(19) United States
(12) Patent Application Publication
(10) Pub. No.: US 2023/0111486 A1
(43) Pub. Date: Apr. 13, 2023

(54) LIDAR SYSTEM WITH SPECTRALLY ENCODED LIGHT PULSES

(71) Applicant: Luminar, LLC, Orlando, FL (US)

(72) Inventors: Lawrence Shah, Winter Park, FL (US); Zachary Ronald Dylan Thomas Bush, Orlando, FL (US); Elias Soto, Melbourne, FL (US); Alex Michael Sincore, Orlando, FL (US); Joseph G. LaChapelle, Philomath, OR (US); Stephen D. Gaalema, Colorado Springs, CO (US); Jason M. Eichenholz, Orlando, FL (US)

(21) Appl. No.: 17/961,650

(22) Filed: Oct. 7, 2022

Related U.S. Application Data
(60) Provisional application No. 63/253,720, filed on Oct. 8, 2021.

(51) Int. Cl. G01S 7/487; G01S 17/10; G01S 7/4865; G01S 7/481

(52) U.S. Cl. CPC G01S 7/4873; G01S 17/10; G01S 7/4865; G01S 7/4817

(57) ABSTRACT

In one embodiment, a lidar system includes a light source configured to emit pulses of light, where each emitted pulse of light includes a spectral signature of multiple different spectral signatures. The lidar system also includes a receiver configured to detect a received pulse of light, the received pulse of light including light from one of the emitted pulses of light scattered by a target located a distance from the lidar system. The emitted pulse of light includes one of the spectral signatures. The receiver includes a detector configured to produce a photocurrent signal corresponding to the received pulse of light, a frequency-detection circuit configured to determine, based on the photocurrent signal, a spectral signature of the received pulse of light, and a pulse-detection circuit configured to determine, based on the photocurrent signal, a time-of-arrival of the received pulse of light.

### CROSS-REFERENCE TO RELATED APPLICATIONS

This application claims the benefit of U.S. Provisional Patent Application No. 63/253,720, filed 8 Oct. 2021, which is incorporated by reference herein in its entirety.

### TECHNICAL FIELD

This disclosure generally relates to lidar systems.

### BACKGROUND

Light detection and ranging (lidar) is a technology that can be used to measure distances to remote targets. Typically, a lidar system includes a light source and an optical receiver. The light source can include, for example, a laser which emits light having a particular operating wavelength. The operating wavelength of a lidar system may lie, for example, in the infrared, visible, or ultraviolet portions of the electromagnetic spectrum. The light source emits light toward a target which scatters the light, and some of the scattered light is received back at the receiver. The system determines the distance to the target based on one or more characteristics associated with the received light. For example, the lidar system may determine the distance to the target based on the time of flight for a pulse of light emitted by the light source to travel to the target and back to the lidar system.

### BRIEF DESCRIPTION OF THE DRAWINGS

FIG. 1 illustrates an example light detection and ranging (lidar) system.

FIG. 2 illustrates an example scan pattern produced by a lidar system.

FIG. 3 illustrates an example lidar system with an example rotating polygon mirror.

FIG. 4 illustrates an example light-source field of view (FOV_{L}) and receiver field of view (FOV_{R}) for a lidar system.

FIG. 5 illustrates an example unidirectional scan pattern that includes multiple pixels and multiple scan lines.

FIG. 6 illustrates an example lidar system that includes a receiver with a pulse-detection circuit and a frequency-detection circuit.

FIG. 7 illustrates an example light source that includes a seed laser diode and a semiconductor optical amplifier (SOA).

FIG. 8 illustrates an example light source that includes a semiconductor optical amplifier (SOA) with a tapered optical waveguide.

FIG. 9 illustrates an example light source that includes a seed laser, a semiconductor optical amplifier (SOA), and a fiber-optic amplifier.

FIG. 10 illustrates an example fiber-optic amplifier.

FIGS. 11-12 each illustrates an example seed current and an example SOA current.

FIG. 13 illustrates example time-domain and frequency-domain graphs of an emitted pulse of light and example time-domain graphs of a corresponding photocurrent and voltage signal.

FIG. 14 illustrates example time-domain and frequency-domain graphs of an emitted pulse of light.

FIG. 15 illustrates example time-domain and frequency-domain graphs of a received pulse of light and example time-domain graphs of a corresponding photocurrent and voltage signal.

FIGS. 16-17 each illustrates an example photocurrent signal.

FIG. 18 illustrates an example receiver that includes a pulse-detection circuit with multiple comparators and TDCs.

FIG. 19 illustrates an example receiver that includes a pulse-detection circuit and a frequency-detection circuit.

FIG. 20 illustrates example time-domain and frequency-domain graphs of a voltage signal.

FIG. 21 illustrates an example receiver that includes a pulse-detection circuit with an analog-to-digital converter (ADC).

FIG. 22 illustrates an example receiver that includes a frequency-detection circuit with a derivative circuit and a zero-crossing circuit.

FIG. 23 illustrates example graphs of a voltage signal and a corresponding derivative signal.

FIG. 24 illustrates an example lidar system that emits pulses of light that are scattered by a target.

FIG. 25 illustrates an example method for determining the distance from a lidar system to a target.

FIG. 26 illustrates an example computer system.

### DESCRIPTION OF EXAMPLE EMBODIMENTS

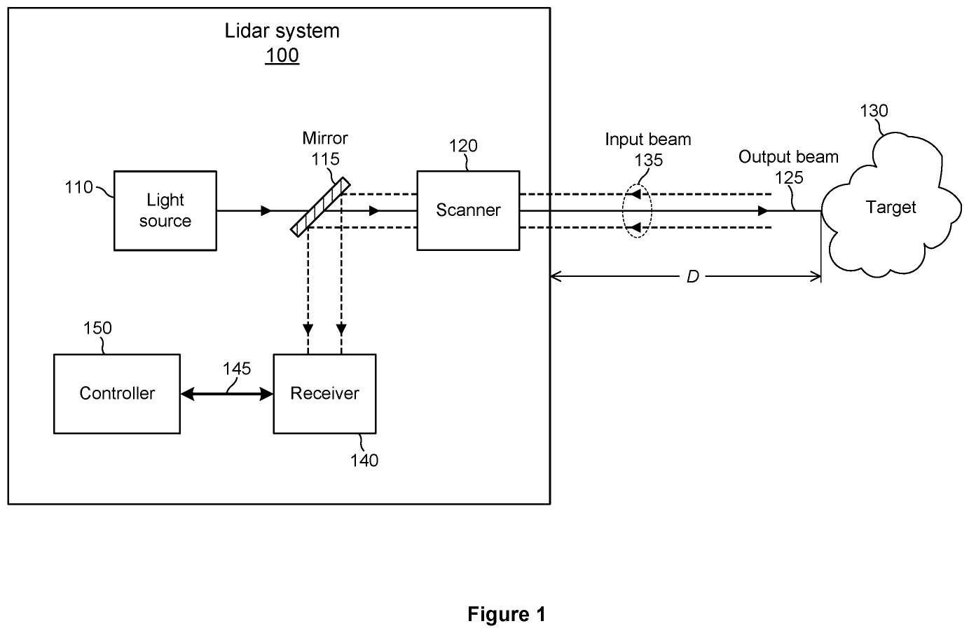

FIG. 1 illustrates an example light detection and ranging (lidar) system 100. A lidar system 100 may be referred to as a laser ranging system, a laser radar system, a LIDAR system, a lidar sensor, or a laser detection and ranging (LADAR or ladar) system. A lidar system 100 may include a light source 110, mirror 115, scanner 120, receiver 140, or controller 150 (which may be referred to as a processor). The light source 110 may include, for example, a laser which emits light having a particular operating wavelength in the infrared, visible, or ultraviolet portions of the electromagnetic spectrum. As an example, light source 110 may include a laser with one or more operating wavelengths between approximately 900 nanometers (nm) and 2000 nm. The light source 110 emits an output beam of light 125 which may be continuous wave (CW), pulsed, or modulated in any suitable manner for a given application. The output beam of light 125 is directed downrange toward a remote target 130. As an example, the remote target 130 may be located a distance D of approximately 1 m to 1 km from the lidar system 100.

Once the output beam 125 reaches the downrange target 130, the target may scatter or reflect at least a portion of light from the output beam 125, and some of the scattered or reflected light may return toward the lidar system 100. In the example of FIG. 1, the scattered or reflected light is represented by input beam 135, which passes through scanner 120 and is reflected by mirror 115 and directed to receiver 140. A relatively small fraction of the light from output beam 125 may return to the lidar system 100 as input beam 135. As an example, the ratio of input beam 135 average power, peak power, or pulse energy to output beam 125 average power, peak power, or pulse energy may be approximately 10⁻¹, 10⁻², 10⁻³, 10⁻⁴, 10⁻⁵, 10⁻⁶, 10⁻⁷, 10⁻⁸, 10⁻⁹, 10⁻¹⁰, 10⁻¹¹, or 10⁻¹². As another example, if a pulse of light of output beam 125 has a pulse energy of 1 microjoule (μj), then the pulse energy of a corresponding pulse of input beam 135 may have a pulse energy of approximately 10 nanojoules (nJ), 1 nJ, 100 picojoules (pJ), 10 pJ, 1 pJ, 100 femtojoules (fJ), 10 fJ, 1 fJ, 100 attojoules (aJ), 10 aJ, 1 aJ, or 0.1 aJ.

The output beam 125 may include or may be referred to as an optical signal, output optical signal, emitted optical signal, output light, emitted pulse of light, laser beam, light beam, optical beam, emitted beam, transmitted beam of light, emitted light, or beam. The input beam 135 may include or may be referred to as a received optical signal, received pulse of light, input pulse of light, input optical signal, return beam, received beam, received beam of light, return light, received light, input light, scattered light, or reflected light. As used herein, scattered light may refer to light that is scattered or reflected by a target 130. As an example, an input beam 135 may include: light from the output beam 125 that is scattered by target 130; light from the output beam 125 that is reflected by target 130; or a combination of scattered and reflected light from target 130.

A receiver 140 may receive or detect photons from input beam 135 and produce one or more representative electrical signals. For example, the receiver 140 may produce an output electrical signal 145 that is representative of the input beam 135, and the electrical signal 145 may be sent to controller 150. A receiver 140 or controller 150 may include a processor, a computer system, an ASIC, an FPGA, or other suitable computing circuitry. A controller 150 may be configured to analyze one or more characteristics of the electrical signal 145 from the receiver 140 to determine one or more characteristics of the target 130, such as its distance downrange from the lidar system 100. This may be done, for example, by analyzing a time of flight or a frequency or phase of a transmitted beam of light 125 or a received beam of light 135. If lidar system 100 measures a time of flight of T (e.g., T may represent a round-trip time of flight for an emitted pulse of light to travel from the lidar system 100 to the target 130 and back to the lidar system 100), then the distance D from the target 130 to the lidar system 100 may be expressed as D=c·T/2, where c is the speed of light (approximately 3.0×10⁸ m/s). As an example, if a time of flight is measured to be T=300 ns, then the distance from the target 130 to the lidar system 100 may be determined to be approximately D=45.0 m. As another example, if a time of flight is measured to be T=1.33 μs, then the distance from the target 130 to the lidar system 100 may be determined to be approximately D=199.5 m. A distance D from lidar system 100 to a target 130 may be referred to as a distance, depth, or range of target 130. As used herein, the speed of light c refers to the speed of light in any suitable medium, such as for example in air, water, or vacuum. As an example, the speed of light in vacuum is approximately 2.9979×10⁸ m/s, and the speed of light in air (which has a refractive index of approximately 1.0003) is approximately 2.9970×10⁸ m/s.

A light source 110 may include a pulsed or CW laser. As an example, light source 110 may be a pulsed laser configured to produce or emit pulses of light with a pulse duration or pulse width of approximately 10 picoseconds (ps) to 100 nanoseconds (ns). The pulses may have a pulse duration of approximately 100 ps, 200 ps, 400 ps, 1 ns, 2 ns, 5 ns, 10 ns, 20 ns, 50 ns, 100 ns, or any other suitable pulse duration. As another example, light source 110 may be a pulsed laser that produces pulses of light with a pulse duration of approximately 1-5 ns. As another example, light source 110 may be a pulsed laser that produces pulses of light at a pulse repetition frequency of approximately 100 kHz to 10 MHz or a pulse period (e.g., a time between consecutive pulses of light) of approximately 100 ns to 10 μs. The pulse period τ may be related to the pulse repetition frequency (PRF) by the expression τ=1/PRF. For example, a pulse period of 1.33 μs corresponds to a PRF of approximately 752 kHz. Light source 110 may have a substantially constant pulse repetition frequency, or light source 110 may have a variable or adjustable pulse repetition frequency. As an example, light source 110 may be a pulsed laser that produces pulses at a substantially constant pulse repetition frequency of approximately 640 kHz (e.g., 640,000 pulses per second), corresponding to a pulse period of approximately 1.56 μs. As another example, light source 110 may have a pulse repetition frequency (which may be referred to as a repetition rate) that can be varied from approximately 200 kHz to 3 MHz. As used herein, a pulse of light may be referred to as an optical pulse, a light pulse, or a pulse.

A light source 110 may include a pulsed or CW laser that produces a free-space output beam 125 having any suitable average optical power. As an example, output beam 125 may have an average power of approximately 1 milliwatt (mW), 10 mW, 100 mW, 1 watt (W), 10 W, or any other suitable average power. An output beam 125 may include optical pulses with any suitable pulse energy or peak optical power. As an example, output beam 125 may include pulses with a pulse energy of approximately 0.01 μJ, 0.1 μJ, 0.5 μJ, 1 μJ, 2 μJ, 10 μJ, or 100 μJ, or any other suitable pulse energy. As another example, output beam 125 may include pulses with a peak power of approximately 10 W, 100 W, 1 kW, 5 kW, 10 kW, or any other suitable peak power. The peak power (Pₚₑₐₖ) of a pulse of light can be related to the pulse energy (E) by the expression E=Pₚₑₐₖ·Δt, where Δt is the duration of the pulse, and the duration of a pulse may be defined as the full width at half maximum duration of the pulse. For example, an optical pulse with a duration of 1 ns and a pulse energy of 1 μJ has a peak power of approximately 1 kW. The average power (Pₐᵥ) of an output beam 125 can be related to the pulse repetition frequency (PRF) and pulse energy by the expression Pₐᵥ=PRF·E. For example, if the pulse repetition frequency is 500 kHz, then the average power of an output beam 125 with 1-μJ pulses is approximately 0.5 W.

A light source 110 may include a laser diode, such as for example, a Fabry-Perot laser diode, a quantum well laser, a distributed Bragg reflector (DBR) laser, a distributed feedback (DFB) laser, a vertical-cavity surface-emitting laser (VCSEL), a quantum dot laser diode, a grating-coupled surface-emitting laser (GCSEL), a slab-coupled optical waveguide laser (SCOWL), a single-transverse-mode laser diode, a multi-mode broad area laser diode, a laser-diode bar, a laser-diode stack, or a tapered-stripe laser diode. As an example, light source 110 may include an aluminum-gallium-arsenide (AlGaAs) laser diode, an indium-gallium-arsenide (InGaAs) laser diode, an indium-gallium-arsenide-phosphide (InGaAsP) laser diode, or a laser diode that includes any suitable combination of aluminum (Al), indium (In), gallium (Ga), arsenic (As), phosphorous (P), or any other suitable material. A light source 110 may include a pulsed or CW laser diode with a peak emission wavelength between 1200 nm and 1600 nm. As an example, light source 110 may include a current-modulated InGaAsP DFB laser diode that produces optical pulses at a wavelength of approximately 1550 nm. As another example, light source 110 may include a laser diode that emits light at a wavelength between 1500 nm and 1510 nm.

A light source 110 may include a pulsed or CW laser diode followed by one or more optical-amplification stages. For example, a seed laser diode may produce a seed optical signal, and an optical amplifier may amplify the seed optical signal to produce an amplified optical signal that is emitted by the light source 110. An optical amplifier may include a fiber-optic amplifier or a semiconductor optical amplifier (SOA). For example, a pulsed laser diode may produce relatively low-power optical seed pulses which are amplified by a fiber-optic amplifier. As another example, a light source 110 may include a fiber-laser module that includes a current-modulated laser diode with an operating wavelength of approximately 1550 nm followed by a single-stage or a multi-stage erbium-doped fiber amplifier (EDFA) or erbium-ytterbium-doped fiber amplifier (EYDFA) that amplifies the seed pulses from the laser diode. As another example, light source 110 may include a continuous-wave (CW) or quasi-CW laser diode followed by an external optical modulator (e.g., an electro-optic amplitude modulator). The optical modulator may modulate the CW light from the laser diode to produce optical pulses which are sent to a fiber-optic amplifier or SOA. As another example, light source 110 may include a pulsed or CW seed laser diode followed by a semiconductor optical amplifier (SOA). The SOA may include an active optical waveguide configured to receive light from the seed laser diode and amplify the light as it propagates through the waveguide. The optical gain of the SOA may be provided by pulsed or direct-current (DC) electrical current supplied to the SOA. The SOA may be integrated on the same chip as the seed laser diode, or the SOA may be a separate device with an anti-reflection coating on its input facet or output facet. As another example, light source 110 may include a seed laser diode followed by a SOA, which in turn is followed by a fiber-optic amplifier. For example, the seed laser diode may produce relatively low-power seed pulses which are amplified by the SOA, and the fiber-optic amplifier may further amplify the optical pulses.

A light source 110 may include a direct-emitter laser diode. A direct-emitter laser diode (which may be referred to as a direct emitter) may include a laser diode which produces light that is not subsequently amplified by an optical amplifier. A light source 110 that includes a direct-emitter laser diode may not include an optical amplifier, and the output light produced by a direct emitter may not be amplified after it is emitted by the laser diode. The light produced by a direct-emitter laser diode (e.g., optical pulses, CW light, or frequency-modulated light) may be emitted directly as a free-space output beam 125 without being amplified. A direct-emitter laser diode may be driven by an electrical power source that supplies current pulses to the laser diode, and each current pulse may result in the emission of an output optical pulse.

A light source 110 may include a diode-pumped solid-state (DPSS) laser. A DPSS laser (which may be referred to as a solid-state laser) may refer to a laser that includes a solid-state, glass, ceramic, or crystal-based gain medium that is pumped by one or more pump laser diodes. The gain medium may include a host material that is doped with rare-earth ions (e.g., neodymium, erbium, ytterbium, or praseodymium). For example, a gain medium may include a yttrium aluminum garnet (YAG) crystal that is doped with neodymium (Nd) ions, and the gain medium may be referred to as a Nd:YAG crystal. A DPSS laser with a Nd:YAG gain medium may produce light at a wavelength between approximately 1300 nm and approximately 1400 nm, and the Nd:YAG gain medium may be pumped by one or more pump laser diodes with an operating wavelength between approximately 730 nm and approximately 900 nm. A DPSS laser may be a passively Q-switched laser that includes a saturable absorber (e.g., a vanadium-doped crystal that acts as a saturable absorber). Alternatively, a DPSS laser may be an actively Q-switched laser that includes an active Q-switch (e.g., an acousto-optic modulator or an electro-optic modulator). A passively or actively Q-switched DPSS laser may produce output optical pulses that form an output beam 125 of a lidar system 100.

An output beam of light 125 emitted by light source 110 may be unpolarized or randomly polarized, may have no specific or fixed polarization (e.g., the polarization may vary with time), or may have a particular polarization (e.g., output beam 125 may be linearly polarized, elliptically polarized, or circularly polarized). As an example, light source 110 may produce light with no specific polarization or may produce light that is linearly polarized.

A lidar system 100 may include one or more optical components configured to reflect, focus, filter, shape, modify, steer, or direct light within the lidar system 100 or light produced or received by the lidar system 100 (e.g., output beam 125 or input beam 135). As an example, lidar system 100 may include one or more lenses, mirrors, filters (e.g., band-pass or interference filters), beam splitters, optical splitters, polarizers, polarizing beam splitters, wave plates (e.g., half-wave or quarter-wave plates), diffractive elements, holographic elements, isolators, couplers, detectors, beam combiners, or collimators. The optical components in a lidar system 100 may be free-space optical components, fiber-coupled optical components, or a combination of free-space and fiber-coupled optical components.

A lidar system 100 may include a telescope, one or more lenses, or one or more mirrors configured to expand, focus, collimate, or steer the output beam 125 or the input beam 135 to a desired beam diameter or divergence. As an example, the lidar system 100 may include one or more lenses to focus the input beam 135 onto a photodetector of receiver 140. As another example, the lidar system 100 may include one or more flat mirrors or curved mirrors (e.g., concave, convex, or parabolic mirrors) to steer or focus the output beam 125 or the input beam 135. For example, the lidar system 100 may include an off-axis parabolic mirror to focus the input beam 135 onto a photodetector of receiver 140. As illustrated in FIG. 1, the lidar system 100 may include mirror 115 (which may be a metallic or dielectric mirror), and mirror 115 may be configured so that light beam 125 passes through the mirror 115 or passes along an edge or side of the mirror 115 and input beam 135 is reflected toward the receiver 140. As an example, mirror 115 (which may be referred to as an overlap mirror, superposition mirror, or beam-combiner mirror) may include a hole, slot, or aperture which output light beam 125 passes through. As another example, rather than passing through the mirror 115, the output beam 125 may be directed to pass alongside the mirror 115 with a gap (e.g., a gap of width approximately 0.1 mm, 0.5 mm, 1 mm, 2 mm, 5 mm, or 10 mm) between the output beam 125 and an edge of the mirror 115.

The mirror 115 may provide for output beam 125 and input beam 135 to be substantially coaxial so that the two beams travel along approximately the same optical path (albeit in opposite directions). The input and output beams being substantially coaxial may refer to the beams being at least partially overlapped or sharing a common propagation axis so that input beam 135 and output beam 125 travel along substantially the same optical path (albeit in opposite directions). As an example, output beam 125 and input beam 135 may be parallel to each other to within less than 10 mrad, 5 mrad, 2 mrad, 1 mrad, 0.5 mrad, or 0.1 mrad. As output beam 125 is scanned across a field of regard, the input beam 135 may follow along with the output beam 125 so that the coaxial relationship between the two beams is maintained.

A lidar system 100 may include a scanner 120 configured to scan an output beam 125 across a field of regard of the lidar system 100. As an example, scanner 120 may include one or more scan mirrors configured to pivot, rotate, oscillate, or move in an angular manner about one or more rotation axes. The output beam 125 may be reflected by a scan mirror, and as the scan mirror pivots or rotates, the reflected output beam 125 may be scanned in a corresponding angular manner. As an example, a scan mirror may be configured to periodically pivot back and forth over a 30-degree range, which results in the output beam 125 scanning back and forth across a 60-degree range (e.g., a Θ-degree rotation by a scan mirror results in a 2Θ-degree angular scan of output beam 125).

A scan mirror (which may be referred to as a scanning mirror) may be attached to or mechanically driven by a scanner actuator or mechanism which pivots or rotates the mirror over a particular angular range (e.g., over a 5° angular range, 30° angular range, 60° angular range, 120° angular range, 360° angular range, or any other suitable angular range). A scanner actuator or mechanism configured to pivot or rotate a mirror may include a galvanometer scanner, a resonant scanner, a piezoelectric actuator, a voice coil motor, an electric motor (e.g., a DC motor, a brushless DC motor, a synchronous electric motor, or a stepper motor), a microelectromechanical systems (MEMS) device, or any other suitable actuator or mechanism. As an example, a scanner 120 may include a scan mirror attached to a galvanometer scanner configured to pivot back and forth over a 1° to 30° angular range. As another example, a scanner 120 may include a scan mirror that is attached to or is part of a MEMS device configured to scan over a 1° to 30° angular range. As another example, a scanner 120 may include a polygon mirror configured to rotate continuously in the same direction (e.g., rather than pivoting back and forth, the polygon mirror continuously rotates 360 degrees in a clockwise or counterclockwise direction). The polygon mirror may be coupled or attached to a synchronous motor configured to rotate the polygon mirror at a substantially fixed rotational frequency (e.g., a rotational frequency of approximately 1 Hz, 10 Hz, 50 Hz, 100 Hz, 500 Hz, or 1,000 Hz).

A scanner 120 may be configured to scan an output beam 125 (which may include at least a portion of the light emitted by light source 110) across a field of regard of a lidar system 100. A field of regard (FOR) of a lidar system 100 may refer to an area, region, or angular range over which the lidar system 100 may be configured to scan or capture distance information. As an example, a lidar system 100 with an output beam 125 with a 30-degree scanning range may be referred to as having a 30-degree angular field of regard. As another example, a lidar system 100 with a scan mirror that rotates over a 30-degree range may produce an output beam 125 that scans across a 60-degree range (e.g., a 60-degree FOR). A lidar system 100 may have a FOR of approximately 10°, 20°, 40°, 60°, 120°, 360°, or any other suitable FOR.

A scanner 120 may be configured to scan an output beam 125 horizontally and vertically, and lidar system 100 may have a particular FOR along the horizontal direction and another particular FOR along the vertical direction. As an example, lidar system 100 may have a horizontal FOR of 10° to 120° and a vertical FOR of 2° to 45°. A scanner 120 may include a first scan mirror and a second scan mirror, where the first scan mirror directs the output beam 125 toward the second scan mirror, and the second scan mirror directs the output beam 125 downrange from the lidar system 100. As an example, the first scan mirror may scan the output beam 125 along a first direction, and the second scan mirror may scan the output beam 125 along a second direction that is different from the first direction (e.g., the first and second directions may be approximately orthogonal to one another, or the second direction may be oriented at any suitable non-zero angle with respect to the first direction). As another example, the first scan mirror may scan the output beam 125 along a substantially horizontal direction, and the second scan mirror may scan the output beam 125 along a substantially vertical direction (or vice versa). As another example, the first and second scan mirrors may each be driven by galvanometer scanners. As another example, the first or second scan mirror may include a polygon mirror driven by an electric motor. A scanner 120 may be referred to as a beam scanner, optical scanner, or laser scanner.

One or more scan mirrors may be communicatively coupled to a controller 150 which may control the scan mirror(s) so as to guide the output beam 125 in a desired direction downrange or along a desired scan pattern. A scan pattern may refer to a pattern or path along which the output beam 125 is directed. As an example, scanner 120 may include two scan mirrors configured to scan the output beam 125 across a 60° horizontal FOR and a 20° vertical FOR. The two scan mirrors may be controlled to follow a scan path that substantially covers the 60°×20° FOR. As an example, the scan path may result in a point cloud with pixels that substantially cover the 60°×20° FOR. The pixels may be approximately evenly distributed across the 60°×20° FOR. Alternatively, the pixels may have a particular nonuniform distribution (e.g., the pixels may be distributed across all or a portion of the 60°×20° FOR, and the pixels may have a higher density in one or more particular regions of the 60°×20° FOR).

A lidar system 100 may include a scanner 120 with a solid-state scanning device. A solid-state scanning device may refer to a scanner 120 that scans an output beam 125 without the use of moving parts (e.g., without the use of a mechanical scanner, such as a mirror that rotates or pivots). For example, a solid-state scanner 120 may include one or more of the following: an optical phased array scanning device; a liquid-crystal scanning device; or a liquid lens scanning device. A solid-state scanner 120 may be an electrically addressable device that scans an output beam 125 along one axis (e.g., horizontally) or along two axes (e.g., horizontally and vertically). A scanner 120 may include a solid-state scanner and a mechanical scanner. For example, a scanner 120 may include an optical phased array scanner configured to scan an output beam 125 in one direction and a galvanometer scanner that scans the output beam 125 in an approximately orthogonal direction. The optical phased array scanner may scan the output beam relatively rapidly in a horizontal direction across the field of regard (e.g., at a scan rate of 50 to 1,000 scan lines per second), and the galvanometer may pivot a mirror at a rate of 1-30 Hz to scan the output beam 125 vertically.

A lidar system 100 may include a light source 110 configured to emit pulses of light and a scanner 120 configured to scan at least a portion of the emitted pulses of light across a field of regard of the lidar system 100. One or more of the emitted pulses of light may be scattered by a target 130 located downrange from the lidar system 100, and a receiver 140 may detect at least a portion of the pulses of light scattered by the target 130. A receiver 140 may include or may be referred to as a photoreceiver, optical receiver, optical sensor, detector, photodetector, or optical detector. A lidar system 100 may include a receiver 140 that receives or detects at least a portion of input beam 135 and produces an electrical signal that corresponds to input beam 135. As an example, if input beam 135 includes an optical pulse, then receiver 140 may produce an electrical current or voltage pulse that corresponds to the optical pulse detected by receiver 140. As another example, receiver 140 may include one or more avalanche photodiodes (APDs) or one or more single-photon avalanche diodes (SPADs). As another example, receiver 140 may include one or more PN photodiodes (e.g., a photodiode structure formed by a p-type semiconductor and a n-type semiconductor, where the PN acronym refers to the structure having p-doped and n-doped regions) or one or more PIN photodiodes (e.g., a photodiode structure formed by an undoped intrinsic semiconductor region located between p-type and n-type regions, where the PIN acronym refers to the structure having p-doped, intrinsic, and n-doped regions). An APD, SPAD, PN photodiode, or PIN photodiode may each be referred to as a detector, photodetector, or photodiode. A detector may receive an input beam 135 that includes an optical pulse, and the detector may produce a pulse of electrical current that corresponds to the received optical pulse. A detector may have an active region or an avalanche-multiplication region that includes silicon, germanium, InGaAs, indium aluminum arsenide (InAlAs), InAsSb (indium arsenide antimonide), AlAsSb (aluminum arsenide antimonide), AlInAsSb (aluminum indium arsenide antimonide), or silicon germanium (SiGe). The active region may refer to an area over which a detector may receive or detect input light. An active region may have any suitable size or diameter, such as for example, a diameter of approximately 10 μm, 25 μm, 50 μm, 80 μm, 100 μm, 200 μm, 500 μm, 1 mm, 2 mm, or 5 mm.

A receiver 140 may include electronic circuitry that performs signal amplification, sampling, filtering, signal conditioning, analog-to-digital conversion, time-to-digital conversion, pulse detection, threshold detection, rising-edge detection, or falling-edge detection. As an example, receiver 140 may include a transimpedance amplifier that converts a photocurrent (e.g., a pulse of current produced by an APD in response to a received optical pulse) into a voltage signal. The voltage signal may be sent to pulse-detection circuitry that produces an analog or digital output signal 145 that corresponds to one or more optical characteristics (e.g., rising edge, falling edge, amplitude, duration, or energy) of a received optical pulse. As an example, the pulse-detection circuitry may perform a time-to-digital conversion to produce a digital output signal 145. The electrical output signal 145 may be sent to controller 150 for processing or analysis (e.g., to determine a time-of-flight value corresponding to a received optical pulse).

A controller 150 (which may include or may be referred to as a processor, an FPGA, an ASIC, a computer, or a computing system) may be located within a lidar system 100 or outside of a lidar system 100. Alternatively, one or more parts of a controller 150 may be located within a lidar system 100, and one or more other parts of a controller 150 may be located outside a lidar system 100. One or more parts of a controller 150 may be located within a receiver 140 of a lidar system 100, and one or more other parts of a controller 150 may be located in other parts of the lidar system 100. For example, a receiver 140 may include an FPGA or ASIC configured to process an output electrical signal from the receiver 140, and the processed signal may be sent to another computing system located elsewhere within the lidar system 100 or outside the lidar system 100. A controller 150 may include any suitable arrangement or combination of logic circuitry, analog circuitry, or digital circuitry.

A controller 150 may be electrically coupled or communicatively coupled to light source 110, scanner 120, or receiver 140. As an example, controller 150 may receive electrical trigger pulses or edges from light source 110, where each pulse or edge corresponds to the emission of an optical pulse by light source 110. As another example, controller 150 may provide instructions, a control signal, or a trigger signal to light source 110 indicating when light source 110 should produce optical pulses. Controller 150 may send an electrical trigger signal that includes electrical pulses, where each electrical pulse results in the emission of an optical pulse by light source 110. The frequency, period, duration, pulse energy, peak power, average power, or wavelength of the optical pulses produced by light source 110 may be adjusted based on instructions, a control signal, or trigger pulses provided by controller 150. A controller 150 may be coupled to light source 110 and receiver 140, and the controller 150 may determine a time-of-flight value for an optical pulse based on timing information associated with a time when the pulse was emitted by light source 110 and a time when a portion of the pulse (e.g., input beam 135) was detected or received by receiver 140. A controller 150 may include circuitry that performs signal amplification, sampling, filtering, signal conditioning, analog-to-digital conversion, time-to-digital conversion, pulse detection, threshold detection, rising-edge detection, or falling-edge detection.

A lidar system 100 may include one or more processors (e.g., a controller 150) configured to determine a distance D from the lidar system 100 to a target 130 based at least in part on a round-trip time of flight for an emitted pulse of light to travel from the lidar system 100 to the target 130 and back to the lidar system 100. The target 130 may be at least partially contained within a field of regard of the lidar system 100 and located a distance D from the lidar system 100 that is less than or equal to an operating range (R_{OP}) of the lidar system 100. An operating range (which may be referred to as an operating distance) of a lidar system 100 may refer to a distance over which the lidar system 100 is configured to sense or identify targets 130 located within a field of regard of the lidar system 100. The operating range of lidar system 100 may be any suitable distance, such as for example, 25 m, 50 m, 100 m, 200 m, 250 m, 500 m, or 1 km. As an example, a lidar system 100 with a 200-m operating range may be configured to sense or identify various targets 130 located up to 200 m away from the lidar system 100.

A lidar system 100 may be used to determine the distance to one or more downrange targets 130. By scanning the lidar system 100 across a field of regard, the system may be used to map the distance to a number of points within the field of regard. Each of these depth-mapped points may be referred to as a pixel or a voxel. A collection of pixels captured in succession (which may be referred to as a depth map, a point cloud, or a frame) may be rendered as an image or may be analyzed to identify or detect objects or to determine a shape or distance of objects within the FOR. As an example, a point cloud may cover a field of regard that extends 60° horizontally and 15° vertically, and the point cloud may include a frame of 100-2000 pixels in the horizontal direction by 4-400 pixels in the vertical direction.

A lidar system 100 may be configured to repeatedly capture or generate point clouds of a field of regard at any suitable frame rate between approximately 0.1 frames per second (FPS) and approximately 1,000 FPS. As an example, lidar system 100 may generate point clouds at a frame rate of approximately 0.1 FPS, 0.5 FPS, 1 FPS, 2 FPS, 5 FPS, 10 FPS, 20 FPS, 100 FPS, 500 FPS, or 1,000 FPS. As another example, lidar system 100 may be configured to produce optical pulses at a rate of 5×10⁵ pulses/second (e.g., the system may determine 500,000 pixel distances per second) and scan a frame of 1000×50 pixels (e.g., 50,000 pixels/frame), which corresponds to a point-cloud frame rate of 10 frames per second (e.g., 10 point clouds per second). A point-cloud frame rate may be substantially fixed, or a point-cloud frame rate may be dynamically adjustable. As an example, a lidar system 100 may capture one or more point clouds at a particular frame rate (e.g., 1 Hz) and then switch to capture one or more point clouds at a different frame rate (e.g., 10 Hz). A slower frame rate (e.g., 1 Hz) may be used to capture one or more high-resolution point clouds, and a faster frame rate (e.g., 10 Hz) may be used to rapidly capture multiple lower-resolution point clouds.

A lidar system 100 may be configured to sense, identify, or determine distances to one or more targets 130 within a field of regard. As an example, a lidar system 100 may determine a distance to a target 130, where all or part of the target 130 is contained within a field of regard of the lidar system 100. All or part of a target 130 being contained within a FOR of the lidar system 100 may refer to the FOR overlapping, encompassing, or enclosing at least a portion of the target 130. A target 130 may include all or part of an object that is moving or stationary relative to lidar system 100. As an example, target 130 may include all or a portion of a person, vehicle, motorcycle, truck, train, bicycle, wheelchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects. A target may be referred to as an object.

A lidar system 100 may include a light source 110, scanner 120, and receiver 140 that are packaged together within a single housing, where a housing may refer to a box, case, or enclosure that holds or contains all or part of a lidar system 100. As an example, a lidar-system enclosure may contain a light source 110, mirror 115, scanner 120, and receiver 140 of a lidar system 100. Additionally, the lidar-system enclosure may include a controller 150. The lidar-system enclosure may also include one or more electrical connections for conveying electrical power or electrical signals to or from the enclosure. One or more components of a lidar system 100 may be located remotely from a lidar-system enclosure. As an example, all or part of light source 110 may be located remotely from a lidar-system enclosure, and pulses of light produced by the light source 110 may be conveyed to the enclosure via optical fiber. As another example, all or part of a controller 150 may be located remotely from a lidar-system enclosure.

A light source 110 may include an eye-safe laser, or lidar system 100 may be classified as an eye-safe laser system or laser product. An eye-safe laser, laser system, or laser product may refer to a system that includes a laser with an emission wavelength, average power, peak power, peak intensity, pulse energy, beam size, beam divergence, exposure time, or scanned output beam such that emitted light from the system presents little or no possibility of causing damage to a person's eyes. As an example, light source 110 or lidar system 100 may be classified as a Class 1 laser product (as specified by the 60825-1:2014 standard of the International Electrotechnical Commission (IEC)) or a Class I laser product (as specified by Title 21, Section 1040.10 of the United States Code of Federal Regulations (CFR)) that is safe under all conditions of normal use. A lidar system 100 may be an eye-safe laser product (e.g., with a Class 1 or Class I classification) configured to operate at any suitable wavelength between approximately 900 nm and approximately 2100 nm. As an example, lidar system 100 may include a laser with an operating wavelength between approximately 1200 nm and approximately 1400 nm or between approximately 1400 nm and approximately 1600 nm, and the laser or the lidar system 100 may be operated in an eye-safe manner. As another example, lidar system 100 may be an eye-safe laser product that includes a scanned laser with an operating wavelength between approximately 900 nm and approximately 1700 nm. As another example, lidar system 100 may be a Class 1 or Class I laser product that includes a laser diode, fiber laser, or solid-state laser with an operating wavelength between approximately 1200 nm and approximately 1600 nm. As another example, lidar system 100 may have an operating wavelength between approximately 1500 nm and approximately 1510 nm.

One or more lidar systems 100 may be integrated into a vehicle. As an example, a truck may include a single lidar system 100 with a 60-degree to 180-degree horizontal FOR directed towards the front of the truck. As another example, multiple lidar systems 100 may be integrated into a car to provide a complete 360-degree horizontal FOR around the car. As another example, 2-10 lidar systems 100, each system having a 45-degree to 180-degree horizontal FOR, may be combined together to form a sensing system that provides a point cloud covering a 360-degree horizontal FOR. The lidar systems 100 may be oriented so that adjacent FORs have an amount of spatial or angular overlap to allow data from the multiple lidar systems 100 to be combined or stitched together to form a single or continuous 360-degree point cloud. As an example, the FOR of each lidar system 100 may have approximately 1-30 degrees of overlap with an adjacent FOR. A vehicle may refer to a mobile machine configured to transport people or cargo. For example, a vehicle may include a car used for work, commuting, running errands, or transporting people. As another example, a vehicle may include a truck used to transport commercial goods to a store, warehouse, or residence. A vehicle may include, may take the form of, or may be referred to as a car, automobile, motor vehicle, truck, bus, van, trailer, off-road vehicle, farm vehicle, lawn mower, construction equipment, forklift, robot, golf cart, motorhome, taxi, motorcycle, scooter, bicycle, skateboard, train, snowmobile, watercraft (e.g., a ship or boat), aircraft (e.g., a fixed-wing aircraft, helicopter, or dirigible), unmanned aerial vehicle (e.g., a drone), or spacecraft. A vehicle may include an internal combustion engine or an electric motor that provides propulsion for the vehicle.

One or more lidar systems 100 may be included in a vehicle as part of an advanced driver assistance system (ADAS) to assist a driver of the vehicle in operating the vehicle. For example, a lidar system 100 may be part of an ADAS that provides information (e.g., about the surrounding environment) or feedback to a driver (e.g., to alert the driver to potential problems or hazards) or that automatically takes control of part of a vehicle (e.g., a braking system or a steering system) to avoid collisions or accidents. A lidar system 100 may be part of a vehicle ADAS that provides adaptive cruise control, automated braking, automated parking, collision avoidance, alerts the driver to hazards or other vehicles, maintains the vehicle in the correct lane, or provides a warning if an object or another vehicle is located in a blind spot.

One or more lidar systems 100 may be integrated into a vehicle as part of an autonomous-vehicle driving system. As an example, a lidar system 100 may provide information about the surrounding environment to a driving system of an autonomous vehicle. An autonomous-vehicle driving system may be configured to guide the autonomous vehicle through an environment surrounding the vehicle and toward a destination. An autonomous-vehicle driving system may include one or more computing systems that receive information from a lidar system 100 about the surrounding environment, analyze the received information, and provide control signals to the vehicle's driving systems (e.g., steering mechanism, accelerator, brakes, lights, or turn signals). As an example, a lidar system 100 integrated into an autonomous vehicle may provide an autonomous-vehicle driving system with a point cloud every 0.1 seconds (e.g., the point cloud has a 10 Hz update rate, representing 10 frames per second). The autonomous-vehicle driving system may analyze the received point clouds to sense or identify targets 130 and their respective locations, distances, or speeds, and the autonomous-vehicle driving system may update control signals based on this information. As an example, if lidar system 100 detects a vehicle ahead that is slowing down or stopping, the autonomous-vehicle driving system may send instructions to release the accelerator and apply the brakes.

An autonomous vehicle may be referred to as an autonomous car, driverless car, self-driving car, robotic car, or unmanned vehicle. An autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

An autonomous vehicle may be configured to drive with a driver present in the vehicle, or an autonomous vehicle may be configured to operate the vehicle with no driver present. As an example, an autonomous vehicle may include a driver's seat with associated controls (e.g., steering wheel, accelerator pedal, and brake pedal), and the vehicle may be configured to drive with no one seated in the driver's seat or with little or no input from a person seated in the driver's seat. As another example, an autonomous vehicle may not include any driver's seat or associated driver's controls, and the vehicle may perform substantially all driving functions (e.g., driving, steering, braking, parking, and navigating) without human input. As another example, an autonomous vehicle may be configured to operate without a driver (e.g., the vehicle may be configured to transport human passengers or cargo without a driver present in the vehicle). As another example, an autonomous vehicle may be configured to operate without any human passengers (e.g., the vehicle may be configured for transportation of cargo without having any human passengers onboard the vehicle).

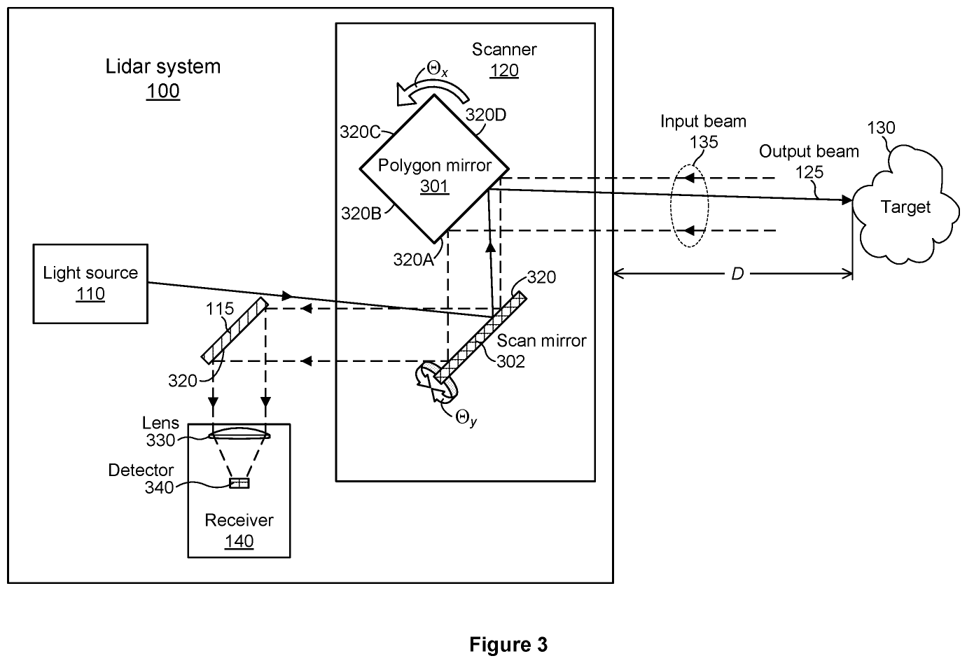

An optical signal (which may be referred to as a light signal, a light waveform, an optical waveform, an output beam, an emitted optical signal, or emitted light) may include pulses of light, CW light, amplitude-modulated light, frequency-modulated (FM) light, or any suitable combination thereof. Although this disclosure describes or illustrates example embodiments of lidar systems 100 or light sources 110 that produce optical signals that include pulses of light, the embodiments described or illustrated herein may also be applied, where appropriate, to other types of optical signals, including continuous-wave (CW) light, amplitude-modulated optical signals, or frequency-modulated optical signals. For example, a lidar system 100 as described or illustrated herein may be a pulsed lidar system and may include a light source 110 that produces pulses of light. The distance to a remote target 130 may be determined based on the round-trip time of flight for a pulse of light to travel to the target 130 and back. Alternatively, a lidar system 100 may be configured to operate as a frequency-modulated continuous-wave (FMCW) lidar system and may include a light source 110 that produces a frequency-modulated optical signal. For example, output beam 125 in FIG. 1 or FIG. 3 may include FM light. Additionally, the light source may also produce local-oscillator (LO) light that is frequency modulated. A FMCW lidar system may use frequency-modulated light to determine the distance to a remote target 130 based on a frequency of received light (which includes emitted light scattered by the remote target) relative to a frequency of the LO light. A round-trip time for the emitted light to travel to a target 130 and back to the lidar system may correspond to a frequency difference between the received scattered light and the LO light. A larger frequency difference may correspond to a longer round-trip time and a greater distance to the target 130. The frequency difference between the received scattered light and the LO light may be referred to as a beat frequency.

A light source 110 for a FMCW lidar system may include (i) a direct-emitter laser diode, (ii) a seed laser diode followed by a SOA, (iii) a seed laser diode followed by a fiber-optic amplifier, or (iv) a seed laser diode followed by a SOA and then a fiber-optic amplifier. A seed laser diode or a direct-emitter laser diode may be operated in a CW manner (e.g., by driving the laser diode with a substantially constant DC current), and a frequency modulation may be provided by an external modulator (e.g., an electro-optic phase modulator may apply a frequency modulation to seed-laser light). Alternatively, a frequency modulation may be produced by applying a current modulation to a seed laser diode or a direct-emitter laser diode. The current modulation (which may be provided along with a DC bias current) may produce a corresponding refractive-index modulation in the laser diode, which results in a frequency modulation of the light emitted by the laser diode. The current-modulation component (and the corresponding frequency modulation) may have any suitable frequency or shape (e.g., piecewise linear, sinusoidal, triangle-wave, or sawtooth). For example, the current-modulation component (and the resulting frequency modulation of the emitted light) may increase or decrease monotonically over a particular time interval. As another example, the current-modulation component may include a triangle or sawtooth wave with an electrical current that increases or decreases linearly over a particular time interval, and the light emitted by the laser diode may include a corresponding frequency modulation in which the optical frequency increases or decreases approximately linearly over the particular time interval. For example, a light source 110 that emits light with a linear frequency change of 200 MHz over a 2-μs time interval may be referred to as having a frequency modulation m of 10¹⁴ Hz/s (or, 100 MHz/μs).

In addition to producing frequency-modulated emitted light, a light source 110 may also produce frequency-modulated local-oscillator (LO) light. The LO light may be coherent with the emitted light, and the frequency modulation of the LO light may match that of the emitted light. The LO light may be produced by splitting off a portion of the emitted light prior to the emitted light exiting the lidar system. Alternatively, the LO light may be produced by a seed laser diode or a direct-emitter laser diode that is part of the light source 110. For example, the LO light may be emitted from the back facet of a seed laser diode or a direct-emitter laser diode, or the LO light may be split off from the seed light emitted from the front facet of a seed laser diode. The received light (e.g., emitted light that is scattered by a target 130) and the LO light may each be frequency modulated, with a frequency difference or offset that corresponds to the distance to the target 130. For a linearly chirped light source (e.g., a frequency modulation that produces a linear change in frequency with time), the larger the frequency difference is between the received light and the LO light, the farther away the target 130 is located.

A frequency difference between received light and LO light may be determined by mixing the received light with the LO light (e.g., by coupling the two beams onto a detector so they are coherently mixed together at the detector) and determining the resulting beat frequency. For example, a photocurrent signal produced by an APD may include a beat signal resulting from the coherent mixing of the received light and the LO light, and a frequency of the beat signal may correspond to the frequency difference between the received light and the LO light. The photocurrent signal from an APD (or a voltage signal that corresponds to the photocurrent signal) may be analyzed to determine the frequency of the beat signal. If a linear frequency modulation m (e.g., in units of Hz/s) is applied to a CW laser, then the round-trip time T may be related to the frequency difference ΔF between the received scattered light and the LO light by the expression T=ΔF/m. Additionally, the distance D from the target 130 to the lidar system 100 may be expressed as D=(ΔF/m)·c/2, where c is the speed of light. For example, for a light source 110 with a linear frequency modulation of 10¹⁴ Hz/s, if a frequency difference (between the received scattered light and the LO light) of 33 MHz is measured, then this corresponds to a round-trip time of approximately 330 ns and a distance to the target of approximately 50 meters. As another example, a frequency difference of 133 MHz corresponds to a round-trip time of approximately 1.33 μs and a distance to the target of approximately 200 meters. A receiver or processor of a FMCW lidar system may determine a frequency difference between received scattered light and LO light, and the distance to a target may be determined based on the frequency difference. The frequency difference ΔF between received scattered light and LO light corresponds to the round-trip time T (e.g., through the relationship T=ΔF/m), and determining the frequency difference may correspond to or may be referred to as determining the round-trip time.

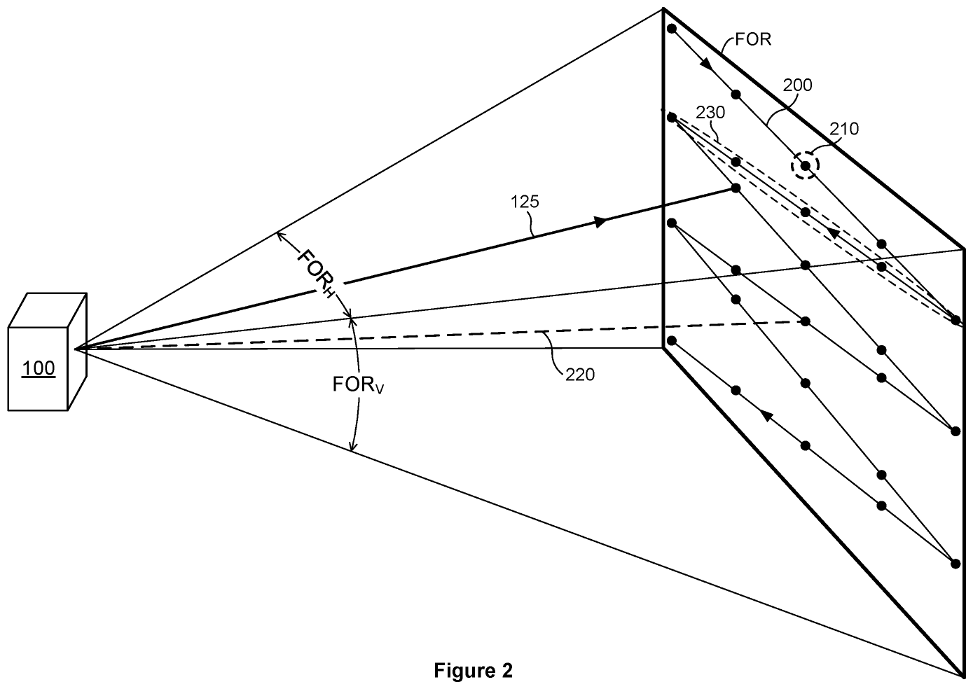

FIG. 2 illustrates an example scan pattern 200 produced by a lidar system 100. A scanner 120 of the lidar system 100 may scan the output beam 125 (which may include multiple emitted optical signals) along a scan pattern 200 that is contained within a field of regard (FOR) of the lidar system 100. A scan pattern 200 (which may be referred to as an optical scan pattern, optical scan path, scan path, or scan) may represent a path or course followed by output beam 125 as it is scanned across all or part of a FOR. Each traversal of a scan pattern 200 by the output beam 125 may correspond to the capture of a single frame or a single point cloud. A scan pattern 200 may scan across any suitable field of regard (FOR) having any suitable horizontal FOR (FOR_{H}) and any suitable vertical FOR (FOR_{V}). For example, a scan pattern 200 may have a field of regard represented by angular dimensions (e.g., FOR_{H}×FOR_{V}) 40°×30°, 90°×40°, or 120°×20°. As another example, a scan pattern 200 may have a FOR_{H} greater than or equal to 10°, 25°, 30°, 40°, 60°, 90°, or 120°. As another example, a scan pattern 200 may have a FOR_{V} greater than or equal to 2°, 5°, 10°, 15°, 20°, 30°, or 45°.

In the example of FIG. 2, reference line 220 represents a center of the field of regard of scan pattern 200. A reference line 220 may have any suitable orientation, such as for example, a horizontal angle of 0° (e.g., reference line 220 may be oriented straight ahead) and a vertical angle of 0° (e.g., reference line 220 may have an inclination of 0°), or reference line 220 may have a non-zero horizontal angle or a non-zero inclination (e.g., a vertical angle of +10° or) −10°. In FIG. 2, if the scan pattern 200 has a 60°×15° field of regard, then scan pattern 200 covers a ±30° horizontal range with respect to reference line 220 and a ±7.5° vertical range with respect to reference line 220. Additionally, optical beam 125 in FIG. 2 has an orientation of approximately −15° horizontal and +3° vertical with respect to reference line 220. Optical beam 125 may be referred to as having an azimuth of −15° and an altitude of +3° relative to reference line 220. An azimuth (which may be referred to as an azimuth angle) may represent a horizontal angle with respect to reference line 220, and an altitude (which may be referred to as an altitude angle, elevation, or elevation angle) may represent a vertical angle with respect to reference line 220.

A scan pattern 200 may include multiple pixels 210, and each pixel 210 may be associated with one or more optical pulses or one or more distance measurements. Additionally, a scan pattern 200 may include multiple scan lines 230, where each scan line represents one scan across at least part of a field of regard, and each scan line 230 may include multiple pixels 210. In FIG. 2, scan line 230 includes five pixels 210 and corresponds to an approximately horizontal scan across the FOR from right to left, as viewed from the lidar system 100. A complete cycle or traversal of a scan pattern 200 may include a total of Pₓ×P_{y} pixels 210 (e.g., a two-dimensional distribution of Pₓ by P_{y} pixels). As an example, scan pattern 200 may include a distribution with dimensions of approximately 100-2,000 pixels 210 along a horizontal direction and approximately 4-400 pixels 210 along a vertical direction. As another example, scan pattern 200 may include a distribution of 1,000 pixels 210 along the horizontal direction by 64 pixels 210 along the vertical direction (e.g., the frame size is 1000×64 pixels) for a total of 64,000 pixels per cycle of scan pattern 200.

A pixel 210 may refer to a data element that includes (i) distance information (e.g., a distance from a lidar system 100 to a target 130 from which an associated pulse of light was scattered) or (ii) an elevation angle and an azimuth angle associated with the pixel (e.g., the elevation and azimuth angles along which the associated pulse of light was emitted). Each pixel 210 may be associated with a distance (e.g., a distance to a portion of a target 130 from which an associated pulse of light was scattered) or one or more angular values. As an example, a pixel 210 may be associated with a distance value and two angular values (e.g., an azimuth and altitude) that represent the angular location of the pixel 210 with respect to the lidar system 100. A distance to a portion of target 130 may be determined based at least in part on a time-of-flight measurement for a corresponding pulse. An angular value (e.g., an azimuth or altitude) may correspond to an angle (e.g., relative to reference line 220) of output beam 125 (e.g., when a corresponding pulse is emitted from lidar system 100) or an angle of input beam 135 (e.g., when an input signal is received by lidar system 100). An angular value may be determined based at least in part on a position of a component of a scanner 120. As an example, an azimuth or altitude value associated with a pixel 210 may be determined from an angular position of one or more corresponding scan mirrors of the scanner 120.

FIG. 3 illustrates an example lidar system 100 with an example rotating polygon mirror 301. A scanner 120 may include a polygon mirror 301 configured to scan output beam 125 along a first direction and a scan mirror 302 configured to scan output beam 125 along a second direction different from the first direction (e.g., the first and second directions may be approximately orthogonal to one another, or the second direction may be oriented at any suitable non-zero angle with respect to the first direction). In the example of FIG. 3, scanner 120 includes two scan mirrors: (1) a polygon mirror 301 that rotates along the Θₓ direction and (2) a scan mirror 302 that oscillates back and forth along the Θ_{y} direction. The output beam 125 from light source 110, which passes alongside mirror 115, is reflected by reflecting surface 320 of scan mirror 302 and is then reflected by a reflecting surface (e.g., surface 320A, 320B, 320C, or 320D) of polygon mirror 301. Scattered light from a target 130 returns to the lidar system 100 as input beam 135. The input beam 135 reflects from polygon mirror 301, scan mirror 302, and mirror 115, which directs input beam 135 through focusing lens 330 and to the detector 340 of receiver 140. The detector 340 may be a PN photodiode, a PIN photodiode, an APD, a SPAD, or any other suitable detector. A reflecting surface 320 (which may be referred to as a reflective surface) may include a reflective metallic coating (e.g., gold, silver, or aluminum) or a reflective dielectric coating, and the reflecting surface 320 may have any suitable reflectivity R at an operating wavelength of the light source 110 (e.g., R may be greater than or equal to 70%, 80%, 90%, 95%, 98%, or 99%).

A polygon mirror 301 may be configured to rotate along a Θₓ or Θ_{y} direction and scan output beam 125 along a substantially horizontal or vertical direction, respectively. A rotation along a Θₓ direction may refer to a rotational motion of mirror 301 that results in output beam 125 scanning along a substantially horizontal direction. Similarly, a rotation along a Θ_{y} direction may refer to a rotational motion that results in output beam 125 scanning along a substantially vertical direction. In FIG. 3, mirror 301 is a polygon mirror that rotates along the Θₓ direction and scans output beam 125 along a substantially horizontal direction, and mirror 302 pivots along the Θ_{y} direction and scans output beam 125 along a substantially vertical direction. A polygon mirror 301 may be configured to scan output beam 125 along any suitable direction. As an example, a polygon mirror 301 may scan output beam 125 at any suitable angle with respect to a horizontal or vertical direction, such as for example, at an angle of approximately 0°, 10°, 20°, 30°, 45°, 60°, 70°, 80°, or 90° with respect to a horizontal or vertical direction.

A polygon mirror 301 may refer to a multi-sided object having reflective surfaces 320 on two or more of its sides or faces. As an example, a polygon mirror may include any suitable number of reflective faces (e.g., 2, 3, 4, 5, 6, 7, 8, or 10 faces), where each face includes a reflective surface 320. A polygon mirror 301 may have a cross-sectional shape of any suitable polygon, such as for example, a triangle (with three reflecting surfaces 320), square (with four reflecting surfaces 320), pentagon (with five reflecting surfaces 320), hexagon (with six reflecting surfaces 320), heptagon (with seven reflecting surfaces 320), or octagon (with eight reflecting surfaces 320). In FIG. 3, the polygon mirror 301 has a substantially square cross-sectional shape and four reflecting surfaces (320A, 320B, 320C, and 320D). The polygon mirror 301 in FIG. 3 may be referred to as a square mirror, a cube mirror, or a four-sided polygon mirror. In FIG. 3, the polygon mirror 301 may have a shape similar to a cube, cuboid, or rectangular prism. Additionally, the polygon mirror 301 may have a total of six sides, where four of the sides include faces with reflective surfaces (320A, 320B, 320C, and 320D).

A polygon mirror 301 may be continuously rotated in a clockwise or counterclockwise rotation direction about a rotation axis of the polygon mirror 301. The rotation axis may correspond to a line that is perpendicular to the plane of rotation of the polygon mirror 301 and that passes through the center of mass of the polygon mirror 301. In FIG. 3, the polygon mirror 301 rotates in the plane of the drawing, and the rotation axis of the polygon mirror 301 is perpendicular to the plane of the drawing. An electric motor may be configured to rotate a polygon mirror 301 at a substantially fixed frequency (e.g., a rotational frequency of approximately 1 Hz (or, 1 revolution per second), 10 Hz, 50 Hz, 100 Hz, 500 Hz, or 1,000 Hz). As an example, a polygon mirror 301 may be mechanically coupled to an electric motor (e.g., a synchronous electric motor) which is configured to spin the polygon mirror 301 at a rotational speed of approximately 160 Hz (or, 9600 revolutions per minute (RPM)).

In FIG. 3, the output beam 125 may be reflected sequentially from the reflective surfaces 320A, 320B, 320C, and 320D as the polygon mirror 301 is rotated. This results in the output beam 125 being scanned along a particular scan axis (e.g., a horizontal or vertical scan axis) to produce a sequence of scan lines, where each scan line corresponds to a reflection of the output beam 125 from one of the reflective surfaces of the polygon mirror 301. In FIG. 3, the output beam 125 reflects off of reflective surface 320A to produce one scan line. Then, as the polygon mirror 301 rotates, the output beam 125 reflects off of reflective surfaces 320B, 320C, and 320D to produce a second, third, and fourth respective scan line. A lidar system 100 may be configured so that the output beam 125 is first reflected from polygon mirror 301 and then from scan mirror 302 (or vice versa). As an example, an output beam 125 from light source 110 may first be directed to polygon mirror 301, where it is reflected by a reflective surface of the polygon mirror 301, and then the output beam 125 may be directed to scan mirror 302, where it is reflected by reflective surface 320 of the scan mirror 302. In the example of FIG. 3, the output beam 125 is reflected from the polygon mirror 301 and the scan mirror 302 in the reverse order. In FIG. 3, the output beam 125 from light source 110 is first directed to the scan mirror 302, where it is reflected by reflective surface 320, and then the output beam 125 is directed to the polygon mirror 301, where it is reflected by reflective surface 320A.

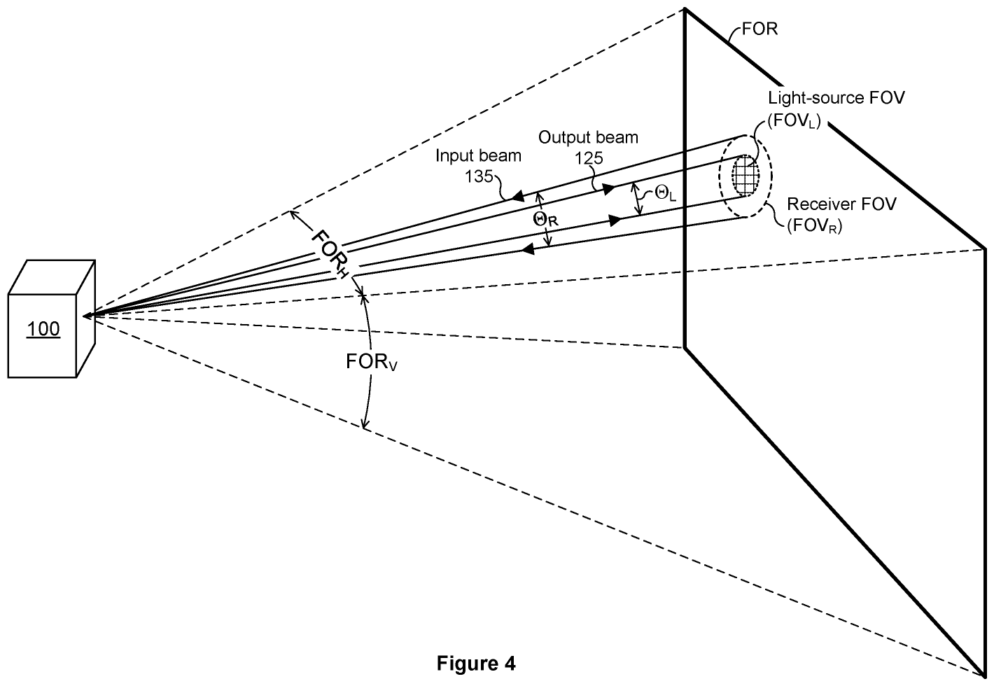

FIG. 4 illustrates an example light-source field of view (FOV_{L}) and receiver field of view (FOV_{R}) for a lidar system 100. A light source 110 of lidar system 100 may emit pulses of light as the FOV_{L} and FOV_{R} are scanned by scanner 120 across a field of regard (FOR). A light-source field of view may refer to an angular cone illuminated by the light source 110 at a particular instant of time. Similarly, a receiver field of view may refer to an angular cone over which the receiver 140 may receive or detect light at a particular instant of time, and any light outside the receiver field of view may not be received or detected. As an example, as the light-source field of view is scanned across a field of regard, a portion of a pulse of light emitted by the light source 110 may be sent downrange from lidar system 100, and the pulse of light may be sent in the direction that the FOV_{L} is pointing at the time the pulse is emitted. The pulse of light may scatter off a target 130, and the receiver 140 may receive and detect a portion of the scattered light that is directed along or contained within the FOV_{R}.

A scanner 120 may be configured to scan both a light-source field of view and a receiver field of view across a field of regard of the lidar system 100. Multiple pulses of light may be emitted and detected as the scanner 120 scans the FOV_{L} and FOV_{R} across the field of regard of the lidar system 100 while tracing out a scan pattern 200. The light-source field of view and the receiver field of view may be scanned synchronously with respect to one another, so that as the FOV_{L} is scanned across a scan pattern 200, the FOV_{R} follows substantially the same path at the same scanning speed. Additionally, the FOV_{L} and FOV_{R} may maintain the same relative position to one another as they are scanned across the field of regard. As an example, the FOV_{L} may be substantially overlapped with or centered inside the FOV_{R} (as illustrated in FIG. 4), and this relative positioning between FOV_{L} and FOV_{R} may be maintained throughout a scan. As another example, the FOV_{R} may lag behind the FOV_{L} by a particular, fixed amount throughout a scan (e.g., the FOV_{R} may be offset from the FOV_{L} in a direction opposite the scan direction).

An output beam of light 125 emitted by light source 110 may be a collimated optical beam having any suitable beam divergence, such as for example, a full-angle beam divergence Θ_{L} of approximately 0.5 to 10 milliradians (mrad). A divergence Θ_{L} of output beam 125 (which may be referred to as an angular size of the output beam) may correspond to an angular measure of an increase in beam size (e.g., a beam radius or beam diameter) as output beam 125 travels away from light source 110 or lidar system 100. An output beam 125 may have a substantially circular cross section with a beam divergence characterized by a single divergence value. As an example, an output beam 125 with a circular cross section and a full-angle beam divergence Θ_{L} of 2 mrad may have a beam diameter or spot size of approximately 20 cm at a distance of 100 m from lidar system 100. An output beam 125 may have a substantially elliptical cross section characterized by two divergence values. As an example, output beam 125 may have a fast axis and a slow axis, where the fast-axis divergence is greater than the slow-axis divergence. As another example, output beam 125 may be an elliptical beam with a fast-axis divergence of 4 mrad and a slow-axis divergence of 2 mrad.

The angular size Θ_{R} of a FOV_{R} may correspond to an angle over which the receiver 140 may receive and detect light. The receiver field of view may be any suitable size relative to the light-source field of view. As an example, the receiver field of view may be smaller than, substantially the same size as, or larger than the angular size of the light-source field of view. The light-source field of view may have an angular size of less than or equal to 50 milliradians, and the receiver field of view may have an angular size of less than or equal to 50 milliradians. The FOV_{L} may have any suitable angular size Θ_{L}, such as for example, an angular size of approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. Similarly, the FOV_{R} may have any suitable angular size Θ_{R}, such as for example, an angular size of approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. The light-source field of view and the receiver field of view may have approximately equal angular sizes. As an example, Θ_{L} and Θ_{R} may both be approximately equal to 0.5 mrad, 1 mrad, or 2 mrad. Alternatively, the receiver field of view may be larger than the light-source field of view, or the light-source field of view may be larger than the receiver field of view. As an example, Θ_{L} may be approximately equal to 1 mrad, and Θ_{R} may be approximately equal to 2 mrad. As another example, Θ_{R} may be approximately L times larger than Θ_{L}, where L is any suitable factor, such as for example, 1.1, 1.2, 1.5, 2, 3, 5, or 10.

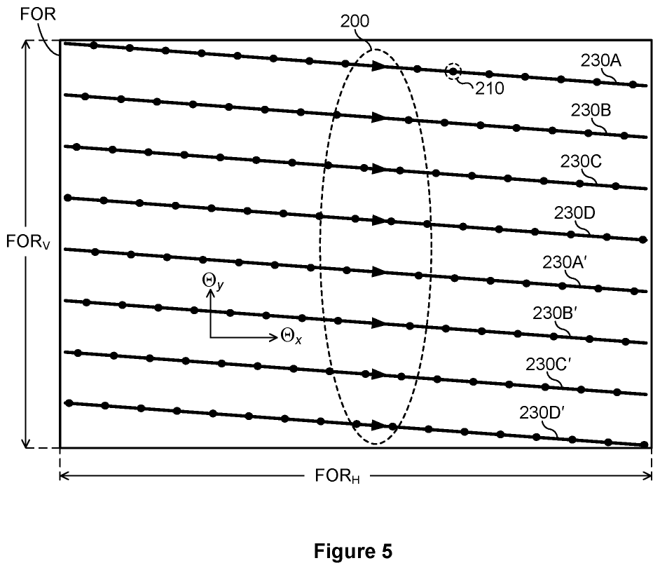

FIG. 5 illustrates an example unidirectional scan pattern 200 that includes multiple pixels 210 and multiple scan lines 230. A scan pattern 200 may include any suitable number of scan lines 230 (e.g., approximately 1, 2, 5, 10, 20, 50, 100, 500, or 1,000 scan lines), and each scan line 230 of a scan pattern 200 may include any suitable number of pixels 210 (e.g., 1, 2, 5, 10, 20, 50, 100, 200, 500, 1,000, 2,000, or 5,000 pixels). The scan pattern 200 illustrated in FIG. 5 includes eight scan lines 230, and each scan line 230 includes approximately 16 pixels 210. A scan pattern 200 in which the scan lines 230 are scanned in two directions (e.g., alternately scanning from right to left and then from left to right) may be referred to as a bidirectional scan pattern 200, and a scan pattern 200 in which the scan lines 230 are scanned in the same direction may be referred to as a unidirectional scan pattern 200. The scan pattern 200 in FIG. 2 may be referred to as a bidirectional scan pattern, and the scan pattern 200 in FIG. 5 may be referred to as a unidirectional scan pattern 200 where each scan line 230 travels across the FOR in substantially the same direction (e.g., approximately from left to right as viewed from the lidar system 100). Scan lines 230 of a unidirectional scan pattern 200 may be directed across a FOR in any suitable direction, such as for example, from left to right, from right to left, from top to bottom, from bottom to top, or at any suitable angle (e.g., at a 0°, 5°, 10°, 30°, or 45° angle) with respect to a horizontal or vertical axis. Each scan line 230 in a unidirectional scan pattern 200 may be a separate line that is not directly connected to a previous or subsequent scan line 230.

A unidirectional scan pattern 200 may be produced by a scanner 120 that includes a polygon mirror (e.g., polygon mirror 301 of FIG. 3), where each scan line 230 is associated with a particular reflective surface 320 of the polygon mirror. As an example, reflective surface 320A of polygon mirror 301 in FIG. 3 may produce scan line 230A in FIG. 5. Similarly, as the polygon mirror 301 rotates, reflective surfaces 320B, 320C, and 320D may successively produce scan lines 230B, 230C, and 230D, respectively. Additionally, for a subsequent revolution of the polygon mirror 301, the scan lines 230A′, 230B′, 230C′, and 230D′ may be successively produced by reflections of the output beam 125 from reflective surfaces 320A, 320B, 320C, and 320D, respectively. One full revolution of a N-sided polygon mirror may correspond to N successive scan lines 230 of a unidirectional scan pattern 200. As an example, the four scan lines 230A, 230B, 230C, and 230D in FIG. 5 may correspond to one full revolution of the four-sided polygon mirror 301 in FIG. 3. Additionally, a subsequent revolution of the polygon mirror 301 may produce the next four scan lines 230A′, 230B′, 230C′, and 230D′ in FIG. 5.

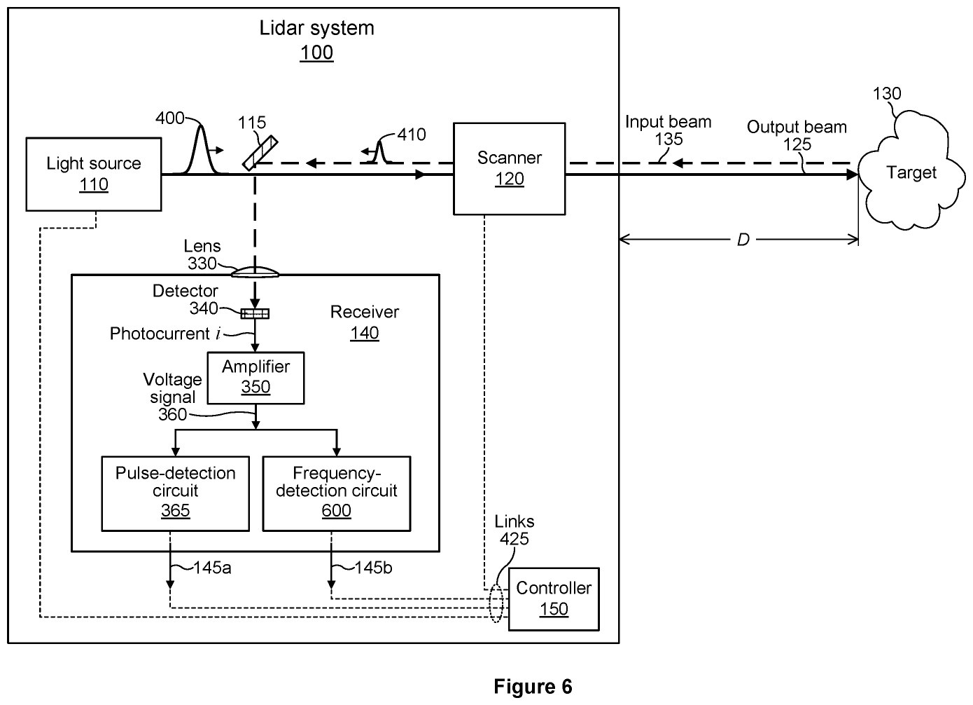

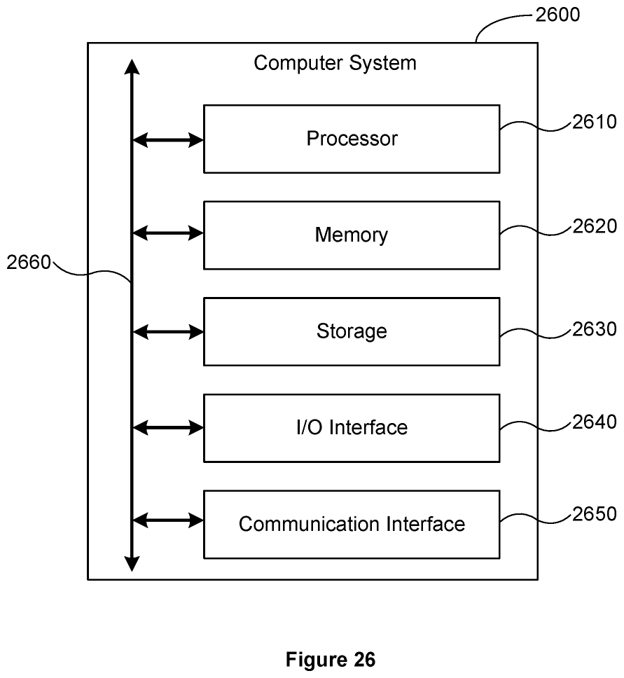

FIG. 6 illustrates an example lidar system 100 that includes a receiver 140 with a pulse-detection circuit 365 and a frequency-detection circuit 600. The lidar system 100 in FIG. 6 includes a light source 110, a scanner 120, a receiver 140, and a controller 150. The receiver 140 includes a focusing lens 330, a detector 340, an electronic amplifier 350, a pulse-detection circuit 365, and a frequency-detection circuit 600. The controller 150 may include or may be referred to as a processor or a computer system (e.g., as illustrated in FIG. 26 described herein). A lidar system 100 as illustrated in FIG. 6 and as described herein may be referred to as a lidar system with spectrally encoded light pulses. A lidar system 100 with spectrally encoded light pulses may include a light source 110 that emits pulses of light 400 that include spectral signatures. The spectral signatures may be imparted to the pulses of light 400 by the light source 110. The light source 110 in FIG. 6 emits pulses of light 400 where each emitted pulse of light may include a spectral signature. Each emitted pulse of light 400 may include one spectral signature of multiple different spectral signatures. The multiple different spectral signatures produced by the light source 110 may include 2, 4, 10, 20, 50, 100, or any other suitable number of different spectral signatures, or a virtually unlimited number of different spectral signatures. A pulse of light that includes a spectral signature may be referred to as a spectrally encoded light pulse, and a spectral signature may be referred to as a frequency signature or a spectral fingerprint.

A light source 110 of a lidar system 100 with spectrally encoded light pulses may include a seed laser that produces seed light and an optical amplifier that amplifies the seed light to produce the emitted pulses of light 400. The emitted pulses of light 400 may be part of an output beam 125 that is scanned by a scanner 120 across a field of regard of the lidar system 100. The pulses of light 400 emitted by the light source 110 may have one or more of the following optical characteristics: a wavelength between 900 nm and 2000 nm; a pulse energy between 0.01 μJ and 100 μJ; a pulse repetition frequency between 80 kHz and 10 MHz; and a pulse duration between 0.1 ns and 100 ns. For example, the light source 110 may emit pulses of light 400 with a wavelength of approximately 1550 nm, a pulse energy of approximately 0.5 μJ per pulse, a pulse repetition frequency of approximately 750 kHz, and a pulse duration of approximately 3 ns. As another example, the light source 110 may emit pulses of light 400 with a wavelength between approximately 1400 nm and approximately 1600 nm. As another example, the light source 110 may emit pulses of light 400 with a wavelength greater than or equal to 1500 nm and less than or equal to 1510 nm.

A lidar system with spectrally encoded light pulses may include a scanner 120 that scans an output beam 125 (which includes emitted pulses of light 400) across a field of regard of the lidar system 100. The scanner 120 may receive the output beam 125 from the light source 110, and the scanner 120 may include one or more scanning mirrors that scan the output beam 125. In addition to scanning the output beam 125, the scanner may also scan a FOV of a detector 340 across the field of regard so that the output beam 125 (which corresponds to the light-source FOV) and the detector FOV (which corresponds to the input beam 135) are scanned synchronously, where the scanning speeds of the light-source FOV and the detector FOV are equal. Additionally, the light-source FOV and the detector FOV may have the same relative position to one another as they are scanned across the field of regard (e.g., the light-source FOV and the detector FOV may be fully or partially overlapped, and the amount of overlap may remain approximately fixed as they are scanned). Alternatively, the lidar system 100 may be configured so that only the output beam 125 is scanned, and the detector may have a static FOV that is not scanned. In this case, the input beam 135 (which includes received pulses of light 410) may bypass the scanner 120 and be directed to the receiver 140 without passing through the scanner 120.

A lidar system with spectrally encoded light pulses may include a receiver 140 that detects received pulses of light 410. A received pulse of light 410 may include light from an emitted pulse of light 400 that is scattered by a target 130 located a distance D from the lidar system 100. A receiver 140 may include a lens 330 that focuses an input beam 135 (which includes a received pulse of light 410) onto the detector 340. In response to the received pulse of light 410, the detector 340 may produce a photocurrent signal i that corresponds to the received pulse of light 410. A detector 340 of a receiver 140 may include an avalanche photodiode (APD), a PIN photodiode, or any other suitable type of detector. A photocurrent signal i may be referred to as a photocurrent, electrical-current signal, electrical current, or current.

A receiver 140 may include one or more detectors 340, and each detector may be configured to produce a photocurrent signal i that corresponds to a received pulse of light 410. The lidar system 100 in FIG. 6 includes a receiver 140 with one detector 340 that receives a pulse of light 410 and produces a photocurrent signal i that corresponds to the received pulse of light 410. For example, in response to the received pulse of light 410, the detector 340 may produce a photocurrent signal i that includes a pulse of electrical current that corresponds to the received pulse of light 410. As another example, a receiver 140 may include a detector array that includes a one-dimensional or a two-dimensional arrangement of two or more detectors 340. A detector array may include a 1×2 one-dimensional array of two detectors 340, a 1×4 one-dimensional array of four detectors 340, an 8×12 two-dimensional array of 96 detectors 340, or any other suitable 1×n one-dimensional array of detectors 340 or m×n two-dimensional array of detectors 340 (where m and n are each integers greater than or equal to 2). A received pulse of light 410 may be incident on two or more detectors of a detector array, and each of the two or more detectors may produce a photocurrent signal i that corresponds to the received pulse of light 410.

A detector 340 producing a photocurrent signal i that corresponds to a received pulse of light 410 may refer to the detector 340 producing a pulse of current in response to receiving or detecting the pulse of light 410. Additionally, a photocurrent signal i (which includes a pulse of current) and a pulse of light 410 that correspond to one another may refer to the pulse of current and the pulse of light 410 having similar pulse characteristics (e.g., similar rise times, fall times, shapes, or durations). For example, the pulse of electrical current may have a rise time, fall time, or duration that is approximately equal to or somewhat greater than that of the pulse of light 410 (e.g., a rise time, fall time, or duration between 1× and 2× that of the pulse of light 410). The pulse of electrical current may have a somewhat longer rise time, fall time, or duration due to a limited electrical bandwidth of the detector 340 or the detector circuitry. As another example, the pulse of light 410 may have a 1-ns rise time and a 4-ns duration, and the corresponding pulse of electrical current produced by the detector 340 may have a 1.2-ns rise time and a 5-ns duration.

The photocurrent signal i produced by a detector 340 of a receiver 140 may be sent to an electronic amplifier 350. The amplifier 350 in FIG. 6 may receive the photocurrent signal i from the detector 340 and amplify the photocurrent signal to produce a voltage signal 360 that corresponds to the photocurrent signal i. For example, the detector 340 may produce a pulse of photocurrent in response to a received pulse of light 410, and the voltage signal 360 may be an analog voltage pulse that corresponds to the pulse of current. An amplifier 350 producing a voltage pulse that corresponds to a pulse of current may refer to the amplifier 350 producing the voltage pulse in response to receiving the pulse of current. Additionally, the voltage pulse and the current pulse corresponding to one another may refer to the voltage pulse and the current pulse having similar rise times, fall times, shapes, durations, or other similar characteristics. For example, the voltage pulse may have a rise time, fall time, or duration that is between 1× and 2× that of the pulse of electrical current. The voltage pulse may have a somewhat longer rise time, fall time, or duration due to a limited electrical bandwidth of the amplifier 350. As another example, the pulse of electrical current may have a 1.2-ns rise time and a 5-ns duration, and the corresponding voltage pulse may have a 1.5-ns rise time and a 7-ns duration.

A lidar system with spectrally encoded light pulses may include a frequency-detection circuit 600 that determines a spectral signature of a received pulse of light 410. The received pulse of light 410 in FIG. 6 may include a portion of light from the emitted pulse of light 400 that is scattered from the target 130. The emitted pulse of light 400 may include a spectral signature, and since the received pulse of light 410 includes a portion of the emitted pulse of light 400, the received pulse of light 410 may include approximately the same spectral signature as the emitted pulse of light 400. The spectral signature of the received pulse of light 410 may be determined based on the corresponding photocurrent signal i produced by a detector 340. The photocurrent signal i may include a pulse of current corresponding to the received pulse of light 410, and the voltage signal 360 produced by the electronic amplifier 350 may include a voltage pulse that corresponds to the pulse of current. Since the voltage signal 360 corresponds to the photocurrent signal i, determining a spectral signature based on a photocurrent signal i may include determining the spectral signature from a corresponding voltage signal 360. For example, the frequency-detection circuit 600 in FIG. 6 may determine the spectral signature of the received pulse of light 410 from the voltage signal 360, where the voltage signal 360 corresponds to the photocurrent signal i.

A lidar system with spectrally encoded light pulses may include a pulse-detection circuit 365 that determines a time-of-arrival for a received pulse of light 410. The time-of-arrival for a received pulse of light 410 may correspond to a time associated with a rising edge, falling edge, peak, or temporal center of the received pulse of light 410. The time-of-arrival of a received pulse of light 410 may be determined based on a corresponding photocurrent signal i produced by a detector 340. The photocurrent signal i may include a pulse of current corresponding to a received pulse of light 410, and an electronic amplifier 350 may produce a voltage signal 360 with a voltage pulse that corresponds to the pulse of current. The pulse-detection circuit 365 may determine the time-of-arrival of the received pulse of light 410 based on a characteristic of the voltage pulse (e.g., based on a time associated with a rising edge, falling edge, peak, or temporal center of the voltage pulse). Since the voltage signal 360 corresponds to the photocurrent signal i, determining a time-of-arrival based on a photocurrent signal i may include determining the time-of-arrival from a corresponding voltage signal 360. For example, the pulse-detection circuit 365 in FIG. 6 may determine the time-of-arrival of the received pulse of light 410 from the voltage signal 360, where the voltage signal 360 corresponds to the photocurrent signal i.

The receiver 140 in FIG. 6 detects the received pulse of light 410 and may produce an output signal (e.g., output signal 145a and 145b) that corresponds to the received pulse of light 410. For example, output signal 145a in FIG. 6 may be a digital signal that corresponds to the analog voltage signal 360, which in turn corresponds to the photocurrent signal i, which in turn corresponds to the received pulse of light 410. Output signal 145a may be referred to as a pulse-detection output signal, and output signal 145b may be referred to as a frequency-detection output signal. The time-of-arrival of the received pulse of light 410 as determined by the pulse-detection circuit 365 may be sent as output signal 145a to a controller 150. Similarly, the spectral signature of the received pulse of light 410 as determined by the frequency-detection circuit 600 may be sent as output signal 145b to a controller 150. The output signals 145a and 145b may be sent separately to the controller 150, or the output signals 145a and 145b may be sent as one output signal (e.g., as illustrated by output signal 145 in FIG. 1). The controller 150 in FIG. 6 may determine, based at least in part on the frequency-detection output signal 145b, that the spectral signature of the received pulse of light 410 matches the spectral signature of the emitted pulse of light 400. The controller 150 may also determine, based at least in part on the pulse-detection output signal 145a, the distance to the target 130.

The receiver 140 in FIG. 6 includes a separate pulse-detection circuit 365 and a separate frequency-detection circuit 600. In another embodiment, all or a portion of a pulse-detection circuit 365 and all or a portion of a frequency-detection circuit 600 may be combined together. For example, a pulse-detection circuit 365 and a frequency-detection circuit 600 may share at least some of the same hardware. As another example, a pulse-detection circuit 365 and a frequency-detection circuit 600 may be combined together into a single circuit that performs both pulse detection and frequency detection. Additionally, the output signals 145a and 145b may be combined together into a single output signal that is sent to a controller 150.

A portion of a frequency-detection circuit 600 may be included in a controller 150, or vice versa. For example, a frequency-detection circuit 600 may include a part of a controller 150, or a controller 150 may include a part of a frequency-detection circuit 600. Depending on the configuration of the frequency-detection circuit 600 and the controller 150, the spectral signature of a received pulse of light 410 being determined by a frequency-detection circuit 600 may refer to the spectral signature being determined by (i) the frequency-detection circuit 600, (ii) the frequency-detection circuit 600 and the controller 150, or (iii) the controller 150.

A portion of a pulse-detection circuit 365 may be included in a controller 150, or vice versa. For example, a pulse-detection circuit 365 may include a part of a controller 150, or a controller 150 may include a part of a pulse-detection circuit 365. Depending on the configuration of the pulse-detection circuit 365 and the controller 150, the time-of-arrival for a received pulse of light 410 being determined by a pulse-detection circuit 365 may refer to the time-of-arrival being determined by (i) the pulse-detection circuit 365, (ii) the pulse-detection circuit 365 and the controller 150, or (iii) the controller 150.

A lidar system with spectrally encoded light pulses may include a processor (e.g., controller 150) that determines the distance to a target 130 based at least in part on a time-of-arrival for a received pulse of light 410. The time-of-arrival for the received pulse of light 410 may correspond to a round-trip time (ΔT) for at least a portion of an emitted pulse of light 400 to travel to the target 130 and back to the lidar system 100, where the portion of the emitted pulse of light 400 that travels back to the target 130 corresponds to the received pulse of light 410. For example, the distance D to the target 130 may be determined from the time-of-arrival for the received pulse of light 410 and from the expression D=c ΔT/2. The round-trip time of flight may be determined from the expression ΔT=T₂−T₁, where T₂ is the time-of-arrival of the received pulse of light 410, and T₁ is a time at which the corresponding pulse of light 400 was emitted. For example, if the pulse-detection circuit 365 determines that the time ΔT between emission of optical pulse 400 and the time-of-arrival of optical pulse 410 is 1 μs, then the controller 150 may determine that the distance to the target 130 is approximately 150 m. Depending on the configuration of the pulse-detection circuit 365 and the controller 150, the distance D to a target 130 being determined by a controller 150 may refer to the distance to the target 130 being determined by (i) the pulse-detection circuit 365, (ii) the pulse-detection circuit 365 and the controller 150, or (iii) the controller 150.

A lidar system with spectrally encoded light pulses may include one or more data links 425 that couple together one or more components of the lidar system. Each link 425 in FIG. 6 represents a data link that couples the controller 150 to another component of the lidar system 100 (e.g., light source 110, scanner 120, pulse-detection circuit 365, and frequency-detection circuit 600). Each data link 425 may include one or more electrical links, one or more wireless links, or one or more optical links, and the data links 425 may be used to send data, signals, or commands to or from the controller 150. For example, the controller 150 may send a command via a link 425 to the light source 110 instructing the light source 110 to emit a pulse of light 400. As another example, the pulse-detection circuit 365 may send the output signal 145a via a link 425 to the controller 150 with time-of-arrival information for a received pulse of light 410. Similarly, the frequency-detection circuit 600 may send the output signal 145b via a link 425 to the controller 150 with spectral-signature information for the received pulse of light 410. Additionally, the controller 150 may be coupled via a link (not illustrated in FIG. 6) to a processor of an autonomous-vehicle driving system. The autonomous-vehicle processor may receive point-cloud data from the controller 150 and may provide driving decisions based on the received point-cloud data.

A lidar system with spectrally encoded light pulses may allow the determination of whether a received pulse of light 410 is associated with a particular emitted pulse of light 400. For example, a received pulse of light 410 may be unambiguously associated with an emitted pulse of light 400 based on the spectral signature of the received pulse of light 410 matching the spectral signature of the emitted pulse of light 400. A received pulse of light 410 being associated with an emitted pulse of light 400 may refer to the received pulse of light 410 including a portion of the emitted pulse of light 400. For example, if a received pulse of light 410 detected by a receiver 140 includes a portion of scattered light from an emitted pulse of light 400, then the received pulse of light 410 and the emitted pulse of light 400 may be referred to as being associated with one another. Additionally, the received pulse of light 410 and the emitted pulse of light 400 may have spectral signatures that match. In FIG. 6, the spectral signature of the received pulse of light 410 matching the spectral signature of the emitted pulse of light 400 may indicate that the received pulse of light 410 is a valid received pulse of light that is associated with and that includes a portion of the light from the emitted pulse of light 400. By determining that the spectral signatures of the received pulse of light 410 and the emitted pulse of light 400 match, the received pulse of light 410 may be determined to be associated with the emitted pulse of light 400. In another instance, if the spectral signature of a second received pulse of light 410 does not match the spectral signature of a second emitted pulse of light 400, then this may indicate that the second received pulse of light 410 is not associated with or does not include light from the second emitted pulse of light 400. For example, the second received pulse of light 410 may include light from another light source external to the lidar system 100, or the second received pulse of light 410 may include light from a different pulse of light that was emitted by the light source 110 before or after the second pulse of light 400 was emitted. If the second received pulse of light 410 includes no spectral signature (or the spectral signature is not measurable by the frequency-detection circuit 600), then a lidar system with spectrally encoded light pulses may determine that the second received pulse of light is not a valid pulse of light that was emitted by the lidar system. If the second received pulse of light 410 includes a spectral signature that does not match any of the spectral signatures of a set of recently emitted pulses of light, then the lidar system may determine that the second received pulse of light is not a valid pulse of light. If the second received pulse of light 410 includes a spectral signature that matches another emitted pulse of light different from the second emitted pulse of light, then the lidar system may determine that the second received pulse of light is associated with the other emitted pulse of light.

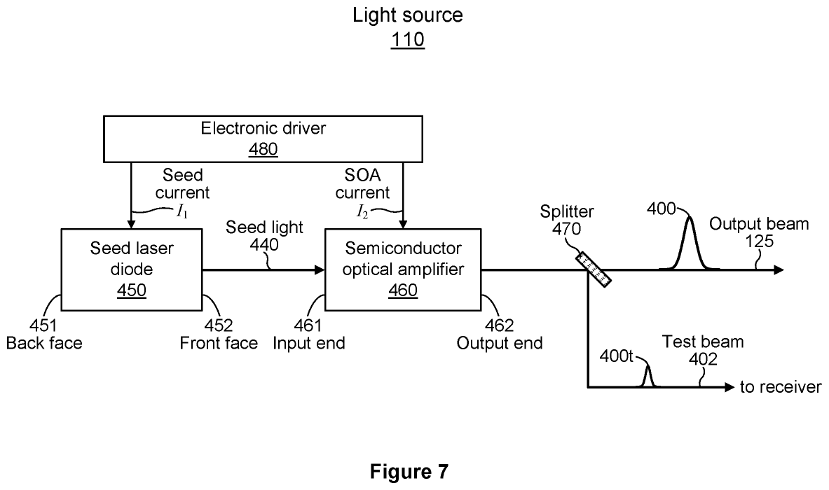

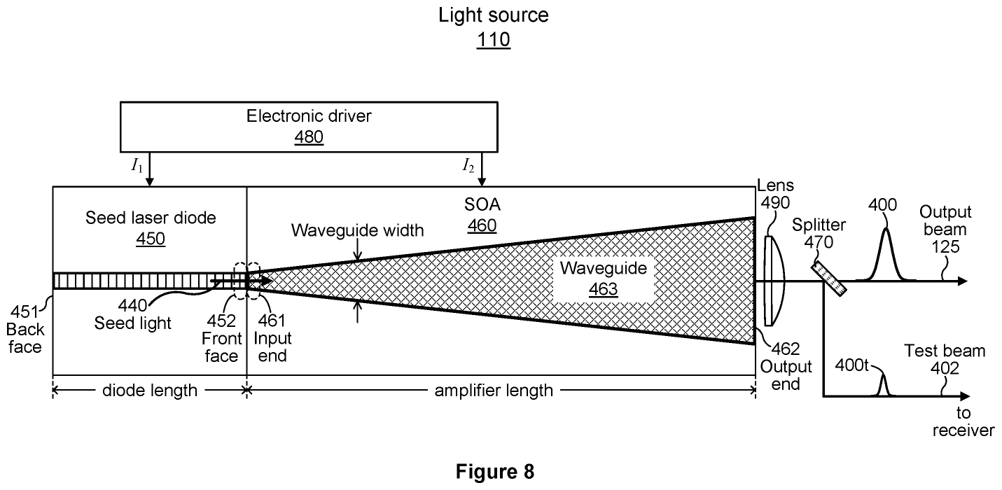

FIG. 7 illustrates an example light source 110 that includes a seed laser diode 450 and a semiconductor optical amplifier (SOA) 460. A light source 110 of a lidar system 100 with spectrally encoded light pulses may include (i) a seed laser 450 that produces seed light 440 and (ii) a pulsed optical amplifier 460 that amplifies temporal portions of the seed light 440 to produce emitted pulses of light 400, where each amplified temporal portion of the seed light corresponds to one of the emitted pulses of light 400. For example, the seed laser 450 may produce seed light 440 having a substantially constant optical power, and the optical amplifier 460 may amplify a 3-ns temporal portion of the seed light 440 to produce an emitted pulse of light 400 having a duration of approximately 3 ns. In the example of FIG. 7, the seed laser is a seed laser diode 450 that produces seed light 440. The seed laser diode 450 may include a Fabry-Perot laser diode, a quantum well laser, a DBR laser, a DFB laser, a VCSEL, a quantum dot laser diode, or any other suitable type of laser diode. In FIG. 7, the pulsed optical amplifier is a semiconductor optical amplifier (SOA) 460 that emits a pulse of light 400 that is part of the output beam 125. A SOA 460 may include a semiconductor optical waveguide that receives the seed light 440 from the seed laser diode 450 and amplifies a temporal portion of the seed light 440 as it propagates through the waveguide to produce an emitted pulse of light 400. The optical waveguide of a SOA may be tapered (e.g., as illustrated in FIG. 8) or may be a straight, non-tapered waveguide. An amplified temporal portion of the seed light 440 may be referred to as corresponding to an emitted pulse of light 400 based on the emitted pulse of light 400 including photons from the temporal portion of the seed light 440 that is amplified as well as additional photons provided by the optical amplifier 460 while amplifying the temporal portion. A SOA 460 may have an optical power gain of 20 decibels (dB), 25 dB, 30 dB, 35 dB, 40 dB, 45 dB, or any other suitable optical power gain. For example, a SOA 460 may have a gain of 40 dB, and a temporal portion of seed light 440 with an energy of 20 pJ may be amplified by the SOA 460 to produce a pulse of light 400 with an energy of approximately 0.2 μJ. A light source 110 that includes a seed laser diode 450 that supplies seed light 440 that is amplified by a SOA 460 may be referred to as a master-oscillator power-amplifier laser (MOPA laser) or a MOPA light source. The seed laser diode 450 may be referred to as a master oscillator, and the SOA 460 may be referred to as a power amplifier.

A light source 110 of a lidar system 100 with spectrally encoded light pulses may include an electronic driver 480 that (i) supplies electrical current to a seed laser 450 and (ii) supplies electrical current to a SOA 460. In FIG. 7, the electronic driver 480 supplies seed current I₁ to the seed laser diode 450 to produce the seed light 440. The seed current I₁ supplied to the seed laser diode 450 may be a substantially constant DC electrical current so that the seed light 440 includes continuous-wave (CW) light or light having a substantially constant optical power. A substantially constant current may refer to a current that changes by less than 10%, 5%, or 1% over a time interval of approximately 100 s, 10 s, or 1 s. Similarly, seed light 440 having a substantially constant optical power may refer to seed light with an optical power that changes by less than 10%, 5%, or 1% over a time interval of approximately 100 s, 10 s, or 1 s. For example, the seed current I₁ may include a substantially constant DC current of approximately 1 mA, 10 mA, 100 mA, 200 mA, 500 mA, 1 A, or any other suitable DC electrical current. Additionally or alternatively, the seed current I₁ may include pulses of electrical current so that the seed light 440 includes seed pulses of light that are amplified by the SOA 460. The seed laser 450 may be pulsed with a pulse of current having a duration that is long enough so that the wavelength of the seed light 440 stabilizes or reaches a substantially constant value at some time during the pulse. For example, the duration of the current pulse may be between 5 ns and 100 ns, and the SOA 460 may be configured to amplify a 3-ns temporal portion of the seed light 440 to produce the emitted pulse of light 400. The temporal portion of the seed light 440 that is selected for amplification may be located in time near the middle or end of the electrical current pulse to allow sufficient time for the wavelength of the seed light to stabilize.

In FIG. 7, the electronic driver 480 supplies SOA current I₂ to the SOA 460, and the SOA current I₂ provides optical gain to temporal portions of the seed light 440 that propagate through the waveguide of the SOA 460. The SOA current I₂ may include pulses of electrical current, where each pulse of current causes the SOA 460 to amplify one temporal portion of the seed light 440 to produce a corresponding emitted pulse of light 400. The SOA current I₂ may have a duration of approximately 0.5 ns, 1 ns, 2 ns, 5 ns, 10 ns, 20 ns, 50 ns, 100 ns, or any other suitable duration. The SOA current I₂ may have a peak amplitude of approximately 1 A, 2 A, 5 A, 10 A, 20 A, 50 A, 100 A, 200 A, 500 A, or any other suitable peak current. For example, the SOA current I₂ supplied to the SOA 460 may include a series of current pulses having a duration of approximately 5-10 ns and a peak current of approximately 100 A. The series of current pulses may result in the emission of a corresponding series of pulses of light 400, and each emitted pulse of light 400 may have a duration that is less than or equal to the duration of the corresponding electrical current pulse. For example, an electronic driver 480 may supply 5-ns duration current pulses to the SOA 460 at a repetition frequency of 700 kHz. This may result in emitted pulses of light 400 that have a duration of approximately 4 ns and the same pulse repetition frequency of 700 kHz.

A pulsed optical amplifier may refer to an optical amplifier that is operated in a pulsed mode so that the output beam 125 emitted by the optical amplifier includes pulses of light 400. For example, a pulsed optical amplifier may include a SOA 460 that is operated in a pulsed mode by supplying the SOA 460 with pulses of current. The seed light 440 may include CW light or light having a substantially constant optical power, and each pulse of current supplied to the SOA 460 may amplify a temporal portion of seed light to produce an emitted pulse of light 400. As another example, a pulsed optical amplifier may include an optical amplifier along with an optical modulator. The optical modulator may be any suitable optical modulator (e.g., an acousto-optic modulator (AOM), electro-optic modulator (EOM), or electro-absorption modulator (EAM)) operated in a pulsed mode so that the modulator selectively transmits pulses of light. The SOA 460 may also be operated in a pulsed mode in synch with the optical modulator to amplify the temporal portions of the seed light, or the SOA 460 may be supplied with substantially DC current to operate as a CW optical amplifier. The optical modulator may be located between the seed laser diode 450 and the SOA 460, and the optical modulator may be operated in a pulsed mode to transmit temporal portions of the seed light 440 which are then amplified by the SOA 460. Alternatively, the optical modulator may be located after the SOA 460, and the optical modulator may be operated in a pulsed mode to transmit the emitted pulses of light 400.

The seed laser diode 450 illustrated in FIG. 7 includes a front face 452 and a back face 451. The seed light 440 is emitted from the front face 452 and directed to the input end 461 of the SOA 460. The seed light 440 may be emitted as a free-space beam, and a light source 110 may include one or more lenses (not illustrated in FIG. 10) that collimate the seed light 440 emitted from the front face 452 or that focus the seed light 440 into the SOA 460. Alternatively, the seed laser diode 450 and the SOA 460 may be integrated together so that the seed light 440 is coupled directly from the seed laser diode 450 to the SOA 460. The front face 452 or back face 451 of a seed laser diode 450 may include a discrete facet formed by a semiconductor-air interface (e.g., a surface formed by cleaving or polishing a semiconductor structure to form the seed laser diode 450). Additionally, the front face 452 or the back face 451 may include a dielectric coating that provides a reflectivity (at the seed-laser operating wavelength) of between approximately 50% and approximately 99.9%. For example, the back face 451 may have a reflectivity of 90% to 99.9% at a wavelength of the seed laser.

FIG. 8 illustrates an example light source 110 that includes a semiconductor optical amplifier (SOA) 460 with a tapered optical waveguide 463. A SOA 460 may include an input end 461, an output end 462, and an optical waveguide 463 extending from the input end 461 to the output end 462. The input end 461 may receive the seed light 440 from the seed laser diode 450. The waveguide 463 may amplify a temporal portion of the seed light 440 as the temporal portion propagates along the waveguide 463 from the input end 461 to the output end 462. The amplified temporal portion may be emitted from the output end 462 as an emitted pulse of light 400. The emitted pulse of light 400 may be part of the output beam 125, and the light source 110 may include a lens 490 configured to collect and collimate the pulses of light 400 from the output end 462 to produce a collimated output beam 125. The seed laser diode 450 in FIG. 8 may have a diode length of approximately 100 μm, 200 μm, 500 μm, 1 mm, or any other suitable length. The SOA 460 may have an amplifier length of approximately 1 mm, 2 mm, 3 mm, 5 mm, 10 mm, 20 mm, or any other suitable length. For example, the seed laser diode 450 may have a diode length of approximately 300 μm, and the SOA 460 may have an amplifier length of approximately 4 mm.

A waveguide 463 may include a semiconductor optical waveguide formed at least in part by the semiconductor material of the SOA 460, and the waveguide 463 may confine light along transverse directions while the light propagates through the SOA 460. A waveguide 463 may have a waveguide width that is substantially fixed along the length of the SOA (e.g., the width at the input end 461 is approximately equal to the width at the output end 462), or a waveguide 463 may have a tapered width (e.g., as illustrated in FIG. 8). For example, a waveguide 463 may have a substantially fixed width of approximately 5 μm, 10 μm, 20 μm, 50 μm, 100 μm, 200 μm, 500 μm, or any other suitable width. In FIG. 8, the SOA 460 has a tapered waveguide 463 with a width that increases along the length of the SOA from the input end 461 to the output end 462. For example, the width of the tapered waveguide 463 at the input end 461 may be approximately equal to the width of the waveguide of the seed laser diode 450 (e.g., the waveguide width at the input end 461 may be approximately 1 μm, 2 μm, 5 μm, 10 μm, or 50 μm). At the output end 462 of the SOA 460, the tapered waveguide 463 may have a width of approximately 50 μm, 100 μm, 200 μm, 500 μm, 1 mm, or any other suitable width. As another example, the width of the tapered waveguide 463 may increase approximately linearly from a width of approximately 20 μm at the input end 461 to a width of approximately 250 μm at the output end 462.

The input end 461 or the output end 462 of a SOA 460 may be a discrete facet formed by a semiconductor-air interface. Additionally, the input end 461 or the output end 462 may include a dielectric coating (e.g., an anti-reflection coating to reduce the reflectivity of the input end 461 or the output end 462). An anti-reflection (AR) coating may have a reflectivity at the seed-laser operating wavelength of less than 5%, 2%, 0.5%, 0.1%, or any other suitable reflectivity value. In FIG. 7, the input end 461 may have an AR coating that reduces the amount of seed light 440 reflected by the input end 461. In FIG. 7 or FIG. 8, the output end 462 may have an AR coating that reduces the amount of amplified seed light reflected by the output end 462. An AR coating applied to the input end 461 or the output end 462 may also prevent the SOA 460 from acting as a laser by emitting coherent light when no seed light 440 is present.

A light source 110 may include a seed laser diode 450 and a SOA 460 that are integrated together and disposed on or in a single chip or substrate. For example, a seed laser diode 450 and a SOA 460 may each be fabricated separately and then attached to the same substrate (e.g., using epoxy, adhesive, or solder). The substrate may be electrically or thermally conductive, and the substrate may have a coefficient of thermal expansion (CTE) that is approximately equal to the CTE of the seed laser 450 and the SOA 460. As another example, the seed laser diode 450 and the SOA 460 may be fabricated together on the same substrate (e.g., using semiconductor-fabrication processes, such as for example, lithography, deposition, and etching). The seed laser diode 450 and the SOA 460 may each include InGaAs or InGaAsP semiconductor structures, and the substrate may include indium phosphide (InP). The InP substrate may be n-doped or p-doped so that it is electrically conductive, and a portion of the InP substrate may act as an anode or cathode for the seed laser diode 450 or the SOA 460. The substrate may be thermally coupled to (i) a heat sink that dissipates heat produced by the seed laser diode 450 or the SOA 460 or (ii) a temperature-control device (e.g., a thermoelectric cooler) that stabilizes the temperature of the seed laser diode 450 or the SOA 460 to a particular temperature setpoint or to within a particular temperature range. In the example of FIG. 7, the seed laser 450 and the SOA 460 may be separate devices that are not disposed on a single substrate, and the seed light 440 may be a free-space beam. Alternatively, in the example of FIG. 7, the seed laser 450 and the SOA 460 may be separate devices that are disposed together on a single substrate. In the example of FIG. 8, the seed laser 450 and the SOA 460 may be integrated together and disposed on or in a single chip or substrate (e.g., the seed laser 450 and the SOA 460 may be fabricated together on a single substrate).

In FIG. 8, rather than having a discrete facet formed by a semiconductor-air interface, the front face 452 of the seed laser diode 450 and the input end 461 of the SOA 460 may be coupled together without a semiconductor-air interface. For example, the seed laser diode 450 may be directly connected to the SOA 460 so that the seed light 440 is directly coupled from the seed laser diode 450 into the waveguide 463 of the SOA 460. The front face 452 may be butt-coupled or affixed (e.g., using an optically transparent adhesive) to the input end 461, or the seed laser diode 450 and the SOA 460 may be fabricated together so that there is no separate front face 452 or input end 461 (e.g., the front face 452 and the input end 461 may be merged together to form a single interface between the seed laser diode 450 and the SOA 460). Alternatively, the seed laser diode 450 may be coupled to the SOA 460 via a passive optical waveguide or via an optical modulator that transmits the seed light 440 from the front face 452 of the seed laser diode 450 to the input end 461 of the SOA 460. For example, an optical modulator may be located between the seed laser diode 450 and the SOA 460. The optical modulator may include an AOM, EOM, or EAM. The EOM may be a phase modulator or an amplitude modulator. For example, the optical modulator may include an electro-optic phase modulator that adds a phase or frequency modulation to seed light 440 produced by the seed laser diode 450. The electro-optic phase modulator may provide at least a portion of a spectral signature imparted to an emitted pulse of light 400.

During a period of time between two successive temporal portions of seed light 440, a SOA 460 may be configured to optically absorb most of the seed light 440 propagating in the SOA 460. The seed light 440 from the seed laser diode 450 may be coupled into the waveguide 463 of the SOA 460. Depending on the amount of SOA current I₂ supplied to the SOA 460, the seed light 440 may be optically amplified or optically absorbed while propagating along the waveguide 463. If the SOA current I₂ exceeds a threshold gain value (e.g., 100 mA) that overcomes the optical loss of the SOA 460, then the seed light 440 may be optically amplified by stimulated emission of photons. Otherwise, if the SOA current I₂ is less than the threshold gain value, then the seed light 440 may be optically absorbed. The process of optical absorption of the seed light 440 may include photons of the seed light 440 being absorbed by electrons located in the semiconductor structure of the SOA 460.

The SOA current I₂ may include pulses of current separated by a period of time that corresponds to the pulse period τ of the light source 110, and each pulse of current may result in the emission of a pulse of light 400. For example, if the SOA current I₂ includes 20-A current pulses with a 10-ns duration, then for each current pulse, a corresponding 10-ns temporal portion of the seed light 440 may be amplified, resulting in the emission of a pulse of light 400. During the time periods τ between successive pulses of current, the SOA current I₂ may be set to approximately zero or to some other value below the threshold gain value, and the seed light 440 present in the SOA 460 during those time periods may be optically absorbed. The optical absorption of the SOA 460 when the SOA current I₂ is zero may be greater than or equal to approximately 10 decibels (dB), 15 dB, 20 dB, 25 dB, or 30 dB. For example, if the optical absorption is greater than or equal to 20 dB, then less than or equal to 1% of the seed light 440 that is coupled into the input end 461 of the waveguide 463 may be emitted from the output end 462 as unwanted leakage light. Having most of the seed light 440 absorbed in the SOA 460 may prevent unwanted seed light 440 (e.g., seed light 440 located between successive pulses of light 400) from leaking out of the SOA 460 and propagating through the rest of the lidar system 100. Additionally, optically absorbing the unwanted seed light 440 may allow the seed laser 450 to be operated with a substantially constant current I₁ or a substantially constant output power so that the wavelength of the seed light 440 is stable and substantially constant.

A SOA 460 may be electrically configured as a diode with a p-doped region and an n-doped region that form a p-n junction. The SOA may include an anode and a cathode that transmit SOA current I₂ from an electronic driver 480 into or out of the p-n junction of the SOA 460. The anode may correspond to the p-doped side of the semiconductor p-n junction, and the cathode may correspond to the n-doped side. For example, the anode of the SOA 460 may include or may be electrically coupled to the p-doped region of the SOA 460, and the p-doped region may be electrically coupled to an electrically conductive electrode material (e.g., gold) deposited onto a surface of the SOA 460. The cathode may include or may be electrically coupled to a n-doped substrate located on the opposite side of the SOA 460. Alternatively, the anode of the SOA 460 may include or may be electrically coupled to a p-doped substrate of the SOA 460, and the cathode may include or may be electrically coupled to an electrode and a n-doped region of the SOA 460. The anode and cathode may be electrically coupled to the electronic driver 480, and the driver 480 may supply a positive SOA current I₂ that flows from the driver 480 into the anode, through the SOA 460, out of the cathode, and back to the driver 480. A positive SOA current I₂ flowing through the SOA 460 may correspond to the p-n junction of the SOA being in a forward-biased state which allows the current to flow. When considering the electrical current as being made up of a flow of electrons, then for a positive SOA current, the electrons may be viewed as flowing in the opposite direction (e.g., from the driver 480 into the cathode, through the SOA 460, and out of the anode and back to the driver 480).

An electronic driver 480 may be configured to electrically couple the SOA anode to the SOA cathode during a period of time between two successive pulses of current. For example, for most or all of the time period τ between two successive pulses of current, the electronic driver 480 may electrically couple the anode and cathode of the SOA 460. Electrically coupling the anode and cathode may include electrically shorting the anode directly to the cathode or coupling the anode and cathode through a particular electrical resistance (e.g., approximately 1Ω, 10Ω, or 100Ω). Alternatively, electrically coupling the anode and the cathode may include applying a reverse-bias voltage (e.g., approximately −1 V, −5 V, or −10 V) to the anode and cathode, where the reverse-bias voltage has a polarity that is opposite the forward-bias polarity associated with the applied pulses of current. By electrically coupling the anode to the cathode, the optical absorption of the SOA may be increased. For example, the optical absorption of the SOA 460 when the anode and cathode are electrically coupled may be increased (compared to the anode and cathode not being electrically coupled) by approximately 3 dB, 5 dB, 10 dB, 15 dB, or 20 dB. The optical absorption of the SOA 460 when the anode and cathode are electrically coupled may be greater than or equal to approximately 20 dB, 25 dB, 30 dB, 35 dB, or 40 dB. For example, the optical absorption of a SOA 460 when the SOA current I₂ is zero and the anode and cathode are not electrically coupled may be 20 dB. When the anode and cathode are electrically shorted together, the optical absorption may increase by 10 dB to an optical absorption of 30 dB. If the optical absorption of the SOA 460 is greater than or equal to 30 dB, then less than or equal to 0.1% of the seed light 440 that is coupled into the input end 461 of the waveguide 463 may be emitted from the output end 462 as unwanted leakage light.

A light source 110 that includes a seed laser diode 450 and a SOA 460 may be electrically configured as a three-terminal device. A three-terminal light source may include (i) a common cathode and separate, electrically isolated anodes or (ii) a common anode and separate, electrically isolated cathodes. A seed laser diode 450 may be electrically configured as a diode with a p-doped region (coupled to a seed laser anode) and a n-doped region (coupled to a seed laser cathode), where the p-doped and n-doped regions form a p-n junction. Similarly, a SOA 460 may be electrically configured as a diode with a p-doped region (coupled to a SOA anode) and a n-doped region (coupled to a SOA cathode), where the p-doped and n-doped regions form a p-n junction. A seed laser diode 450 and a SOA 460 may each have a cathode and an anode, and a common-cathode configuration may refer to the cathodes of the seed laser diode 450 and the SOA 460 being electrically connected together into a single electrical terminal or contact that is connected to an electronic driver 480. A light source 110 configured as a three-terminal common-cathode device may include a seed laser anode, a SOA anode, and a common cathode. The seed laser anode and the SOA anode may be electrically isolated from one another, and the seed laser cathode and the SOA cathode may be electrically connected together to form the common cathode. Alternatively, a light source 110 may be configured as a three-terminal common-anode device that includes a seed laser cathode, a SOA cathode, and a common anode. The seed laser cathode and the SOA cathode may be electrically isolated from one another, and the seed laser anode and the SOA anode may be electrically connected together to form the common anode.

Two terminals (e.g., two anodes or two cathodes) being electrically isolated from one another may refer to the two terminals having greater than a particular value of electrical resistance between them (e.g., the resistance between two electrically isolated anodes may be greater than 1 kΩ, 10 kΩ, 100 kΩ, or 1 MΩ). Two terminals (e.g., two anodes or two cathodes) being electrically connected may refer to the two terminals having less than a particular value of electrical resistance between them (e.g., the resistance between two electrically connected cathodes may be less than 1 kΩ, 100 Ω, 10Ω, or 1Ω). A common-anode or common-cathode configuration may be provided by combining or electrically connecting the respective anodes or cathodes through an electrically conductive substrate. For example, a seed laser diode 450 and a SOA 460 may be fabricated separately and then affixed to an electrically conductive substrate so that their anodes or cathodes are electrically connected. As another example, a substrate may include an electrically conductive semiconductor material on which a seed laser diode 450 and SOA 460 are grown. The seed laser diode 450 and the SOA 460 may each include an InGaAs or InGaAsP semiconductor structure grown on an InP substrate. The InP substrate may be n-doped so that it is electrically conductive, and the cathodes of the seed laser diode 450 and the SOA 460 may each be electrically connected to the InP substrate so that the InP substrate acts as a common cathode. Alternatively, the InP substrate may be p-doped, and the anodes of the seed laser diode 450 and the SOA 460 may each be electrically connected to the InP substrate, which acts as a common anode.

One or more of the light sources 110 illustrated in FIGS. 7-8 and described herein may be configured as a three-terminal device (with a common cathode or a common anode). For example, the light source 110 in FIG. 8 may be configured as a three-terminal common-cathode device having separate electrical connections between the electronic driver 480 and each of these three electrical terminals or contacts: (i) seed laser anode, (ii) SOA anode, and (iii) common cathode. In a three-terminal common-cathode device, the seed laser anode and the SOA anode may be electrically isolated from one another, and an electronic driver 480 may drive the seed laser diode 450 and the SOA 460 by supplying separate electrical signals to the seed laser anode and the SOA anode. The common cathode may act as a common return path for currents from the seed laser diode 450 and the SOA 460 to combine and return to the electronic driver 480.

A light source 110 that includes a seed laser diode 450 and a SOA 460 may be configured as a four-terminal device. In a four-terminal light source 110, the seed laser anode and the SOA anode may be electrically isolated from one another, and instead of having a common cathode, the seed laser cathode and the SOA cathode may also be electrically isolated from one another. One or more of the light sources 110 described herein may be configured as a four-terminal device. For example, the light source 110 in each of FIGS. 7 and 8 may be configured as a four-terminal device with two electrically isolated anodes (seed laser anode and SOA anode) and two electrically isolated cathodes (seed laser cathode and SOA cathode). A four-terminal light source 110 may have separate electrical connections between an electronic driver 480 and each of these four electrical terminals or contacts: (i) seed laser anode, (ii) seed laser cathode, (iii) SOA anode, and (iv) SOA cathode. An electronic driver 480 may drive the anode and cathode of the seed laser diode 450 separately or independently from the anode and cathode of the SOA 460. As compared to a three-terminal light source 110, a light source configured as a four-terminal device may provide improved electrical isolation between the seed laser diode 450 and the SOA 460. For example, in a four-terminal light source 110, applying a pulse of current to the SOA 460 may result in a reduced amount of unwanted cross-talk current that is coupled to the seed laser diode 450.

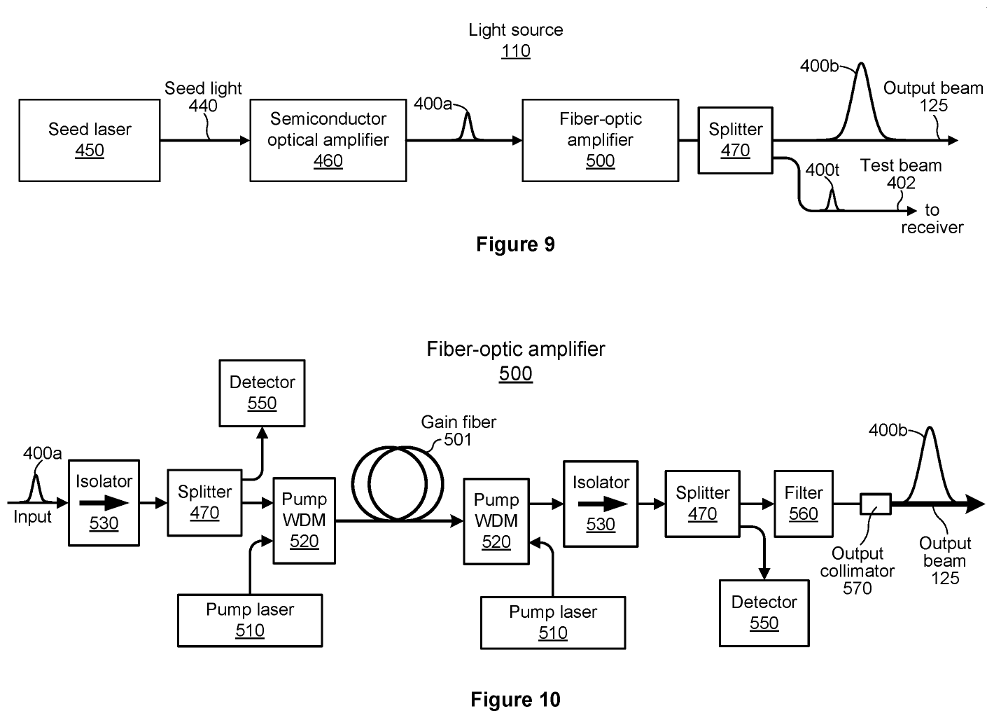

FIG. 9 illustrates an example light source 110 that includes a seed laser 450, a semiconductor optical amplifier (SOA) 460, and a fiber-optic amplifier 500. In addition to a seed laser 450 and a pulsed optical amplifier 460, a light source 110 may also include a fiber-optic amplifier 500 that amplifies pulses of light 400a produced by the pulsed optical amplifier 460. In FIG. 9, the SOA 460 may amplify temporal portions of seed light 440 from the seed laser 450 to produce pulses of light 400a, and the fiber-optic amplifier 500 may further amplify the pulses of light 400a from the SOA 460 to produce amplified pulses of light 400b. In FIG. 9, the pulses of light 400a produced by the SOA 460 may be referred to as initial pulses of light. The amplified pulses of light 400b (which may be referred to as emitted pulses of light) may be part of a free-space output beam 125 that is sent to a scanner 120 and scanned across a field of regard of a lidar system 100. Each amplified temporal portion of the seed light 440 may correspond to one of the initial pulses of light 400a, which in turn may correspond to one of the emitted pulses of light 400b. Each initial pulse of light 400a may include a spectral signature, and the corresponding emitted pulse of light 400b may include substantially the same spectral signature as the initial pulse of light 400a. For example, the spectral signature imparted to an initial pulse of light 400a by the seed laser 450 or the SOA 460 may be substantially preserved when the initial pulse of light 400a is amplified by the fiber-optic amplifier 500 so that the emitted pulse of light 400b includes substantially the same spectral signature as the initial pulse of light 400a.

A SOA 460 and a fiber-optic amplifier 500 may each have an optical power gain of 10 dB, 15 dB, 20 dB, 25 dB, 30 dB, 35 dB, 40 dB, or any other suitable optical power gain. In the example of FIG. 9, the SOA 460 may have a gain of 30 dB, and the fiber-optic amplifier 500 may have a gain of 20 dB, which corresponds to an overall gain of 50 dB. A temporal portion of seed light 440 with an energy of 5 pJ may be amplified by the SOA 460 (with a gain of 30 dB) to produce an initial pulse of light 400a with an energy of approximately 5 nJ. The fiber-optic amplifier 500 may amplify the 5-nJ pulse of light 400a by 20 dB to produce an output pulse of light 400b with an energy of approximately 0.5 μJ.

FIG. 10 illustrates an example fiber-optic amplifier 500. A light source 110 of a lidar system 100 may include a fiber-optic amplifier 500 that amplifies pulses of light 400a produced by a SOA 460 to produce an output beam 125 with amplified pulses of light 400b. A fiber-optic amplifier 500 may be terminated by a lens (e.g., output collimator 570) that produces a collimated free-space output beam 125 which may be directed to a scanner 120. A fiber-optic amplifier 500 may include one or more pump lasers 510, one or more pump WDMs 520, one or more optical gain fibers 501, one or more optical isolators 530, one or more optical splitters 470, one or more detectors 550, one or more optical filters 560, or one or more output collimators 570.

A fiber-optic amplifier 500 may include an optical gain fiber 501 that is optically pumped (e.g., provided with energy) by one or more pump lasers 510. The optically pumped gain fiber 501 may provide optical gain to each input pulse of light 400a while propagating through the gain fiber 501. The pump-laser light may travel through the gain fiber 501 in the same direction (co-propagating) as the pulse of light 400a or in the opposite direction (counter-propagating). The fiber-optic amplifier 500 in FIG. 10 includes one co-propagating pump laser 510 on the input side of the amplifier 500 and one counter-propagating pump laser 510 on the output side. A pump laser 510 may produce light at any suitable wavelength to provide optical excitation to the gain material of gain fiber 501 (e.g., a wavelength of approximately 808 nm, 810 nm, 915 m, 940 nm, 960 nm, 976 nm, or 980 nm). A pump laser 510 may be operated as a CW light source and may produce any suitable amount of average optical pump power, such as for example, approximately 1 W, 2 W, 5 W, 10 W, or 20 W of pump power. The pump-laser light from a pump laser 510 may be coupled into gain fiber 501 via a pump wavelength-division multiplexer (WDM) 520. A pump WDM 520 may be used to combine or separate pump light and the pulses of light 400a that are amplified by the gain fiber 501.

The fiber-optic core of a gain fiber 501 may be doped with a gain material that absorbs pump-laser light and provides optical gain to pulses of light 400a as they propagate along the gain fiber 501. The gain material may include rare-earth ions, such as for example, erbium (Er³⁺), ytterbium (Yb³⁺), neodymium (Nd³⁺), praseodymium (Pr³⁺), holmium (Ho′), thulium (Tm³⁺), dysprosium (Dy³⁺), or any other suitable rare-earth element, or any suitable combination thereof. For example, the gain fiber 501 may include a core doped with erbium ions or with a combination of erbium and ytterbium ions. The rare-earth dopants absorb pump-laser light and are “pumped” or promoted into excited states that provide amplification to the pulses of light 400a through stimulated emission of photons. The rare-earth ions in excited states may also emit photons through spontaneous emission, resulting in the production of amplified spontaneous emission (ASE) light by the gain fiber 501.

A gain fiber 501 may include a single-clad or multi-clad optical fiber with a core diameter of approximately 6 μm, 7 μm, 8 μm, 9 μm, 10 μm, 12 μm, 20 μm, 25 μm, or any other suitable core diameter. A single-clad gain fiber 501 may include a core surrounded by a cladding material, and the pump light and the pulses of light 400a may both propagate substantially within the core of the gain fiber 501. A multi-clad gain fiber 501 may include a core, an inner cladding surrounding the core, and one or more additional cladding layers surrounding the inner cladding. The pulses of light 400a may propagate substantially within the core, while the pump light may propagate substantially within the inner cladding and the core. The length of gain fiber 501 in an amplifier 500 may be approximately 0.5 m, 1 m, 2 m, 4 m, 6 m, 10 m, 20 m, or any other suitable gain-fiber length.

A fiber-optic amplifier 500 may include one or more optical filters 560 located at the input or output side of the amplifier 500. An optical filter 560 (which may include an absorptive filter, dichroic filter, long-pass filter, short-pass filter, band-pass filter, notch filter, Bragg grating, or fiber Bragg grating) may transmit light over a particular optical pass-band and substantially block light outside of the pass-band. The optical filter 560 in FIG. 10 is located at the output side of the amplifier 500 and may reduce the amount of ASE from the gain fiber 501 that accompanies the output pulses of light 400b. For example, the filter 560 may transmit light at the wavelength of the pulses of light 400a (e.g., 1550 nm) and may attenuate light at wavelengths away from a 5-nm pass-band centered at 1550 nm.

A fiber-optic amplifier 500 may include one or more optical isolators 530. An isolator 530 may reduce or attenuate backward-propagating light, which may destabilize or cause damage to a seed laser diode 450, SOA 460, pump laser 510, or gain fiber 501. The isolators 530 in FIG. 10 may allow light to pass in the direction of the arrow drawn in the isolator and block light propagating in the reverse direction. Backward-propagating light may arise from ASE light from gain fiber 501, counter-propagating pump light from a pump laser 510, or optical reflections from one or more optical interfaces of a fiber-optic amplifier 500. An optical isolator 530 may prevent the destabilization or damage associated with backward-propagating light by blocking most of the backward-propagating light (e.g., by attenuating backward-propagating light by greater than or equal to 5 dB, 10 dB, 20 dB, 30 dB, 40 dB, 50 dB, or any other suitable attenuation value).

A fiber-optic amplifier 500 may include one or more optical splitters 470 and one or more detectors 550. A splitter 470 may split off a portion of light (e.g., approximately 0.1%, 0.5%, 1%, 2%, or 5% of light received by the splitter 470) and direct the split off portion to a detector 550. In FIG. 10, each splitter 470 may split off and send approximately 1% of each pulse of light (400a or 400b) to a detector 550. One or more detectors 550 may be used to monitor the performance or health of a fiber-optic amplifier 500. If an electrical signal from a detector 550 drops below a particular threshold level, then a controller 150 may determine that there is a problem with the amplifier 500 (e.g., there may be insufficient optical power in the input pulses of light 400a or a pump laser 510 may be failing). In response to determining that there is a problem with the amplifier 500, the controller 150 may shut down or disable the amplifier 500, shut down or disable the lidar system 100, or send a notification that the lidar system 100 is in need of service or repair.

A fiber-optic amplifier 500 may include an input optical fiber configured to receive input pulses of light 400a from a SOA 460. The input optical fiber may be part of or may be coupled or spliced to one of the components of the fiber-optic amplifier 500. For example, pulses of light 400a may be coupled into an optical fiber which is spliced to an input optical fiber of the isolator 530 located at the input to the amplifier 500. As another example, the pulses of light 400a from a SOA 460 may be part of a free-space beam that is coupled into an input optical fiber of fiber-optical amplifier 500 using one or more lenses. As another example, an input optical fiber of fiber-optic amplifier 500 may be positioned at or near the output end 462 of a SOA 460 so that the pulses of light 400a are directly coupled from the SOA 460 into the input optical fiber.

The optical components of a fiber-optic amplifier 500 may be free-space components, fiber-coupled components, or a combination of free-space and fiber-coupled components. As an example, each optical component in FIG. 10 may be a free-space optical component or a fiber-coupled optical component. As another example, the input pulses of light 400a may be part of a free-space optical beam, and the isolator 530, splitter 470, and pump WDM 520 located on the input side of the amplifier 500 may each be free-space optical components. Additionally, the light from the pump laser 510 on the input side may be a free-space beam that is combined with the input pulses of light 400a by the pump WDM 520 on the input side, and the combined pump-seed light may form a free-space beam that is coupled into the gain fiber 501 via one or more lenses.

A light source 110 may include (i) a passive optical waveguide that includes an optical filter and (ii) a SOA 460, where the passive optical waveguide and the SOA 460 are optically coupled to one another. Additionally, the light source 110 may include an electronic driver 480 that supplies pulses of electrical current to the SOA 460, where each pulse of current causes the SOA to produce an emitted pulse of light 400. A passive optical waveguide may refer to an optical waveguide that provides optical guidance or confinement to light propagating through the waveguide but does not provide optical gain to the propagating light and does not produce light. The passive optical waveguide may act as an external optical cavity coupled to the SOA 460, and the optical filter may reflect a portion of light produced by the SOA back to the SOA. The optical filter may include a discrete optical filter that is attached to or integrated into the passive optical waveguide (e.g., the optical filter may include a dielectric coating deposited onto a back face of the waveguide). Additionally or alternatively, the optical filter may include a distributed optical filter, such as for example, a distributed Bragg reflector that includes a refractive index that varies along all or part of the length of the waveguide. Since the passive optical waveguide is optically coupled to the SOA 460, the passive optical waveguide may receive a portion of light produced by the SOA 460 when a pulse of current is applied. The optical filter of the passive optical waveguide may transmit a portion of the received light, and the transmitted portion may exit the waveguide through the back face. Additionally, the optical filter may reflect a portion of the received light back to the SOA 460, and the reflected portion may include light within a particular wavelength range, based on the configuration of the optical filter. For example, the optical filter may reflect light within a particular wavelength range and may transmit light outside of the particular wavelength range. As another example, the portion of light produced by the SOA 460 that is received by the passive optical waveguide may include light with an optical spectrum from approximately 1540 nm to approximately 1560 nm, and the portion of light reflected back to the SOA 460 by the optical filter may include light from approximately 1549 nm to approximately 1551 nm. The optical characteristics or the spectral signature of an emitted pulse of light 400 resulting from a pulse of current supplied to the SOA 460 may depend at least in part on (i) the electrical characteristics of the pulse of current (e.g., rise time, fall time, amplitude, or duration) and (ii) the optical characteristics of the passive optical waveguide and the optical filter (e.g., waveguide length, the filter reflection or transmission bandwidth, or other filter characteristics).

A light source 110 that includes a passive optical waveguide and a SOA 460 may be similar to the light source 110 illustrated in FIG. 8, except a passive optical waveguide may be used in place of the seed laser diode 450. For example, the seed laser diode 450 in FIG. 8 may be replaced with a passive optical waveguide having a distributed optical filter with a refractive index that varies periodically along the length of the waveguide. As another example, the light source 110 in FIG. 8 may be configured to operate as a light source with a passive optical waveguide and a SOA by setting the seed current I₁ to zero amperes. Instead of supplying a non-zero seed current I₁ to the seed laser diode 450, the seed laser diode 450 may be supplied with no seed current so that the seed laser diode 450 does not produce any seed light 440. In this embodiment, the seed laser diode 450 may act as a passive optical waveguide that is optically coupled to the SOA 460. Additionally, the seed laser diode 450 may be a DFB laser diode that includes a refractive index that varies along the length of the device, and the variation in refractive index may provide an optical filter that reflects and transmits particular wavelengths of light. To set the seed current I₁ to zero, the anode and cathode of the seed laser diode 450 may be electrically coupled together by (i) shorting the anode to the cathode or coupling the anode and cathode through an electrical resistance or (ii) applying a reverse-bias voltage to the anode and cathode. Alternatively, the anode and cathode may be left as an open circuit so that there is no direct electrical connection between the anode and cathode. In another embodiment, a non-zero electrical current I₁ may be supplied to the seed laser diode 450. The electrical current h may include a substantially constant DC electrical current or may include pulses of current (e.g., with a particular rise time, fall time, amplitude, or duration), and the electrical current I₁ may be configured so that the seed laser diode 450 provides little or no optical gain, or produces little or no seed light. The spectral signature of an emitted pulse of light 400 resulting from a pulse of current supplied to the SOA 460 may depend at least in part on (i) the electrical characteristics of the pulse of current (e.g., rise time, fall time, amplitude, or duration) and (ii) the optical characteristics of the seed laser diode (e.g., waveguide length, filter reflection or transmission bandwidth, or other filter characteristics). Additionally, if a non-zero electrical current I₁ is supplied to the seed laser diode 450, the spectral signature of an emitted pulse of light 400 may depend on the electrical characteristics of the current I₁.

A light source 110 of a lidar system 100 with spectrally encoded light pulses may be configured to emit test pulses of light 400t. In addition to producing an output beam 125 with emitted pulses of light 400, a light source 110 may also produce a test beam 402 that includes test pulses of light 400t, where each test pulse of light 400t is associated with one of the emitted pulses of light 400. Each test pulse of light 400t may include a small portion of an associated emitted pulse of light 400. For example, the test pulse 400t in FIG. 7 may include approximately 1% of the light from the emitted pulse of light 400 (e.g., the test pulse 400t may have a pulse energy that is approximately 1% of the pulse energy of the emitted pulse of light 400). A test pulse 400t that is associated with an emitted pulse of light 400 may refer to the test pulse 400t including a portion of the emitted pulse of light 400. Additionally, a test pulse 400t that is associated with an emitted pulse of light 400 may refer to the test pulse 400t having approximately the same spectral signature as the emitted pulse of light 400. For example, an emitted pulse of light 400 may include a spectral signature, and since the associated test pulse of light 400t includes a portion of the emitted pulse of light 400, the test pulse 400t may include approximately the same spectral signature as the emitted pulse of light 400. In FIG. 7, the test beam 402 (which includes a test pulse of light 400t) may be directed to a receiver 140, and a frequency-detection circuit 600 may determine a spectral signature of the test pulse 400t.

A light source 110 may include an optical splitter 470 that splits off a portion of each emitted pulse of light 400 to produce an associated test pulse of light 400t. The light source 110 in each of FIGS. 7-9 includes an optical splitter 470 that splits off a portion of the output beam 125 (which includes an emitted pulse of light 400) to produce a test beam 402 (which includes a test pulse of light 400t). An optical splitter 470 may split off less than approximately 5% of the pulse energy of each emitted pulse of light 400 or less than approximately 5% of the average power of an output beam 125. For example, an optical splitter 470 may split off less than or equal to approximately 0.001%, 0.01%, 0.1%, 1%, 5%, or any other suitable percentage of an emitted pulse of light 400 to produce a test pulse of light 400t. As another example, if an emitted pulse of light 400 has a pulse energy of 1 μJ and the splitter splits off 0.1% of the emitted pulse of light 400, then the test pulse of light 400t may have a pulse energy of approximately 1 nJ. An optical splitter 470 may be a free-space optical splitter, a fiber-optic splitter, or an optical-waveguide splitter. For example, the optical splitter 470 in each of FIGS. 7 and 8 may be a free-space optical splitter, and the optical splitter 470 in FIG. 9 may be a fiber-optic splitter. The splitter 470 in FIG. 9 is located after the fiber-optic amplifier 500. In another embodiment, the splitter 470 in FIG. 9 may be disposed between the SOA 460 and the fiber-optic amplifier 500 so that the splitter 470 splits off a portion of each initial pulse of light 400a to produce a test pulse of light 400t. Alternatively, the splitter 470 in FIG. 9 may be located within the fiber-optic amplifier 500.

The output beam 125 in FIG. 8 may be directed to a scanner 120, and the test beam 402 (which includes a test pulse of light 400t) may be directed to a receiver 140. The receiver 140 may detect the test pulse of light 400t, and the receiver 140 may include a frequency-detection circuit 600 that determines the spectral signature of the test pulse of light 400t. The frequency-detection circuit 600 may determine the spectral signature of each emitted pulse of light 400 based on the spectral signature of an associated test pulse of light 400t. Since the test pulse of light 400t in FIG. 8 may include substantially the same spectral signature as the associated emitted pulse of light 400, the spectral signature of the emitted pulse of light 400 may be determined by determining the spectral signature of the associated test pulse of light 400t.

After the test pulse of light 400t is detected by the receiver 140, the receiver may detect a received pulse of light 410 that includes scattered light from the associated emitted pulse of light 400. The frequency-detection circuit 600 may determine the spectral signature of the received pulse of light 410, and a controller 150 may determine that the spectral signature of the received pulse of light 410 matches the spectral signature of the test pulse of light 400t. Based on the spectral signature of the received pulse of light 410 matching the spectral signature of the test pulse of light 400t, the controller 150 may determine that the spectral signature of the received pulse of light 410 matches the spectral signature of the emitted pulse of light 400. Since the test pulse of light 400t may include substantially the same spectral signature as the associated emitted pulse of light 400, determining that the spectral signature of a received pulse of light 410 matches the spectral signature of the emitted pulse of light 400 may include determining that the spectral signature of the received pulse of light 410 matches the spectral signature of the test pulse 400t associated with the emitted pulse of light 400. Similarly, determining that the spectral signature of a second received pulse of light does not match the spectral signature of the emitted pulse of light 400 may include determining that the spectral signature of the second received pulse of light does not match the spectral signature of the test pulse 400t associated with the emitted pulse of light 400. Additionally, determining that the spectral signature of the second received pulse of light matches the spectral signature of a second emitted pulse of light may include determining that the spectral signature of the second received pulse of light matches the spectral signature of a test pulse associated with the second emitted pulse of light.

A lidar system 100 may include a receiver 140 that detects and determines the spectral signatures of a received pulse of light 410 and a test pulse of light 400t. The same detector 340 may be used to detect both the received pulse of light 410 and the test pulse of light 400t, or a receiver 140 may include separate detectors for detecting the two pulses of light separately. Additionally, the same frequency-detection circuit 600 of a receiver 140 may be used to determine the spectral signatures of both a received pulse of light 410 and a test pulse of light 400t. Alternatively, a receiver may include separate circuits that determine the spectral signatures of the two pulses of light separately.

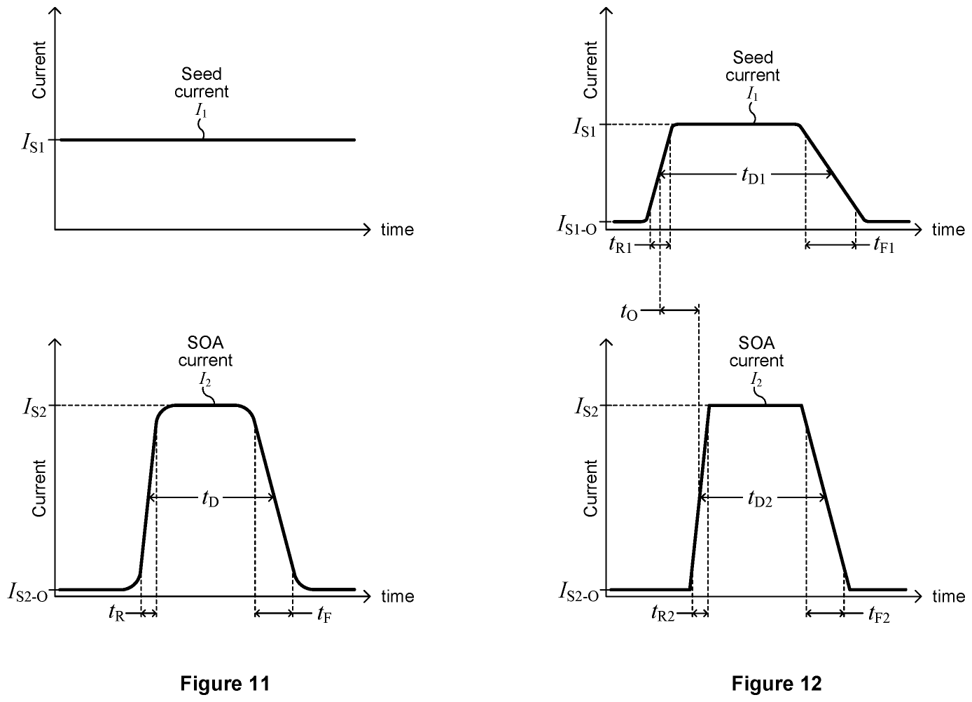

FIGS. 11-12 each illustrates an example seed current I₁ and an example SOA current h. Each of the two graphs of seed current I₁ represents the electrical current supplied to a seed laser diode 450 by an electronic driver 480, and each of the two graphs of SOA current I₂ represents the electrical current supplied to a SOA 460 by an electronic driver 480. The graphs in FIGS. 11-12 are plotted versus time to illustrate the behavior of the seed current and SOA current as a function of time.

In FIG. 11, the seed current I₁ is substantially constant, and the corresponding seed light 440 produced by the seed laser diode 450 may have a substantially constant optical power. For example, the amplitude I_{S1} of the seed current I₁ may be approximately 1 mA, 10 mA, 100 mA, 200 mA, 500 mA, 1 A, or any other suitable current value. As another example, the amplitude I_{S1} of the seed current I₁ may be approximately zero amperes so that there is substantially no current applied to the seed laser diode 450. With the seed current set to zero amperes, the seed laser diode 450 may operate as a passive optical waveguide with an optical filter, and the seed laser diode 450 may be part of a light source 110 where the passive optical waveguide is optically coupled to a SOA 460.

The SOA current I₂ in FIG. 11 includes one pulse of current that is supplied to a SOA 460. The SOA current pulse may cause the SOA 460 to amplify a temporal portion of the seed light 440 to produce an emitted pulse of light 400. The temporal portion of the seed light 440 that is amplified may correspond to seed light that temporally coincides with the time interval t_{D} in FIG. 11. The amplitude I_{S2} of the SOA current pulse may be approximately 1 A, 2 A, 5 A, 10 A, 20 A, 50 A, 100 A, 200 A, 500 A, or any other suitable peak current value. In addition to the current pulse, the SOA current I₂ may include a substantially constant offset current I_{S2-O}. The offset current I_{S2-O} may be approximately 1 mA, 100 mA, 1 A, or any other suitable current value, or the offset current I_{S2-O} may be approximately zero amperes so that there is substantially no offset current applied to the SOA. The SOA current pulse has a duration of t_{D}, a rise time of t_{R}, and a fall time of t_{F}. The duration t_{D} of the SOA current pulse may be approximately 0.5 ns, 1 ns, 2 ns, 5 ns, 10 ns, 20 ns, 50 ns, 100 ns, or any other suitable duration. The rise time t_{R} and the fall time t_{F} may each be approximately 0.1 ns, 0.2 ns, 0.5 ns, 1 ns, 2 ns, 5 ns, 10 ns, or any other suitable time. For example the duration of the SOA current pulse may be 5 ns, the rise time may be 0.5 ns, and the fall time may be 1 ns. The rise time t_{R} and the fall time t_{F} may each correspond to a time for the SOA current I₂ to change from one value to another. For example, a rise time t_{R} may equal a time for the SOA current I₂ to change from 10% to 90% of a peak value (e.g., from 10% of I_{S2} to 90% of I_{S2}, or from 10% of (I_{S2}-I_{S2-O} to 90% of (I_{S2}-I_{S2-O}). Similarly, a fall time t_{F} may equal a time for the SOA current I₂ to change from 90% to 10% of a peak value

In FIG. 11, the spectral signature imparted to an emitted pulse of light 400 by a light source 110 may depend at least in part on one or more of the following electrical-current parameters: the amplitude I_{S1} of the substantially constant seed current I₁, the amplitude I_{S2} of the SOA current pulse, the amplitude of the substantially constant SOA offset current I_{S2-O}, the duration t_{D} of the SOA current pulse, the rise time t_{R} of the SOA current pulse, the fall time t_{F} of the SOA current pulse, and the shape of the SOA current pulse. For example, an electronic driver 480 may supply a substantially constant seed current I₁ of approximately 250 mA and a substantially constant SOA offset current I_{S2-O} of zero amperes. Additionally, the electronic driver 480 may supply a current pulse to the SOA 460 with an amplitude I_{S2} of 20 A, a duration t_{D} of 3 ns, a rise time t_{R} of 0.5 ns, and a fall time t_{F} of 1 ns. The electrical-current characteristics of the seed current I₁ and the SOA current I₂ may result in an emitted pulse of light 400 having a particular spectral signature. For example, the spectral signature imparted to the emitted pulse of light may result in a photocurrent signal i produced by a detector 340 having a beat signal with a beat frequency of approximately 500 MHz or a beat frequency between 450 MHz and 550 MHz. The shape of a current pulse may be approximately trapezoidal, square, triangular, or any other suitable shape. Additionally, a current pulse may have corners that are rounded (e.g., as illustrated by the SOA current pulse in FIG. 11) or relatively sharp (e.g., as illustrated by the SOA current pulse in FIG. 12). Each of the current pulses in FIGS. 11 and 12 may be referred to as having an approximately trapezoidal shape.

An electronic driver 480 may supply current pulses to a SOA 460 having two or more different pulse characteristics, and the different pulse characteristics may result in emitted pulses of light that have different respective spectral signatures. For example, an electronic driver 480 may alternate between supplying pulses of current to the SOA 460 having two or more different amplitudes I_{S2}, two or more different offset currents I_{S2-O}, two or more different durations t_{D}, two or more different rise times t_{R}, two or more different fall times t_{F}, two or more different shapes, or any suitable combination thereof. As another example, an electronic driver 480 may supply pulses of current to the SOA 460 with an amplitude I_{S2} of 30 A, a rise time t_{R} of 1 ns, a fall time t_{F} of 2 ns, and a duration t_{D} that alternates between 4 ns and 8 ns. The two different durations may result in emitted pulses of light 400 that alternate between two different spectral signatures. As another example, an electronic driver 480 may supply pulses of current to the SOA 460 with an amplitude I_{S2} of 20 A, a duration t_{D} of 5 ns, a fall time t_{F} of 1 ns, and a rise time t_{R} that alternates between 0.5 ns and 1 ns. The two different rise times may result in each emitted pulse of light 400 having one of two different spectral signatures, each spectral signature corresponding to one of the rise times. For example, a first pulse of light produced from a current pulse with a 0.5-ns rise time may have a first spectral signature that is associated with a beat signal having a 500-MHz beat frequency, and a second pulse of light produced from a current pulse with a 1-ns rise time may have a second spectral signature that is associated with a beat signal having a 300-MHz beat frequency. As another example, a first pulse of light produced from a current pulse with a 0.5-ns rise time may have a first spectral signature associated with a beat frequency between 450 MHz and 550 MHz, and a second pulse of light produced from a current pulse with a 1-ns rise time may have a second spectral signature associated with a beat frequency between 250 MHz and 350 MHz.

FIG. 12 is similar to FIG. 11, except the seed current I₁ in FIG. 12 includes a pulse of seed current that is supplied to a seed laser diode 450. The seed current pulse may cause the seed laser diode 450 to produce a pulse of seed light 440, and the corresponding SOA current pulse may cause the SOA 460 to amplify at least a portion of the seed pulse of light to produce an emitted pulse of light 400. The amplitude I_{S1} of the seed current pulse may be approximately 10 mA, 100 mA, 500 mA, 1 A, 10 A, or any other suitable peak current value. In addition to the seed current pulse, the seed current I₁ in FIG. 12 may also include a substantially constant offset current I_{S1-O}. The offset current I_{S1-O} may be approximately 1 mA, 10 mA, 50 mA, or any other suitable current value, or the offset current I_{S1-O} may be approximately zero amperes so that there is substantially no offset current applied to the seed laser. The seed current pulse has a duration of t_{D1}, a rise time of t_{R1}, and a fall time of t_{F1}. The duration t_{D1} of the seed current pulse may be approximately 0.5 ns, 1 ns, 2 ns, 5 ns, 10 ns, 20 ns, 50 ns, 100 ns, or any other suitable duration. The rise time t_{R1} and the fall time t_{F1} may each be approximately 0.1 ns, 0.2 ns, 0.5 ns, 1 ns, 2 ns, 5 ns, 10 ns, or any other suitable time. For example the duration of the seed current pulse may be 10 ns, the rise time may be 2 ns, and the fall time may be 3 ns.

The SOA current I₂ in FIG. 12 includes one pulse of current that is supplied to a SOA 460. The SOA current pulse may cause the SOA 460 to amplify at least a portion of the corresponding seed pulse of light to produce an emitted pulse of light 400. The portion of the seed light 440 that is amplified may correspond to seed light that temporally coincides with the time interval t_{D2} in FIG. 12. The amplitude I_{S2} of the SOA current pulse may be approximately 1 A, 2 A, 5 A, 10 A, 20 A, 50 A, 100 A, 200 A, 500 A, or any other suitable peak current value. In addition to the current pulse, the SOA current I₂ may include a substantially constant offset current I_{S2-O}. The offset current I_{S2-O} may be approximately 1 mA, 100 mA, 1 A, or any other suitable current value, or the offset current I_{S2-O} may be approximately zero amperes so that there is substantially no offset current applied to the SOA. The SOA current pulse in FIG. 12 has a duration of t_{D2}, a rise time of t_{R2}, and a fall time of t_{F2}. The duration t_{D2} of the SOA current pulse may be approximately 0.5 ns, 1 ns, 2 ns, 5 ns, 10 ns, 20 ns, 50 ns, 100 ns, or any other suitable duration. The rise time t_{R2} and the fall time t_{F2} may each be approximately 0.1 ns, 0.2 ns, 0.5 ns, 1 ns, 2 ns, 5 ns, 10 ns, or any other suitable time. For example the duration of the SOA current pulse may be 8 ns, the rise time may be 1 ns, and the fall time may be 1 ns. The duration of the seed current pulse may be greater than or equal to the duration of the SOA current pulse (e.g., t_{D1}≥t_{D2}).

The time interval to in FIG. 12 represents a temporal offset between the seed current pulse and the SOA current pulse. The temporal offset to may be approximately 0.1 ns, 0.2 ns, 0.5 ns, 1 ns, 2 ns, 5 ns, 10 ns, or any other suitable offset time. The temporal offset to may have a positive value, which corresponds to the beginning of the seed current pulse occurring before the beginning of the SOA current pulse (as illustrated in FIG. 12). Alternatively, the temporal offset to may be approximately 0 ns, which corresponds to the seed current pulse and the SOA current pulse starting at approximately the same time.

In FIG. 12, the spectral signature imparted to an emitted pulse of light 400 by a light source 110 may depend at least in part on one or more of the following electrical-current parameters: the amplitude I_{S1} of the seed current pulse, the amplitude of the substantially constant seed offset current I_{S1-O}, the duration tai of the seed current pulse, the rise time t_{R1} of the seed current pulse, the fall time t_{F1} of the seed current pulse, the shape of the seed current pulse, the amplitude I_{S2} of the SOA current pulse, the amplitude of the substantially constant SOA offset current I_{S2-O}, the duration t_{D2} of the SOA current pulse, the rise time t_{R2} of the SOA current pulse, the fall time t_{F2} of the SOA current pulse, the shape of the SOA current pulse, and the temporal offset to between the seed current pulse and the SOA current pulse. For example, an electronic driver 480 may supply to a seed laser diode 450 a current pulse with an amplitude I_{S1} of 500 mA, a duration t_{D1} of 12 ns, a rise time t_{R1} of 2 ns, and a fall time t_{F1} of 3 ns. The seed current pulse may have any suitable shape, such as for example, approximately trapezoidal, square, or triangular. Additionally, the electronic driver 480 may supply to a SOA 460 a current pulse with an amplitude I_{S2} of 40 A, a duration t_{D2} of 6 ns, a rise time t_{R2} of 1 ns, and a fall time t_{F2} of 2 ns. The SOA current pulse may have any suitable shape, such as for example, approximately trapezoidal, square, or triangular. The temporal offset to between the seed current pulse and the SOA current pulse may be approximately 2 ns. The electrical-current characteristics of the seed current I₁ and the SOA current I₂ may result in an emitted pulse of light 400 having a particular spectral signature. For example, the spectral signature imparted to the emitted pulse of light may result in a photocurrent signal i produced by a detector 340 having a beat signal with a beat frequency of approximately 1 GHz or a beat frequency between 0.9 GHz and 1.1 GHz.

An electronic driver 480 may supply seed current pulses and SOA current pulses having two or more different pulse characteristics, and the different pulse characteristics may result in emitted pulses of light that have different respective spectral signatures. For example, an electronic driver 480 may alternate between supplying pulses of current to the seed laser 450 and the SOA 460 having two or more different amplitudes I_{S1}, two or more different offset currents I_{S1-O}, two or more different durations t_{D1}, two or more different rise times t_{R1}, two or more different fall times t_{F1}, two or more different amplitudes I_{S2}, two or more different offset currents I_{S2-O}, two or more different durations t_{D2}, two or more different rise times t_{R2}, two or more different fall times t_{F2}, two or more different shapes, two or more different temporal offsets to, or any suitable combination thereof. As another example, an electronic driver 480 may supply pulses of current to the seed laser 450 with an amplitude I_{S1} of 500 mA, a duration t_{D1} of 20 ns, a rise time t_{R1} of 3 ns, and a fall time t_{F1} of 5 ns. Additionally, the electronic driver 480 may supply pulses of current to the SOA 460 with an amplitude I_{S2} of 10 A, a duration t_{D2} of 5 ns, a fall time t_{F2} of 3 ns, a temporal offset to of 6 ns, and a rise time t_{R2} that alternates between 1 ns and 2 ns. The two different rise times may result in emitted pulses of light 400 that alternate between two different spectral signatures.

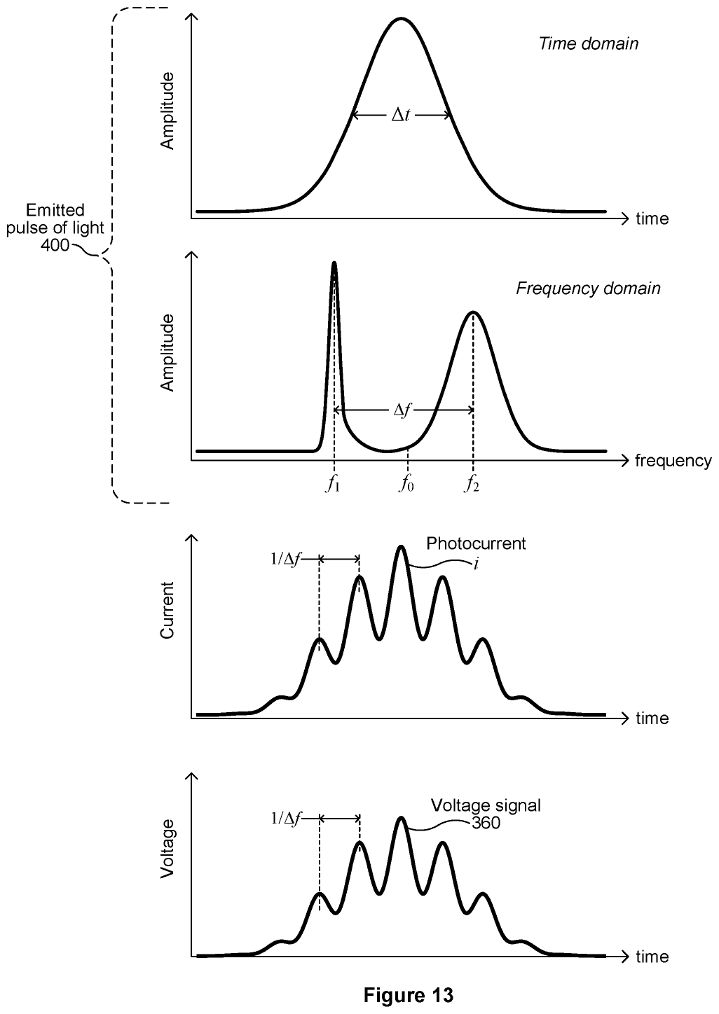

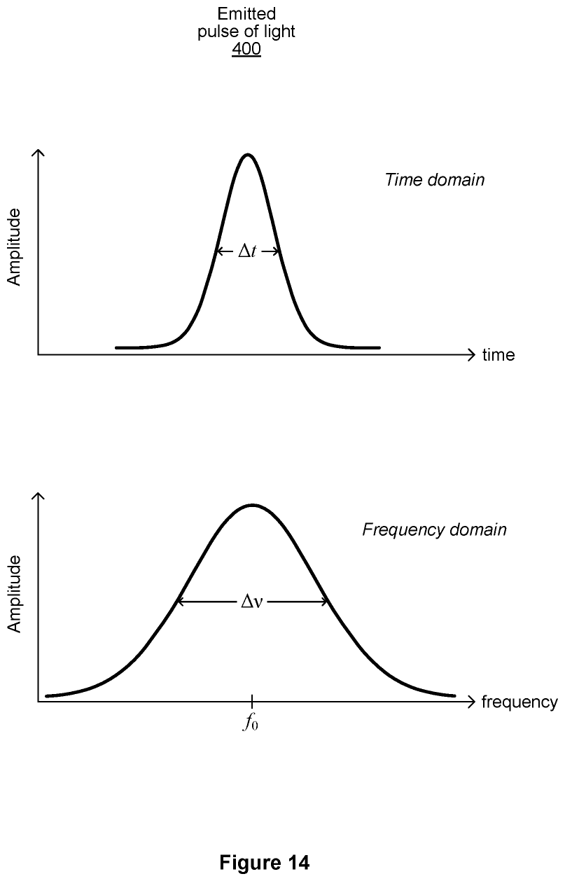

FIG. 13 illustrates example time-domain and frequency-domain graphs of an emitted pulse of light 400 and example time-domain graphs of a corresponding photocurrent i and voltage signal 360. The time-domain graph of the emitted pulse of light 400 indicates that the pulse of light has an approximately Gaussian shape with a pulse duration of Δt. The frequency-domain graph (which may be referred to as an optical spectrum or a frequency spectrum of the emitted pulse of light) illustrates the optical power or the power spectral density of the emitted pulse of light as a function of optical frequency. Optical frequency, which may be referred to as frequency, represents a frequency of light in an optical range, such as for example, a frequency between approximately 150 terahertz (THz) and approximately 330 THz (which corresponds to a wavelength of light between approximately 900 nm and approximately 2000 nm). By comparison, a frequency of an electromagnetic wave in the 10 MHz to 40 GHz range may be referred to as a radio frequency (RF) or microwave frequency. The frequency-domain graph in FIG. 13 is an example optical spectrum that includes two peaks with a valley between the peaks. The spectral peaks are located at frequencies f₁ and f₂ and are separated by a frequency difference of Δf. Other optical spectra of pulses of light may include a single peak (e.g., as illustrated by the frequency-domain graph in FIG. 14), two or more peaks, one or more valleys, one or more substantially flat regions, or any other suitable shape or combination of shapes.

The photocurrent signal i in FIG. 13 may be produced by a detector 340 in response to detecting the pulse of light 400, and the corresponding voltage signal 360 may be produced by an electronic amplifier 350. A test pulse of light 400t that includes a portion of the emitted pulse of light 400 in FIG. 13 may have associated time-domain and frequency-domain graphs similar to those in the upper portion of FIG. 13. Additionally, a detector 340 and an electronic amplifier 350 may produce respective photocurrent and voltage signals similar to those in FIG. 13 in response to detecting the test pulse of light 400t. Similarly, a received pulse of light 410 that includes a portion of the emitted pulse of light 400 in FIG. 13 may have associated time-domain and frequency-domain graphs similar to those in the upper portion of FIG. 13, and a detector 340 and an electronic amplifier 350 may produce respective photocurrent and voltage signals similar to those in FIG. 13 in response to detecting the received pulse of light 410.

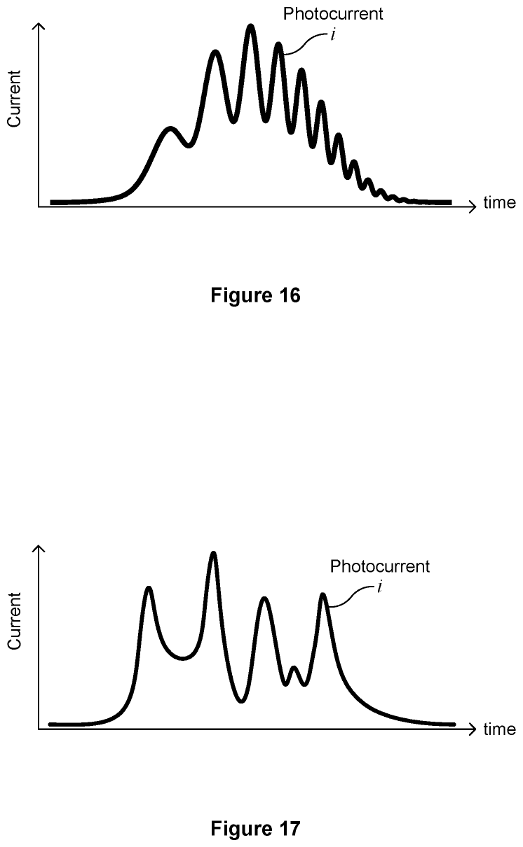

The time-domain graph of the photocurrent signal i (and the corresponding voltage signal 360) includes temporal pulsations that correspond to a beat signal. A beat signal may include a series of temporal pulsations, where each pulsation includes an increase and decrease in an amplitude of current or voltage. The beat signal in FIG. 13 includes approximately seven pulsations, and the beat signal has a period of 1/Δf, which corresponds to a beat frequency of Δf. The beat signal in FIG. 13 is a periodic signal with a beat frequency and period that are approximately constant. Other beat signals may have a beat frequency that changes with time (e.g., as illustrated in FIG. 16) or may be non-periodic (e.g., as illustrated in FIG. 17). A non-periodic beat signal may include temporal pulsations that are distributed temporally in a manner that at least appears random, or a non-periodic beat signal may not have a readily apparent pattern, frequency, or period.

In FIG. 13, the beat frequency of the beat signal in the photocurrent and voltage signals is equal to the frequency difference Δf between the spectral peaks of the optical spectrum of the pulse of light 400. The beat signal may result from coherent mixing at a detector 340 of light associated with each of the two spectral peaks. The detection of a pulse of light by a detector 340 may include two or more optical-frequency components of the pulse of light being coherently mixed at the detector. Coherent mixing (which may be referred to as optical mixing, frequency mixing, or mixing) of two or more optical-frequency components may refer to the electric fields of the frequency components being (i) combined or added together and (ii) detected by a detector 340. The electric fields of two or more optical-frequency components that are part of a pulse of light may be considered to be combined together since they are part of the same pulse of light. Additionally, detection of a pulse of light by a detector 340 may include “square-law” detection in which the photocurrent signal i produced by the detector is proportional to the square of the electric field of the pulse of light. When a pulse of light (which includes two or more optical-frequency components) is detected by a detector 340, the detector may produce a photocurrent signal that is proportional to the square of the electric field of the pulse of light. Squaring the electric field produces mixing between different optical-frequency components of the pulse of light, which results in a photocurrent signal that may include sum or difference frequencies of the optical-frequency components. For example, a photocurrent signal i resulting from coherent mixing of two frequency components f₁ and f₂ may include a beat signal with a beat frequency that is approximately equal to the difference (f₂−f₁) between the frequencies associated with the optical-frequency components.

The spectral signature of the emitted pulse of light 400 in FIG. 13 includes a first optical-frequency component at frequency f₁ and a second optical-frequency component at frequency f₂, where f₂ is greater than f₁. The first optical-frequency component may be represented by the expression E₁ (t)·cos[2πf₁t+ϕ], where E₁(t) represents the amplitude of the electric field of the first optical-frequency component, and ϕ₁ represents a phase of the first optical-frequency component. Similarly, the second optical-frequency component may be represented by the expression E₂ (t)·cos[2πf₂t+ϕ₂], where E₂(t) represents the electric field amplitude of the second optical-frequency component, and ϕ₂ represents a phase of the second optical-frequency component. The electric field amplitudes E₁(t) and E₂(t) are time varying and may each correspond to the envelope of the electric field of the emitted pulse of light 400. For example, E₁(t) and E₂(t) may be approximately equal, and the electric field of the emitted pulse of light may be expressed approximately as E₀(t)·[cos(2πf₁t+Θ₁)+cos(2πf₂t+ϕ₂)], where E₀(t) represents the electric-field envelope of the emitted pulse of light 400. For a Gaussian-shaped pulse of light, the electric-field envelope of the emitted pulse of light may have the form E₀ exp[−α(t/Δt)²], where α is a constant, and E₀ is the peak electric field of the emitted pulse of light 400. For example, if the emitted pulse of light 400 is a Gaussian pulse with a full-width at half-maximum duration of Δt, the electric-field envelope may be expressed as E₀(t)=E₀ exp[−2In 2 (t/Δt)²]. The photocurrent signal i produced by a detector 340 in response to the pulse of light 400 may be proportional to the square of the electric field of the pulse of light. Squaring the above expression for the electric field of the pulse of light produces a mixing term that is proportional to cos[2π(f₂−f₁)t+ϕ₂−ϕ₁], which corresponds to a beat signal having a beat frequency of Δf=f₂−f₁. This expression for the mixing term indicates that when a pulse of light that includes two optical-frequency components is detected by a detector 340, the detector may produce a photocurrent signal that includes a beat signal with a beat frequency equal to the difference between the frequencies associated with the two optical-frequency components.

A light source 110 of a lidar system 100 with spectrally encoded light pulses may emit pulses of light 400, where the light source imparts to each emitted pulse of light a spectral signature of multiple different spectral signatures. Each spectral signature may include or may be associated with two or more optical-frequency components. For example, a spectral signature of an emitted pulse of light 400 may include 2, 3, 4, 5, 10, or any other suitable number of optical-frequency components. An optical-frequency component, which may be referred to as a frequency component or a spectral-signature frequency component, may include a particular frequency or a range of frequencies of an optical spectrum of a pulse of light 400. For example, a peak frequency or a frequency range around a peak may correspond to an optical-frequency component. As another example, an optical-frequency component may include or may overlap with a peak, a portion of a peak, a valley, a substantially flat region, a wing, or any other suitable portion of the optical spectrum of a pulse of light. As another example, an optical-frequency component may include a frequency or a range of frequencies within a frequency range from approximately 150 THz to approximately 330 THz (which corresponds to a wavelength or a range of wavelengths between approximately 900 nm and approximately 2000 nm).

The optical spectrum in FIG. 13 has two primary frequency components at frequencies f₁ and f₂, which are separated by a frequency difference of Δf. The emitted pulse of light 400 in FIG. 13 may be referred to as including at least two optical-frequency components (e.g., one at optical frequency f₁ and another at optical frequency f₂), where each of the two peaks of the optical spectrum may correspond to an optical-frequency component. The frequency difference Δf between the two frequency components may have a value of 100 MHz, 200 MHz, 500 MHz, 1 GHz, 2 GHz, 10 GHz, 40 GHz, or any other suitable value between approximately 100 MHz and 40 GHz. If the emitted pulse of light 400 in FIG. 13 has a center wavelength of approximately 1555 nm, then the optical spectrum of the emitted pulse of light may have a center or average optical frequency f₀ of approximately 192.8 THz. Optical-frequency component f₁ may have a frequency of approximately 192.799 THz, and optical-frequency component f₂ may have a frequency of approximately 192.801 THz, which corresponds to a frequency difference Δf of 2 GHz between the two frequency components.

An emitted pulse of light 400, a test pulse of light 400t, or a received pulse of light 410 may be detected by a detector 340. In response to detecting the pulse of light, the detector 340 may produce a photocurrent signal i that includes one or more beat signals. Each beat signal may include a beat frequency that is approximately equal to the frequency difference Δf between two optical-frequency components of the spectral signature of the pulse of light. A beat signal may include a temporal variation (e.g., temporal pulsations) in the photocurrent signal, and the frequency of the temporal variation may equal the beat frequency of the beat signal. The photocurrent signal i in FIG. 13 includes a beat signal with temporal pulsations that have a period of 1/Δf, which corresponds to a beat frequency of Δf. The voltage signal 360, which corresponds to the photocurrent signal, also includes a similar beat signal with a beat frequency of Δf. A pulse of light may include two or more optical-frequency components, and a corresponding photocurrent or voltage signal may include one or more beat signals. The pulse of light 400 in FIG. 13 includes two primary frequency components, and each of the photocurrent and voltage signals includes one primary beat signal having a beat frequency of Δf. Other photocurrent and voltage signals may include a combination of 2, 3, 4, 5, 10, or any other suitable number of beat signals, each beat signal having a particular beat frequency. For example, a photocurrent signal may include a combination of five beat signals having five different respective beat frequencies.

In the example of FIG. 13, coherent mixing of light associated with the two spectral peaks results in the temporal pulsations in the photocurrent and voltage signals. Coherent mixing of a pulse of light at a detector may include mixing between two or more optical-frequency components of the pulse of light, and the frequency components that are mixed may include a peak, a portion of a peak, a valley, a substantially flat portion, a wing, or any other suitable spectral portion of the optical spectrum of a pulse of light. In FIG. 13, the photocurrent signal includes a beat signal resulting from coherent mixing of the optical-frequency components at frequencies f₁ and f₂, and the beat signal has a beat frequency of Δf, where Δf=f₂−f₁. In the time-domain graph of the photocurrent signal i (and the corresponding voltage signal 360), the beat signal corresponds to the periodic temporal pulsations that have a period of approximately 1/Δf. The beat frequency Δf of a beat signal may have a value of 100 MHz, 200 MHz, 500 MHz, 1 GHz, 2 GHz, 10 GHz, 40 GHz, or any other suitable value between approximately 100 MHz and 40 GHz. Similarly, the temporal pulsations of a beat signal may have a period 1/Δf of approximately 10 ns, 5 ns, 2 ns, 1 ns, 0.5 ns, 0.1 ns, or 0.025 ns. For example, the frequencies f₁ and f₂ in FIG. 13 may have a frequency difference Δf of approximately 500 MHz, and the corresponding photocurrent signal i may have a beat frequency Δf of approximately 500 MHz (which corresponds to a beat-signal period 1/Δf of approximately 2 ns). As another example, a light source 110 may emit pulses of light where each pulse includes two or more optical-frequency components, and each pair of optical-frequency components may have a frequency difference Δf of between approximately 100 MHz and approximately 2 GHz. An associated beat signal produced by one of the pulses of light may have a corresponding beat frequency Δf between approximately 100 MHz and approximately 2 GHz, which corresponds to a beat-signal period 1/Δf between approximately 0.5 ns and 10 ns.

The spectral signature of a pulse of light (e.g., an emitted pulse of light 400, a test pulse of light 400t, or a received pulse of light 410) may be determined based on a photocurrent signal i or a corresponding voltage signal 360. Determining the spectral signature of a pulse of light may include determining one or more beat frequencies associated with the pulse of light. Since a spectral signature may be associated with optical-frequency components of a pulse of light, determining the spectral signature of the pulse of light may include determining one or more beat frequencies associated with the optical-frequency components of the pulse of light. The spectral signature of the pulse of light in FIG. 13 may be determined based on the photocurrent signal i or based on the corresponding voltage signal 360. For example, a frequency-detection circuit 600 may receive the voltage signal 360 in FIG. 13, and the frequency-detection circuit 600 may determine the spectral signature of the pulse of light by determining the beat frequency Δf or the period 1/Δf of the beat signal that is part of the voltage signal.

An optical-frequency component that is part of a spectral signature of a pulse of light may have a frequency in the 150-330 THz range (which corresponds to a wavelength between approximately 900 nm and approximately 2000 nm). A beat signal produced by detection of the pulse of light may have a beat frequency in the 100 MHz to 40 GHz range, which is orders of magnitude less than the frequency of the optical-frequency component. The coherent mixing of two optical-frequency components (e.g., with 150-330 THz frequencies) at a detector results in a frequency down-conversion that may produce an electrical signal with a frequency below 40 GHz, for example. A technological advantage of the techniques disclosed herein is that by down-converting the optical-frequency components of a pulse of light into the range of RF or microwave signals, a spectral signature of the pulse of light may be determined using an electronic-based technique rather than an optical-based technique. Additionally, since the optical-frequency components that make up a spectral signature are part of a pulse of light, coherent mixing between the optical-frequency components may occur at a detector 340 without an additional optical signal, such as a local oscillator, needing to be supplied. Another technological advantage of a lidar system with spectrally encoded light pulses is that the spectral encoding may be used to disambiguate a received pulse of light 410 by determining which emitted pulse of light 400 the received pulse of light 410 is associated with. A received pulse of light 410 may be unambiguously associated with an emitted pulse of light based on the spectral signature of the received pulse of light 410 matching the spectral signature of the emitted pulse of light 400.

FIG. 14 illustrates example time-domain and frequency-domain graphs of an emitted pulse of light 400. The pulse of light has an approximately Gaussian shape with a pulse duration of Δt, and the frequency spectrum of the pulse of light has a spectral width of Δν. An associated test pulse of light 400t or received pulse of light 410 may have time-domain and frequency-domain graphs similar to those in FIG. 14. A pulse duration (Δτ) and spectral linewidth (Δν) of a pulse of light may have an inverse relationship where the product Δτ·Δν (which may be referred to as a time-bandwidth product) is greater than or equal to a constant value. For example, a pulse of light with a Gaussian temporal shape may have a time-bandwidth product equal to a constant value that is greater than or equal to 0.44. If a Gaussian pulse has a time-bandwidth product that is approximately equal to 0.44, then the pulse may be referred to as a transform-limited pulse. For a transform-limited Gaussian pulse, the pulse duration (Δτ) and spectral linewidth (Δν) may be related by the expression Δτ·Δν=0.44. This inverse relationship between pulse duration and spectral linewidth indicates that a shorter-duration pulse has a larger spectral linewidth (and vice versa). For example, the pulse of light 400 in FIG. 14 may be a transform-limited Gaussian pulse with (i) a pulse duration Δτ of 2 ns and a spectral linewidth Δν of approximately 220 MHz or (ii) a pulse duration Δτ of 4 ns and a spectral linewidth Δν of approximately 110 MHz. The inverse relationship between pulse duration and spectral linewidth results from the Fourier-transform relationship between time-domain and frequency-domain representations of a pulse. If a Gaussian pulse of light has a time-bandwidth product that is greater than 0.44, then the pulse of light may be referred to as a non-transform-limited pulse of light. For example, the pulse of light 410 in FIG. 14 may be a non-transform-limited pulse of light with a time-bandwidth product of 1, and the received pulse of light 410 may have (i) a pulse duration Δτ of 2 ns and a spectral linewidth Δν of approximately 500 MHz or (ii) a pulse duration Δτ of 4 ns and a spectral linewidth Δν of approximately 250 MHz. A light source 110 may emit pulses of light 400 that are transform-limited or pulses of light that are non-transform-limited.

A light source 110 may include a seed laser diode 450 that produces seed light 440 and a SOA 460 that amplifies temporal portions of the seed light to produce emitted pulses of light 400. The seed laser 450 may produce seed light 440 having a substantially constant optical power and a relatively narrow spectral linewidth. Amplifying a temporal portion of the seed light 440 to produce a pulse of light 400 may result in the seed-light linewidth being effectively broadened according to the inverse relationship between pulse duration and spectral linewidth. For example, the seed light 440 may have a spectral width of 1 MHz, and a temporal portion of the seed light may be amplified to produce an emitted pulse of light 400 with a 2-ns pulse duration and a spectral linewidth of greater than or equal to 220 MHz.

A spectral signature imparted to an emitted pulse of light may result from at least one or both of (i) spectral broadening due to the inverse time-bandwidth relationship between pulse duration and spectral linewidth and (ii) one or more nonlinear optical effects. In addition to providing a broadened spectral linewidth to an emitted pulse of light 400 based on the time-bandwidth relationship, a light source 110 may also impart at least part of a spectral signature to the emitted pulse of light 400 through one or more nonlinear optical effects that may occur in a light source 110. For example, in a light source 110 that includes a seed laser diode 450 and a SOA 460, one or more of the following nonlinear optical effects occurring in the seed laser diode 450 or the SOA 460 may impart a spectral signature to an emitted pulse of light: four-wave mixing, Kerr nonlinear optical effect, self-phase modulation, coupled-cavity effects between the seed laser diode and the SOA, stimulated Raman scattering (SRS), stimulated Brillouin scattering (SBS), and plasma dispersion effect. A spectral signature associated with one or more nonlinear optical effects may cause a broadening of the spectral linewidth of an emitted pulse of light 400 or a shift in the optical frequency of an emitted pulse of light 400. An emitted pulse of light 400 may have a spectral signature that results from a combination of spectral broadening due to the inverse time-bandwidth relationship and one or more nonlinear optical effects. As an example, for an emitted pulse of light with a 4-ns pulse duration and a 500-MHz spectral linewidth Δν, approximately 300 MHz of the 500-MHz spectral linewidth may be attributed to spectral broadening related to the time-bandwidth relationship. Additionally, approximately 200 MHz of the spectral linewidth may be attributed to one or more nonlinear optical effects occurring in the light source.

A light source 110 may impart spectral signatures to emitted pulses of light 400 where the spectral signatures change from pulse to pulse in an approximately random manner. For a light source 110 that includes a seed laser diode 450 and a SOA 460, the type or characteristics of a spectral signature imparted to an emitted pulse of light may depend at least in part on electrical-current characteristics of the seed current I₁ and the SOA current I₂, as discussed with respect to FIGS. 11-12. Additionally, the spectral signature imparted to an emitted pulse of light may depend on nonlinear optical effects occurring within the light source 110. Some of the nonlinear optical effects may exhibit random or chaotic behavior, and due to this random nature of the nonlinear optical effects, the spectral signature imparted to emitted pulses of light may change from pulse to pulse in a random manner. The spectral signature imparted to a pulse of light may result from a combination of (i) approximately deterministic effects associated with the electrical-current characteristics of the current supplied to the light source and (ii) substantially random variations associated with the chaotic nature of the nonlinear optical effects. The approximately deterministic effects may result in a spectral signature associated with a particular beat frequency (e.g., approximately 500 MHz), and the random variations may result in a random pulse-to-pulse variation of the beat frequency within a frequency range around the particular beat frequency (e.g., 450-550 MHz). For example, a current pulse with a 0.5-ns rise time supplied to a SOA may result in a pulse of light associated with a beat frequency in the 450-550 MHz range, and a current pulse with a 1-ns rise time may result in a pulse of light associated with a beat frequency in the 250-350 MHz range. A first pulse of light produced from a SOA current pulse with a 0.5-ns rise time may have a first spectral signature associated with a beat frequency between 450 MHz and 550 MHz, and a second pulse of light produced from a SOA current pulse with a 1-ns rise time may have a second spectral signature associated with a beat frequency between 250 MHz and 350 MHz. The beat frequencies associated with emitted pulses of light may be approximately randomly distributed within each 100-MHz frequency range, and the random variation may be attributed to the random nature of the nonlinear optical effects occurring in the light source. For example, one pulse of light produced from a SOA current pulse with a 0.5-ns rise time may have an associated beat frequency of 475 MHz, and another pulse of light produced from a SOA current pulse with the same rise time may have an associated beat frequency of 540 MHz.

A light source 110 that imparts spectral signatures to emitted pulses of light 400 in a random manner (e.g., the imparted spectral signatures change from pulse to pulse in an approximately random manner) may include an optical splitter 470. The optical splitter 470 may split off a portion of each emitted pulse of light 400 to produce an associated test pulse of light 400t. The test pulse of light 400t may be directed to a receiver 140 that determines the spectral signature of the test pulse of light 400t (which corresponds to the spectral signature of the associated emitted pulse of light). A controller 150 of a lidar system 100 may receive the spectral-signature information from the receiver 140, and the controller may store the spectral-signature information for comparison to the spectral signature of a subsequently received pulse of light 410. For example, the controller may store the spectral signatures of the P most recently emitted pulses of light, where P is an integer greater than or equal to 2. The stored spectral signatures of the P emitted pulses of light may be compared with the spectral signature of a received pulse of light to determine whether the received pulse of light is associated with one of the P emitted pulses of light. The value of P may be 2, 3, 4, 5, 10, 20, 50, 100, or any other suitable value greater than or equal to 2 and less than or equal to approximately 100.

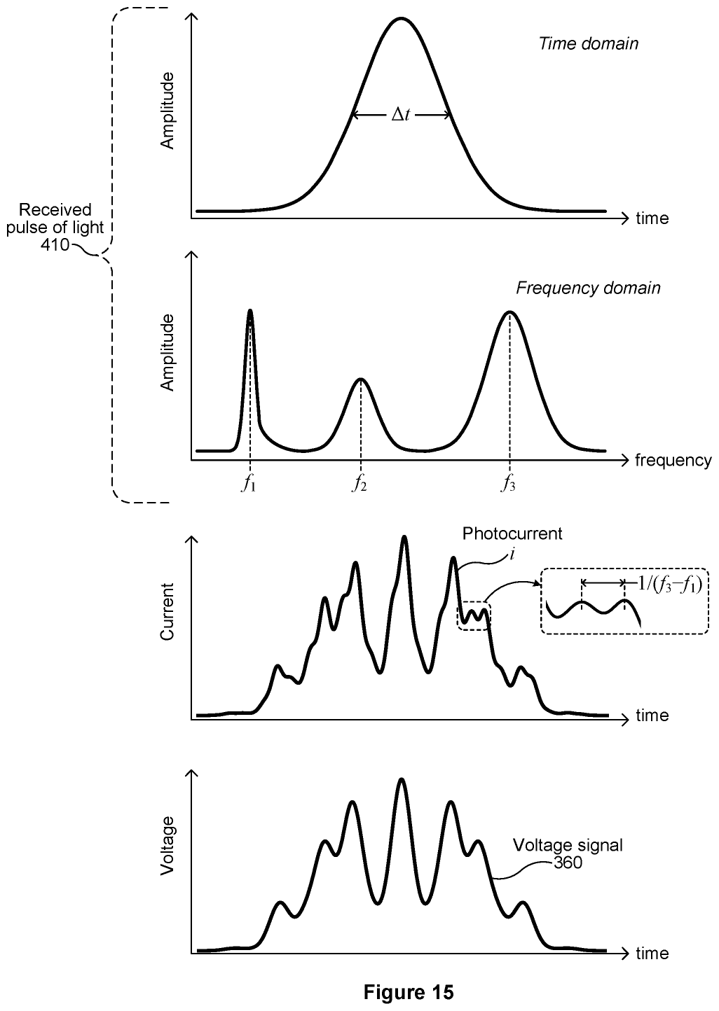

FIG. 15 illustrates example time-domain and frequency-domain graphs of a received pulse of light 410 and example time-domain graphs of a corresponding photocurrent and voltage signal 360. The time-domain graph of the received pulse of light 410 indicates that the pulse of light has an approximately Gaussian shape with a pulse duration of Δt. The frequency-domain graph includes three peaks located at frequencies f₁, f₂, and f₃, which corresponds to a spectral signature that includes three primary optical-frequency components at frequencies f₁, f₂, and f₃. The received pulse of light 410 in FIG. 15 may include light from an emitted pulse of light 400 that was scattered by a target 130, and the emitted and received pulses of light may include approximately the same spectral signature. The photocurrent signal i may be produced by a detector 340 in response to detecting the received pulse of light 410, and the corresponding voltage signal 360 may be produced by an electronic amplifier 350. The photocurrent signal i includes temporal pulsations that correspond to a combination of three beat signals, each beat signal having a different beat frequency. The three beat signals may be produced by coherent mixing between the optical-frequency components f₁, f₂, and f₃, and the beat signals may have beat frequencies of (f₂−f₁), (f₃−f₂), and (f₃−f₁). For example, the three beat frequencies may be approximately 500 MHz, 700 MHz, and 1.2 GHz, respectively. The beat signal at frequency (f₃−f₁), which has the highest frequency of the three beat signals, may correspond to the relatively high-frequency temporal pulsations with period 1/(f₃−f₁), as shown in the dashed-line inset of the photocurrent signal in FIG. 15. The voltage signal 360 includes the two lower-frequency beat signals with frequencies (f₂−f₁) and (f₃−f₂), and the high-frequency (f₃−f₁) beat signal is not present in the voltage signal. An electronic amplifier 350 that produces the voltage signal 360 may include a low-pass filter that removes or attenuates high-frequency signals. For example, the electronic amplifier may include a low-pass filter that attenuates signals above 1 GHz. If the three beat frequencies are 500 MHz, 700 MHz, and 1.2 GHz, then the 1.2-GHz beat signal may be filtered out by the electronic amplifier 350. The resulting voltage signal 360 may include the 500-MHz and 700-MHz beat signals, and the 1.2-GHz beat signal may be substantially attenuated or may not be present in the voltage signal 360. Determining the spectral signature of the received pulse of light 410 in FIG. 15 may include determining the 500-MHz and 700-MHz frequencies of the two beat signals that are present in the voltage signal 360, and the 1.2-GHz beat signal that is filtered out may not be included in the spectral-signature determination.

FIGS. 16-17 each illustrates an example photocurrent signal i. The photocurrent signal in each of FIGS. 16 and 17 may be produced by a detector 340 in response to detecting a test pulse of light 400t or a received pulse of light 410, and the temporal pulsations in the photocurrent signal may result from coherent mixing between optical-frequency components of the pulse of light. A beat signal may include periodic temporal pulsations with a constant frequency (e.g., as illustrated in FIG. 13) or a combination of two or more periodic temporal pulsations (e.g., as illustrated in FIG. 15). Other beat signals may have a beat frequency that changes with time or may be non-periodic. The beat signal in FIG. 16 includes temporal pulsations with a frequency that increases with time. The beat signal in FIG. 17 may be referred to as a non-periodic beat signal with temporal pulsations that appear to be random or that appear not to have a readily discernible pattern, frequency, or period. Although the beat signal in FIG. 17 may appear not to have a readily discernible pattern, the beat signal may include two or more beat frequencies that are combined together to produce the resulting beat signal in FIG. 17.

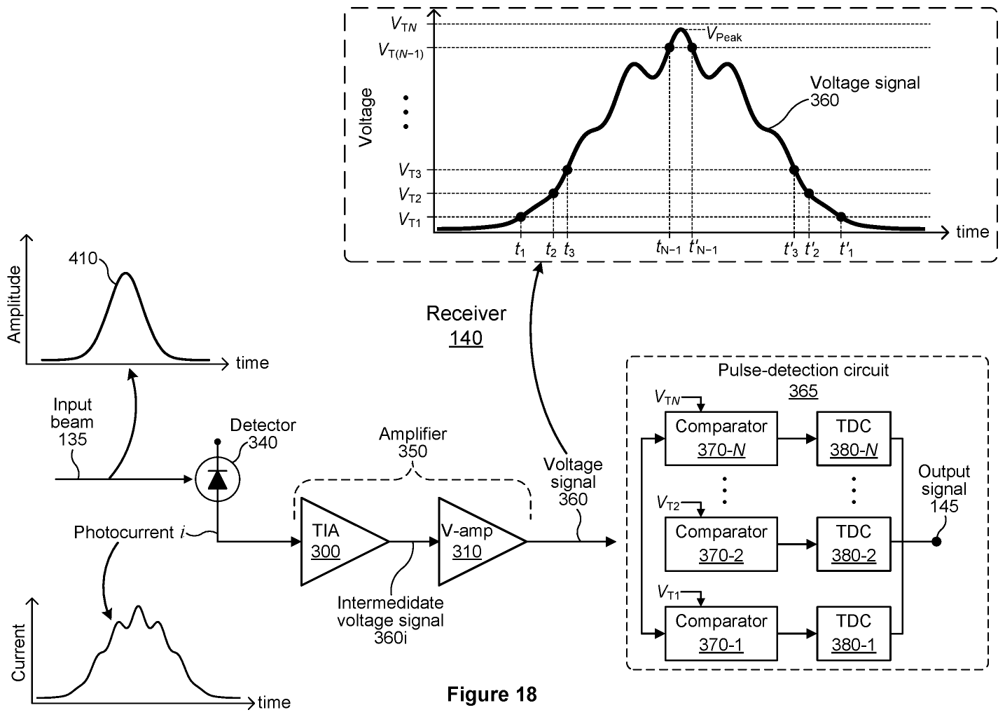

FIG. 18 illustrates an example receiver 140 that includes a pulse-detection circuit 365 with multiple comparators 370 and TDCs 380. The receiver 140 in FIG. 18 includes a detector 340 that receives an input beam 135 that includes a pulse of light 410, and the detector 340 produces a photocurrent signal i that corresponds to the received pulse of light. The photocurrent signal includes a pulse of photocurrent along with temporal pulsations that correspond to a beat signal. The detector 340 may include an APD, PN photodiode, or PIN photodiode. For example, the detector 340 may include a silicon APD or PIN photodiode configured to detect light at an 800-1100 nm operating wavelength of a lidar system 100, or the detector 340 may include an InGaAs APD or PIN photodiode configured to detect light at a 1200-1600 nm operating wavelength.

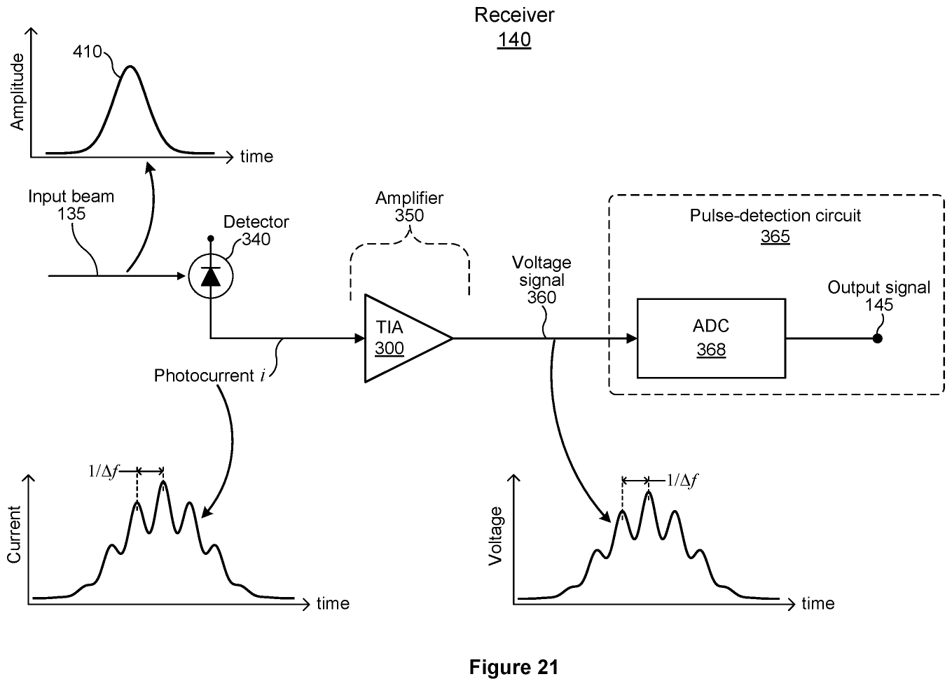

The receiver 140 in FIG. 18 includes an electronic amplifier 350 that receives the photocurrent signal i from the detector 340. The amplifier 350 amplifies the photocurrent signal to produce a voltage signal 360 that corresponds to the photocurrent signal. For example, the detector 340 may be an APD that produces a pulse of photocurrent in response to the received pulse of light 410, and the voltage signal 360 may include an analog voltage pulse that corresponds to the pulse of photocurrent. The electronic amplifier 350 includes a transimpedance amplifier (TIA) 300 followed by a voltage amplifier 310. A TIA 300 may be referred to as a current-to-voltage converter, and producing a voltage signal from a received photocurrent signal may be referred to as performing current-to-voltage conversion. The transimpedance gain or amplification of a TIA 300 may be expressed in units of ohms (Ω), or equivalently volts per ampere (V/A). For example, if a TIA 300 has a gain of 100 V/A, then for a photocurrent i with a peak current of 10 μA, the TIA may produce a voltage signal 360 with a corresponding peak voltage of approximately 1 mV. In FIG. 18, the TIA 300 receives the photocurrent i and amplifies the photocurrent to produce an intermediate voltage signal 360i, and the voltage amplifier 310 further amplifies the intermediate voltage signal to produce the output voltage signal 360 that is supplied to the pulse-detection circuit 365. Alternatively, as illustrated in FIG. 21, an electronic amplifier 350 may not include a separate voltage amplifier, and a TIA 300 may amplify a photocurrent signal i to directly produce a voltage signal 360 (e.g., without an additional or separate voltage-amplification stage located after the TIA). An electronic amplifier 350 may include an electronic filter (e.g., a low-pass, high-pass, or band-pass filter) that filters the photocurrent signal i or the voltage signal 360. For example, a TIA 300 or voltage amplifier 310 may include a high-pass filter that attenuates signals below a particular frequency (e.g., below 1 MHz, 10 MHz, 50 MHz, 100 MHz, 200 MHz, or any other suitable frequency). As another example, a TIA 300 or voltage amplifier 310 may include a low-pass filter that attenuates signals above a particular frequency (e.g., above 200 MHz, 500 MHz, 1 GHz, 2 GHz, or any other suitable frequency).

The voltage signal 360 produced by the amplifier 350 in FIG. 18 is coupled to a pulse-detection circuit 365 that includes multiple comparators 370 and multiple time-to-digital converters (TDCs) 380. Each comparator 370 is coupled to a TDC 380, and each comparator may receive the voltage signal 360 and provide an electrical-edge signal to a corresponding TDC when the voltage signal rises above or falls below a particular threshold voltage. The pulse-detection circuit 365 includes N comparators (comparators 370-1, 370-2, . . . , 370-N), and each comparator is supplied with a particular threshold or reference voltage (V_{T1}, V_{T2}, . . . , V_{TN}). For example, a receiver 140 may include N=10 comparators, and the threshold voltages may be set to 10 values between 0 volts and 1 volt (e.g., V_{T1}=0.1 V, V_{T2}=0.2 V, and V_{T10}=1.0 V). A comparator may produce an electrical-edge signal (e.g., a rising or falling electrical edge) when the voltage signal 360 rises above or falls below a particular threshold voltage. For example, comparator 370-2 may produce a rising edge at time t₂ when the voltage signal 360 rises above the threshold voltage V_{T2}. Additionally or alternatively, comparator 370-2 may produce a falling edge at time t′₂ when the voltage signal 360 falls below the threshold voltage V_{T2}.

The pulse-detection circuit 365 in FIG. 18 includes N time-to-digital converters (TDCs 380-1, 380-2, . . . , 380-N), and each comparator 370 is coupled to one of the TDCs 380. The number N of comparators 370 and TDCs 380 in a pulse-detection circuit 365 may be 2, 4, 8, 10, 20, 30, 50, 100, 200, 500, 1,000, or any other suitable number of comparators and TDCs. Each comparator-TDC pair in FIG. 18 (e.g., comparator 370-1 and TDC 380-1) may be referred to as a threshold detector. A comparator may provide an electrical-edge signal to a corresponding TDC, and the TDC may act as a timer that produces an electrical output signal (e.g., a digital signal, a digital word, or a digital value) that represents a time when the edge signal is received from the comparator. For example, if the voltage signal 360 rises above the threshold voltage V_{T1}, then the comparator 370-1 may produce a rising-edge signal that is supplied to the input of TDC 380-1, and the TDC 380-1 may produce a digital time value corresponding to a time when the edge signal was received by TDC 380-1. The digital time value may be referenced to a time when a pulse of light is emitted, and the digital time value may correspond to or may be used to determine a round-trip time for the pulse of light to travel to a target 130 and back to the lidar system 100. Additionally, if the voltage signal 360 subsequently falls below the threshold voltage V_{T1}, then the comparator 370-1 may produce a falling-edge signal that is supplied to the input of TDC 380-1, and the TDC 380-1 may produce a digital time value corresponding to a time when the edge signal was received by TDC 380-1.

A pulse-detection output signal 145 may include an electrical signal that corresponds to a received pulse of light 410. For example, the output signal 145 in FIG. 18 may be a digital signal that corresponds to the analog voltage signal 360, which in turn corresponds to the photocurrent signal i, which in turn corresponds to a received pulse of light 410. If an input light signal 135 includes a received pulse of light 410, the pulse-detection circuit 365 may receive a voltage signal 360 (which corresponds to the photocurrent i) and produce an output signal 145 that corresponds to the received pulse of light 410. The output signal 145 may include one or more digital time values from each of the TDCs 380 that received one or more edge signals from a comparator 370, and the digital time values may represent the analog voltage signal 360. The pulse-detection output signal 145 may be sent to a controller 150, and a time-of-arrival of the received pulse of light 410 may be determined based at least in part on the one or more time values produced by the TDCs. For example, the time-of-arrival may be determined from a time associated with the peak (e.g., Vₚₑₐₖ) of the voltage signal 360, a temporal center of the voltage signal, or a rising edge of the voltage signal. Since the voltage signal 360, photocurrent signal i, and output signal 145 correspond to one another, and since a portion of a pulse-detection circuit 365 may be included in a controller 150 (or vice versa), the pulse-detection circuit 365 may be referred to as determining a time-of-arrival of the received pulse of light 410 based on the corresponding photocurrent signal i or voltage signal 360.

A pulse-detection output signal 145 may include one or more digital values that correspond to a time interval between (1) a time when a pulse of light 400 is emitted and (2) a time when a received pulse of light 410 is detected by a receiver 140. The output signal 145 in FIG. 18 may include digital values from each of the TDCs that receive an edge signal from a comparator, and each digital value may represent a time interval between the emission of an optical pulse 400 by a light source 110 and the receipt of an edge signal from a comparator. For example, a light source 110 may emit a pulse of light 400 that is scattered by a target 130, and a receiver 140 may receive a portion of the scattered pulse of light as an input pulse of light 410. When the light source emits the pulse of light 400, a count value of the TDCs may be reset to zero counts. Alternatively, the TDCs in receiver 140 may accumulate counts continuously over two or more pulse periods (e.g., for 10, 100, 1,000, 10,000, or 100,000 pulse periods), and when a pulse of light 400 is emitted, the TDC count at the time when the pulse is emitted may be stored in memory. After the pulse of light 400 is emitted, the TDCs may accumulate counts that correspond to elapsed time (e.g., the TDCs may count in terms of clock cycles or some fraction of clock cycles).

In FIG. 18, when TDC 380-1 receives an edge signal from comparator 370-1, the TDC 380-1 may produce a digital signal that represents the time interval between emission of the pulse of light 400 and receipt of the edge signal. For example, the digital signal may include a digital value that corresponds to the number of clock cycles that elapsed between emission of the pulse of light 400 and receipt of the edge signal. Alternatively, if the TDC 380-1 accumulates counts over multiple pulse periods, then the digital signal may include a digital value that corresponds to the TDC count at the time of receipt of the edge signal. The pulse-detection output signal 145 may include digital values corresponding to one or more times associated with an emitted pulse of light 400 or one or more times when a TDC received an edge signal associated with a received pulse of light 410. An output signal 145 from a pulse-detection circuit 365 may correspond to a received pulse of light 410 and may include digital values from each of the TDCs that receive an edge signal from a comparator. The pulse-detection output signal 145 may be sent to a controller 150, and the controller may determine the time-of-arrival of the received pulse of light 410 or the distance to the target 130 based at least in part on output signal 145. Additionally or alternatively, the controller 150 may determine an optical characteristic of a received pulse of light 410 based at least in part on the output signal 145 received from the TDCs of a pulse-detection circuit 365. An optical characteristic of a received pulse of light 410 may correspond to a peak optical intensity, a peak optical power, an average optical power, an optical energy, a shape or amplitude, a temporal duration, or a temporal center of the received pulse of light 410. For example, a controller 150 may apply a curve-fit or interpolation operation to the values of a pulse-detection output signal 145 and then determine an optical characteristic of a pulse of light from the curve-fit or interpolation.

The example voltage signal 360 illustrated in the dashed-line inset of FIG. 18 corresponds to the received pulse of light 410. The voltage signal 360 may be an analog signal produced by the electronic amplifier 350 and may correspond to the pulse of light 410 detected by the receiver 140. The voltage levels on the y-axis correspond to the threshold voltages V_{T1}, V_{T2}, . . . , V_{TN} of the respective comparators 370-1, 370-2, . . . , 370-N. The time values t₁, t₂, t₃, t_{N-1} correspond to times when the voltage signal 360 exceeds the corresponding threshold voltages, and the time values t′₁, t′₂, . . . , t′_{N-1} correspond to times when the voltage signal 360 falls below the corresponding threshold voltages. For example, at time t₁ when the voltage signal 360 exceeds the threshold voltage V_{T1}, comparator 370-1 may produce an edge signal, and TDC 380-1 may output a digital value corresponding to the time t₁. Additionally, the TDC 380-1 may output a digital value corresponding to the time t′₁ when the voltage signal 360 falls below the threshold voltage V_{T1}. Alternatively, the receiver 140 may include an additional TDC (not illustrated in FIG. 18) configured to produce a digital value corresponding to time t′₁ when the voltage signal 360 falls below the threshold voltage V_{T1}. The output signal from pulse-detection circuit 365 may include one or more digital values that correspond to one or more of the time values t₁, t₂, t₃, t_{N-1} and Additionally, the pulse-detection output signal may also include one or more values corresponding to the threshold voltages associated with the time values. Since the voltage signal 360 in FIG. 18 does not exceed the threshold voltage V_{TN}, the corresponding comparator 370-N may not produce an edge signal. As a result, TDC 380-N may not produce a time value, or TDC 380-N may produce a signal indicating that no edge signal was received.

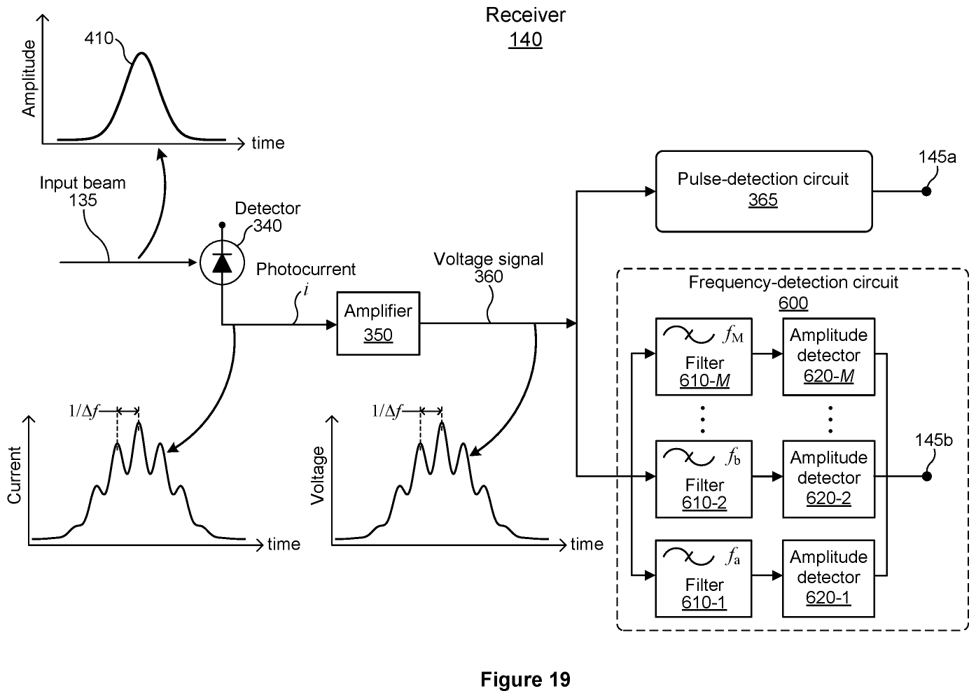

A receiver 140 may include a pulse-detection circuit 365 and a frequency-detection circuit 600. The pulse-detection circuit may determine a time-of-arrival of a received pulse of light 410, and the frequency-detection circuit may determine a spectral signature of the received pulse of light. The receiver 140 in each of FIGS. 6 and 19 includes a pulse-detection circuit 365 and a frequency-detection circuit 600 that is separate from the pulse-detection circuit. In other embodiments, a receiver 140 may include pulse-detection and frequency-detection circuits that are at least partially combined together. For example, at least part of a pulse-detection circuit 365 and at least part of a frequency-detection circuit 600 may be combined together into a single circuit that performs both pulse detection and frequency detection. The pulse-detection circuit 365 in FIG. 18, which may be referred to as a combined pulse-detection and frequency-detection circuit, may also act as a frequency-detection circuit. The pulse-detection and frequency-detection circuit in FIG. 18 includes multiple comparators 370 and multiple TDCs 380. Each comparator 370 (i) receives a voltage signal 360 (which corresponds to the photocurrent signal i) and (ii) provides an electrical-edge signal to a corresponding TDC 380 when the voltage signal rises above or falls below a particular threshold voltage. The corresponding TDC 380 produces a time value corresponding to a time when the electrical-edge signal was received by the TDC. The output signal 145 produced by the pulse-detection and frequency-detection circuit in FIG. 18 corresponds to the voltage signal 360 and includes time values produced by each of the TDCs 380 that receive one or more edge signals from a comparator 370. In addition to determining the time-of-arrival of the received pulse of light 410 based on the output signal 145, a controller 150 may also determine the spectral signature of the received pulse of light 410 based on the output signal 145. For example, the time-of-arrival of the received pulse of light 410 may be determined from a time associated with a rising edge, peak, or temporal center of the voltage signal 360. Additionally, the output signal 145 may be analyzed to determine one or more beat frequencies of the voltage signal 360. For example, a fast Fourier transform (FFT) or a derivative may be applied to the output signal 145, and the beat frequencies of the voltage signal 360 may be determined from the resulting FFT or derivative signal.

FIG. 19 illustrates an example receiver 140 that includes a pulse-detection circuit 365 and a frequency-detection circuit 600. The voltage signal 360 produced by the electronic amplifier 350 in FIG. 19 is coupled to the frequency-detection circuit 600 and to the pulse-detection circuit 365. The pulse-detection circuit 365 may include multiple comparators 370 and multiple TDCs 380 (e.g., as illustrated in FIG. 18) or may include an analog-to-digital converter (e.g., as illustrated in FIG. 21). The pulse-detection circuit 365 receives the voltage signal 360 and produces a pulse-detection output signal 145a that may include or may be used to determine time-domain information for the received pulse of light 410 (e.g., a time-of-arrival or a duration of the received pulse of light). The frequency-detection circuit 600 receives the voltage signal 360 (which corresponds to the photocurrent signal i) and may determine frequency-domain or spectral-signature information associated with the received pulse of light 410. For example, the frequency-detection circuit 600 may determine the spectral signature of the received pulse of light 410 from the voltage signal. Since the voltage signal 360 and the photocurrent signal i correspond to one another, determining the spectral signature based on the voltage signal may be referred to as determining the spectral signature based on the photocurrent signal. The frequency-detection circuit 600 produces an output signal 145b that may include amplitude information for one or more beat frequencies of the voltage signal 360. The frequency-detection output signal 145b may include the amplitude of one or more beat frequencies associated with the received pulse of light 410, and this amplitude information may correspond to the spectral signature of the received pulse of light. The output signal 145b may be sent to a controller 150, and, based on the output signal 145b, the controller may determine whether the spectral signature of the received pulse of light 410 matches the spectral signature of an emitted pulse of light 400.

A frequency-detection circuit 600 may include multiple parallel frequency-measurement channels, and each frequency-measurement channel may include a filter 610 and a corresponding amplitude detector 620. Each filter 610 may receive a voltage signal 360 (which corresponds to a photocurrent signal i) and produce a filtered signal that is sent to a corresponding amplitude detector. In FIG. 19, the frequency-detection circuit 600 includes M electronic filters (filters 610-1, 610-2, . . . , 610-M), where each filter is associated with a particular frequency (frequencies fₐ, f_{b}, . . . , f_{M}). A filter 610 may include a passive filter implemented with one or more passive electronic components (e.g., one or more resistors, inductors, or capacitors). Alternatively, a filter 610 may include an active filter that includes one or more active electronic components (e.g., one or more transistors or op-amps) along with one or more passive components. Each filter 610 in FIG. 19 may include an electronic band-pass filter having a particular pass-band center frequency and width, and the filtered signal produced by the filter may correspond to the spectral portion of the voltage signal 360 that is within the pass-band of the filter. A band-pass filter may have (i) a center frequency between approximately 100 MHz and approximately 40 GHz and (ii) a pass-band with a frequency width of approximately 1 MHz, 10 MHz, 20 MHz, 50 MHz, 100 MHz, 200 MHz, or any other suitable frequency width. For example, filter 610-2 may include a band-pass filter with a center frequency f_{b} of 500 MHz and a pass-band width of 50 MHz, and the filter may pass or transmit spectral components of the voltage signal 360 with frequencies between approximately 475 MHz and 525 MHz. As another example, a frequency-detection circuit 600 may include four band-pass filters 610 with center frequencies of approximately 400 MHz, 600 MHz, 800 MHz, and 1 GHz, and each filter may have a pass-band with a frequency width of approximately 100 MHz. A 1.0-GHz filter with a 100-MHz pass-band may pass or transmit frequency components from approximately 0.95 GHz to approximately 1.05 GHz and may attenuate frequency components outside of that frequency range. The pass-band of a filter may be used to accommodate a random variation in spectral signatures imparted to pulses light due to the chaotic nature of nonlinear optical effects that may occur in a light source. For example, if beat frequencies are randomly distributed within a 100-MHz frequency range, then a 100-MHz pass-band may allow for detection of the beat frequencies.

In addition to the M electronic filters 610, the frequency-detection circuit 600 in FIG. 19 also includes M electronic amplitude detectors (amplitude detectors 620-1, 620-2, . . . , 620-M), and each electronic filter may be coupled to a corresponding amplitude detector. The number M of filters 610 and amplitude detectors 620 in a frequency-detection circuit 600 may be 1, 2, 4, 8, 10, 20, 50, or any other suitable number of filters and amplitude detectors. An amplitude detector 620 may be configured to produce an amplitude signal that corresponds to an amplitude (e.g., a peak value, a size, or an energy) of an electrical signal received from a filter 610. For example, the filter 610 Min FIG. 19 may receive the voltage signal 360 and provide to amplitude detector 620-M a filtered signal that includes the spectral portion of the voltage signal 360 at or near the frequency f_{M}. The amplitude detector 620-M may produce a digital or analog amplitude signal that corresponds to the amplitude or energy of the filtered signal, and the amplitude or energy of the filtered signal may indicate the amplitude of a beat signal with a beat frequency of approximately f_{M}. If the amplitude of the beat signal is above a particular threshold value, then the voltage signal 360 may be considered to include a beat signal with a beat frequency of approximately f_{M}. Similarly, if the beat-signal amplitude is below the threshold value, then the voltage signal 360 may be considered to not include the beat signal with a beat frequency of approximately f_{M}.

Each amplitude detector 620 may include a sample-and-hold circuit, a peak-detector circuit, an integrator circuit, a comparator, or an ADC. For example, amplitude detector 620-M may include a sample-and-hold circuit and an ADC. The sample-and-hold circuit may produce an analog voltage corresponding to the amplitude of a filtered signal received from filter 610-M, and the ADC may produce a digital value that represents the analog voltage. As another example, amplitude detector 620-M may include an integrator circuit followed by a comparator. The comparator may produce a digital-high value (e.g., digital value “1”) if a signal from the integrator circuit is greater than or equal to a particular threshold voltage. A digital-high value produced by the comparator may indicate that the voltage signal 360 includes a beat signal with a beat frequency of approximately f_{M}. A digital-low value from the comparator may indicate that the voltage signal 360 does not include a beat signal with a beat frequency of approximately f_{M}.

The output signal 145 produced by a frequency-detection circuit 600 may include one or more amplitude signals from one or more amplitude detectors 620. For example, the output signal 145b in FIG. 19 may include M amplitude values corresponding to M respective amplitudes of beat signals at each of the filter pass-band center frequencies. The amplitude signal from each amplitude detector may include amplitude information for a particular beat frequency, and the amplitude signals produced by the amplitude detectors 620 (which together corresponds to the output signal 145b) may represent the spectral signature of the received pulse of light 410. For example, the amplitude signal produced by an amplitude detector 620 may have a value that represents the amplitude of a filtered signal produced by a corresponding filter 610 (e.g., the amplitude signal may include a digital value that represents the amplitude of the filtered signal). The amplitude of the filtered signal may represent the amplitude of a beat signal with a beat frequency within the pass-band of the filter 610. As another example, the amplitude signal produced by an amplitude detector 620 may include a first value (e.g., a digital value “1”) if the amplitude of the filtered signal is greater than or equal to a particular threshold value and a second value (e.g., a digital value “0”) if the amplitude of the filtered signal is less than the particular threshold value. A digital value of 1 may indicate that the corresponding beat frequency is present in the photocurrent signal i or voltage signal 360, and a digital value of 0 may indicate that the beat frequency is not present. For example, if the beat frequency Δf of the beat signal in FIG. 19 is 600 MHz, then an amplitude detector 620 coupled to a band-pass filter 610 with a center frequency of approximately 600 MHz may produce a digital value of 1, which indicates that a 600-MHz beat frequency is present in the voltage signal 360. Additionally, amplitude detectors coupled to band-pass filters with center frequencies of 400 MHz, 800 MHz, and 1 GHz may each produce a digital value of 0 (which indicates that the voltage signal 360 does not include a beat signal at 400 MHz, 600 MHz, or 1 GHz).

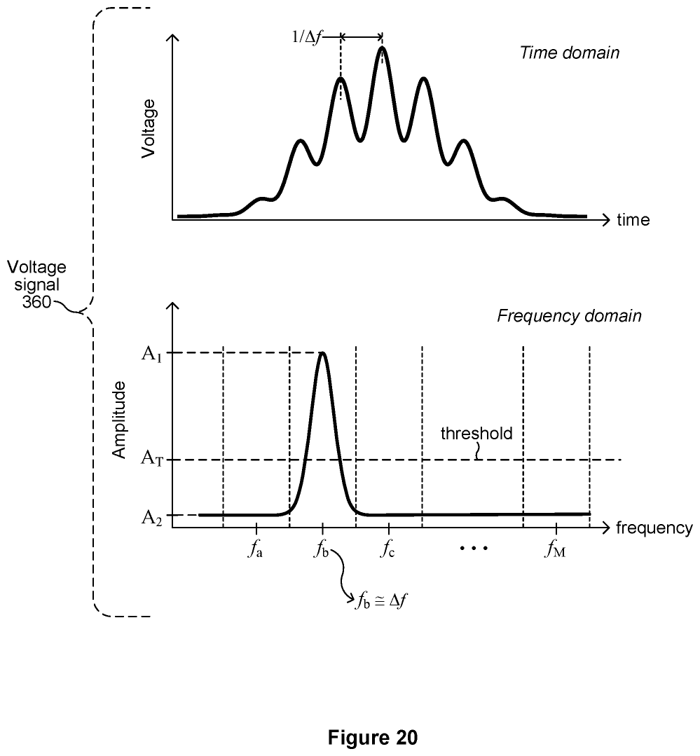

FIG. 20 illustrates example time-domain and frequency-domain graphs of a voltage signal 360. The time-domain graph of the voltage signal 360 includes temporal pulsations that correspond to a beat signal with a beat frequency of Δf. The frequency-domain graph (which may be referred to as a frequency spectrum or an electronic frequency spectrum of the voltage signal) illustrates the electronic power or the power spectral density of the voltage signal 360 as a function of frequency. The frequency-spectrum graph in FIG. 20 is similar to the frequency-spectrum graph in FIG. 13, except the frequency-spectrum graph in FIG. 20 is an electronic frequency spectrum with the frequency axis having a range less than 40 GHz (e.g., an electronic frequency range from 100 MHz to 1 GHz), while the frequency-spectrum graph in FIG. 13 is an optical frequency spectrum with the frequency axis having a range between approximately 150 THz and 330 THz (e.g., an optical frequency range from 190 THz to 200 THz). The frequencies fₐ, f_{b}, f_{c}, . . . , f_{M} in FIG. 20 may correspond to the center frequencies of the band-pass filters 610 in FIG. 19. The frequency-domain graph has a peak at the beat frequency Δf, which corresponds to the band-pass frequency f_{b} of filter 610-2. For example, the band-pass filters may have respective center frequencies of 400 MHz, 600 MHz, 800 MHz, and 1 GHz, and the beat frequency may have a frequency of approximately 600 MHz, which corresponds to the band-pass frequency f_{b} of 600 MHz. The output signal 145b produced by the frequency-detection circuit 600 in FIG. 19 in response to the voltage signal 360 in FIG. 20 may include the amplitude values A₂, A₁, A₂, and A₂ (which corresponds to the amplitudes of the respective frequencies fₐ, f_{b}, f_{c}, and f_{M}). The amplitude A_{T} represents a threshold amplitude value. A beat signal with an amplitude above A_{T} may indicate that the corresponding beat frequency is present in the voltage signal 360, and an amplitude below A_{T} may indicate that the corresponding beat frequency is not present. The amplitude A₁ is above the threshold A_{T}, which indicates that a beat signal with a beat frequency of approximately f_{b} is present in the voltage signal 360. The amplitude A₂ of the beat signals at frequencies fₐ, f_{c}, and f_{M} is below the beat-signal threshold, which indicates that those beat frequencies are not present in the voltage signal 360. If the output signal 145b in FIG. 19 includes a digital value 1 to indicate that a beat frequency is present and a digital value 0 to indicate that a beat frequency is not present, then the output signal in response to the voltage signal 360 in FIG. 20 may include the values 0, 1, 0, and 0 (which corresponds to the amplitude values A₂, A₁, A₂, and A₂ of the respective frequencies fₐ, f_{b}, f_{c}, and f_{M}).

FIG. 21 illustrates an example receiver 140 that includes a pulse-detection circuit 365 with an analog-to-digital converter (ADC) 368. The ADC 368 may sample the voltage signal 360 and produce an output signal 145 that includes a digital representation of the voltage signal. For example, the output signal 145 may include a series of digital values that represents the temporal behavior or shape of the voltage signal 360, and a time-of-arrival of the received pulse of light 410 may be determined based on the output signal 145. The pulse-detection circuit 365 in FIG. 21 may also act as a frequency-detection circuit and may be referred to as a pulse-detection and frequency-detection circuit. In addition to determining the time-of-arrival of the received pulse of light 410 based on the output signal 145, the spectral signature of the received pulse of light 410 may also be determined based on the output signal 145. The ADC 368 may receive the voltage signal 360 (which corresponds to the photocurrent signal i) and produce a digital output signal 145 that corresponds to the voltage signal and the photocurrent signal. A controller 150 may determine the time-of-arrival and the spectral signature of the received pulse of light 410 based on the output signal 145. The time-of-arrival of the received pulse of light 410 may be determined based on a time associated with a rising edge, peak, or temporal center of the voltage signal 360. Additionally, the output signal 145 may be analyzed to determine one or more beat frequencies of the voltage signal 360. For example, a fast Fourier transform (FFT) or a derivative may be applied to the output signal 145, and one or more beat frequencies of the voltage signal 360 may be determined from the resulting FFT or derivative signal. A peak of a FFT may correspond to a beat frequency of the voltage signal 360. The beat frequencies associated with the received pulse of light 410 may represent the spectral signature of the received pulse. An ADC 368 may sample the voltage signal 360 at a sampling rate that is greater than or equal to twice the highest beat frequency to be measured. For example, if the pulse-detection circuit 365 is configured to measure beat frequencies up to a maximum of Δfₘₐₓ, then the ADC 368 may have a sampling rate greater than or equal to 2Δfₘₐₓ. As another example, if the maximum beat frequency to be measured is 1 GHz, then the ADC 368 may sample the voltage signal 360 at a sampling rate greater than or equal to 2 GHz.

A frequency-detection circuit may be configured to determine a spectral signature of a received pulse of light 410 based on a corresponding photocurrent signal i. Determining the spectral signature of the received pulse of light 410 may include determining an electronic frequency spectrum of the photocurrent signal i. For example, an amplifier 350 may produce a voltage signal 360 that corresponds to the photocurrent signal i, and a frequency-detection circuit may determine a frequency spectrum of the voltage signal (which corresponds to a frequency spectrum of the photocurrent signal). A frequency spectrum associated with an emitted pulse of light 400 or a received pulse of light 410 may be determined from an output signal 145 produced by (i) a pulse-detection and frequency-detection circuit that includes multiple comparators 370 and TDCs 380 (e.g., as illustrated in FIG. 18), (ii) a frequency-detection circuit 600 that includes multiple filters 610 and amplitude detectors 620 (e.g., as illustrated in FIG. 19), or (iii) a pulse-detection and frequency-detection circuit that includes an ADC 368 (e.g., as illustrated in FIG. 21). For example, the ADC 368 in FIG. 21 may produce an output signal 145 that includes a series of digital values that represents the time-domain behavior of the voltage signal 360. The frequency spectrum of the voltage signal may be determined by taking a fast Fourier transform (FFT) of the output signal. The frequency spectrum may be a digital representation of the power spectral density of the voltage signal or photocurrent signal. A frequency spectrum associated with a received pulse of light 410 may include a graph, list, table, or matrix that indicates an amplitude (e.g., an amount of power, energy, current, or voltage) of a voltage signal 360 as a function of frequency. In the example of FIG. 20, a frequency spectrum of the voltage signal 360 may include a series of values that represents the frequency-domain curve in the lower portion of FIG. 20.

A controller 150 may determine whether the spectral signatures of a received pulse of light 410 and an emitted pulse of light 400 match based on the associated frequency spectra of the pulses of light. Determining whether the spectral signature of a received pulse of light 410 matches the spectral signature of an emitted pulse of light 400 may include comparing a frequency spectrum associated with the received pulse of light to a frequency spectrum associated with the emitted pulse of light. For example, a controller 150 may compare the frequency spectrum of a voltage signal 360 associated with the received pulse of light to a frequency spectrum of a voltage signal associated with the emitted pulse of light. The comparison of the frequency spectra may include determining a measure of correlation between the frequency spectrum associated with the received pulse of light and the frequency spectrum associated with the emitted pulse of light. For example, a convolution or a cross-correlation between the two frequency spectra may be calculated to determine the measure of correlation, and if the measure of correlation exceeds a particular threshold value, then the spectral signatures of the received and emitted pulses of light may be determined to match.

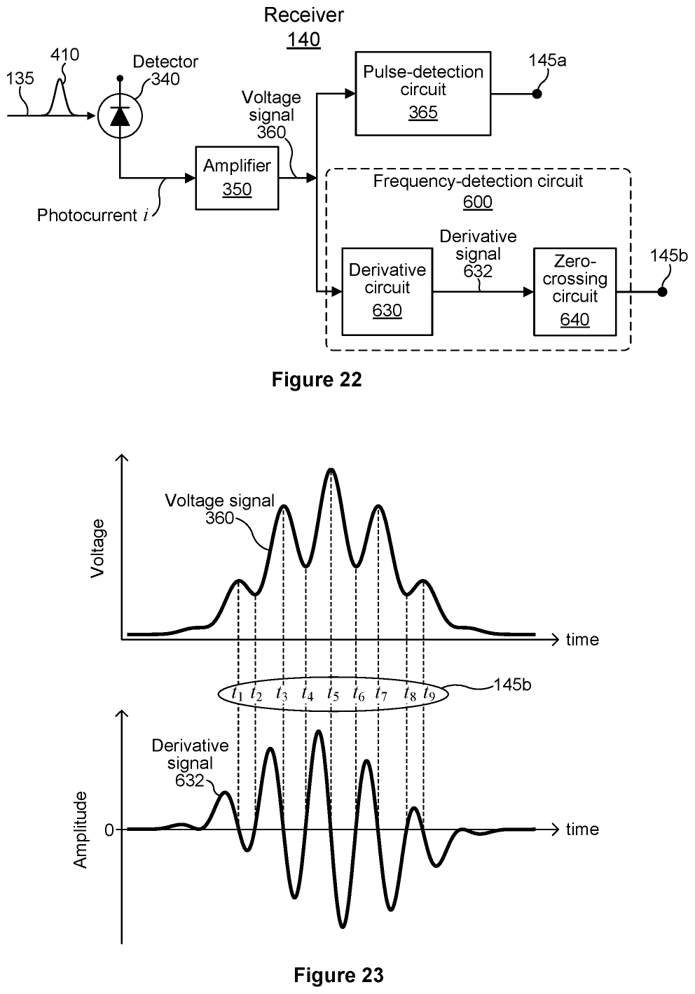

FIG. 22 illustrates an example receiver 140 that includes a frequency-detection circuit 600 with a derivative circuit 630 and a zero-crossing circuit 640. The derivative circuit 630 receives a voltage signal 360 and produces a derivative signal 632 corresponding to a first derivative with respect to time of the voltage signal. The voltage signal 360 in FIG. 22 corresponds to the photocurrent signal i, and the derivative signal 632 may correspond to a first derivative of the photocurrent signal i. The derivative circuit 630 may include an analog differentiator, such as for example, an operational amplifier (op-amp) configured to act as an analog differentiator of the voltage signal 360. The op-amp differentiator circuit may include a series capacitor coupled to the inverting input terminal of the op-amp and a resistor located across the op-amp (e.g., coupled from the inverting input to the output of the op-amp) to provide negative feedback. The derivative signal 632 may be an analog voltage signal that is proportional to the first derivative with respect to time of the voltage signal 360. The zero-crossing circuit 640 may determine two or more zero crossings of the derivative signal 632. Each zero crossing may include a time value indicating a time at which the derivative signal 632 crosses the x-axis, where the x-axis corresponds to a value of approximately zero volts for the derivative signal. Each zero crossing may correspond to a time associated with a local maximum or minimum of the voltage signal 360 or the corresponding current signal i. The zero-crossing circuit 640 may include a comparator followed by a timer circuit (e.g., a TDC), and the threshold voltage for the comparator may be set to approximately zero volts. When the derivative signal 632 crosses zero volts, the comparator 370 may produce an electrical-edge signal, and the timer circuit may produce a digital value that represents a time when the edge signal is received from the comparator. The frequency-detection output signal 145b may include two or more digital time values, each time value corresponding to one of the zero crossings.

In another embodiment, instead of using an analog differentiator to determine the derivative of a voltage signal 360, a digital or numerical technique may be employed. For example, the output signal 145a from a pulse-detection circuit 365 may be provided to a controller 150, and the controller may determine the derivative of the voltage signal 360 from the output signal. A pulse-detection circuit 365 that includes multiple comparators and TDCs (e.g., as illustrated in FIG. 18) or that includes an ADC 368 (e.g., as illustrated in FIG. 21) may produce an output signal that includes a digital representation of a voltage signal. The controller may apply a numerical technique to the output signal to determine a corresponding derivative of the voltage signal. Additionally, instead of using a zero-crossing circuit to determine the zero crossings of the derivative of the voltage signal, the controller may analyze the derivative of the voltage signal to determine the zero-crossing times.

FIG. 23 illustrates example graphs of a voltage signal 360 and a corresponding derivative signal 632. The voltage and derivative signals may be produced by the receiver 140 of FIG. 22 in response to detecting the received pulse of light 410. The voltage signal 360 includes temporal pulsations that correspond to a beat signal, and the derivative signal 632 represents a first derivative of the voltage signal. Each zero crossing of the derivative signal 632 corresponds to a peak or valley of the voltage signal (e.g., a local maximum or minimum of the voltage signal, or a point with zero slope). The derivative signal 632 in FIG. 23 includes nine zero crossings, represented by the nine time values t₁, t₂, t₃, t₄, t₅, t₆, t₇, t₈, and t₉. The output signal 145b may include the time values for the nine zero crossings, and the output signal may represent the spectral signature of the received pulse of light 410 in FIG. 22. The frequency-detection circuit 600 in FIG. 22 may send the frequency-detection output signal 145b that includes the time values of the zero crossings to a controller 150. Based on the zero crossings, the controller 150 may determine whether the spectral signature of the received pulse of light 410 matches a spectral signature of an emitted pulse of light 400.

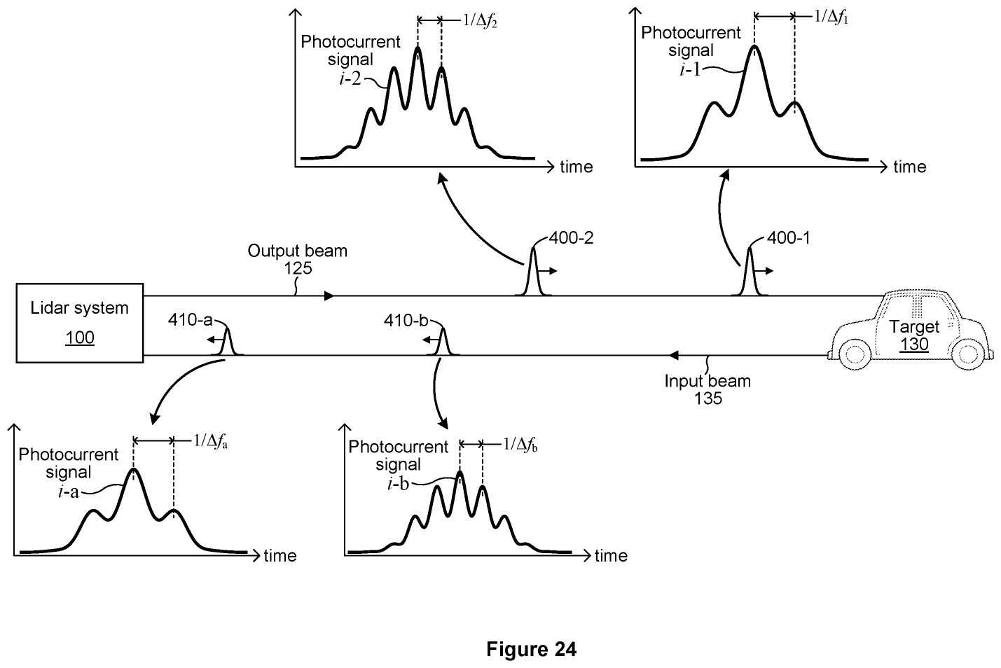

FIG. 24 illustrates an example lidar system 100 that emits pulses of light 400-1 and 400-2 that are scattered by a target 130. Each of the received pulses of light 410-a and 410-b may include scattered light from one of the emitted pulses of light. The photocurrent signal i-1 corresponds to the emitted pulse of light 400-1, and the photocurrent signal i-2 corresponds to the emitted pulse of light 400-2. The lidar system 100 may include an optical splitter 470 that splits off a portion of each emitted pulse of light to produce an associated test pulse of light 400t, and the lidar system may include a detector that produces the photocurrent signals i-1 and i-2 in response to the test pulses of light. The lidar system 100 may determine the spectral signature of each of the emitted pulses of light 400-1 and 400-2 based on the associated photocurrent signals i-1 and i-2. For example, a frequency-detection circuit 600 may determine the spectral signature of the emitted pulse of light 400-1 based on a voltage signal that corresponds to the photocurrent signal i-1. Similarly, the lidar system 100 may determine the spectral signatures of the received pulses of light 410-a and 410-b based on the associated photocurrent signals i-a and i-b. Determining a spectral signature of a pulse of light may include (i) determining one or more beat frequencies of a photocurrent signal or voltage signal associated with the pulse of light, (ii) determining a frequency spectrum of a photocurrent signal or voltage signal associated with the pulse of light, or (iii) determining zero crossings of the derivative of a photocurrent signal or voltage signal associated with the pulse of light.

The lidar system 100 in FIG. 24 may include a controller 150 that determines whether the spectral signature of a received pulse of light matches the spectral signature of an emitted pulse of light. For example, the controller may compare spectral signatures and determine that the spectral signature of the received pulse of light 410-a matches the spectral signature of the emitted pulse of light 400-1. Additionally or alternatively, the controller may determine that the spectral signature of the received pulse of light 410-a does not match the spectral signature of the emitted pulse of light 400-2. Based on the comparison of spectral signatures, the controller may determine that the received pulse of light 410-a is associated with the emitted pulse of light 400-1, which indicates that the received pulse of light 410-a includes light from the emitted pulse of light 400-1 that was scattered from the target 130. Additionally, the controller may determine that the received pulse of light 410-a is not associated with the emitted pulse of light 400-2. Similarly, the controller may determine that the received pulse of light 410-b is associated with the emitted pulse of light 400-2 and is not associated with the emitted pulse of light 400-1.

Determining whether the spectral signatures of two pulses of light match may include determining whether the pulses of light are associated with approximately the same beat frequencies (e.g., each of the one or more beat frequencies associated with each pulse of light are approximately equal). A pulse of light may be associated with one or more beat signals having one or more respective beat frequencies, and the spectral signature of a received pulse of light 410 may be determined to match the spectral signature of an emitted pulse of light 400 if the beat frequencies associated with each of the pulses of light are approximately equal. For example, the spectral signatures may be determined to match if each pair of beat frequencies associated with each pulse of light is approximately equal (e.g., each pair of beat frequencies may be equal to within ±1%, ±2%, ±5%, or ±10% of one another). Additionally, spectral signatures of a received pulse of light 410 and an emitted pulse of light 400 may be determined not to match if one or more beat frequencies associated with one pulse of light is not also associated with the other pulse of light. For example, a first pulse of light with an associated beat frequency of 500 MHz and a second pulse of light with an associated beat frequency of 505 MHz may be determined to have spectral signatures that match. As another example, a first pulse of light with an associated beat frequency of 500 MHz and a second pulse of light with an associated beat frequency of 800 MHz may be determined to have spectral signatures that do not match. As another example, a first pulse of light with associated beat frequencies 200 MHz and 800 MHz and a second pulse of light with associated beat frequencies 205 MHz and 790 MHz may be determined to have spectral signatures that match. As another example, a first pulse of light with associated beat frequencies 200 MHz and 800 MHz and a second pulse of light with associated beat frequencies 205 MHz, 500 MHz, and 805 MHz may be determined to have spectral signatures that do not match. As another example, a first pulse of light with associated beat frequencies 200 MHz and 800 MHz and a second pulse of light with associated beat frequencies 205 MHz and 500 MHz may be determined to have spectral signatures that do not match.

In FIG. 24, the emitted pulse of light 400-1 is associated with a photocurrent signal i-1 that has a beat signal with a beat frequency of Δf₁, and the emitted pulse of light 400-2 is associated with a photocurrent signal i-2 that has a beat signal with a beat frequency of Δf₂, where Δf₁ and Δf₂ are not equal. The received pulse of light 410-a is associated with a photocurrent signal i-a that has a beat signal with a beat frequency of Δfₐ, and the received pulse of light 410-b is associated with a photocurrent signal i-b that has a beat signal with a beat frequency of Δf_{b}, where Δfₐ and Δf₁, are not equal. A controller may determine that the beat frequencies Δfₐ and Δf₁ are approximately equal, and the spectral signature of the received pulse of light 410-a may be determined to match the spectral signature of the emitted pulse of light 400-1 based on the beat frequencies Δfₐ and Δf₁ being approximately equal. Additionally, the spectral signature of the received pulse of light 410-a may be determined to not match the spectral signature of the emitted pulse of light 400-2 based on the beat frequency Δfₐ being different from the beat frequency Δf₂. Similarly, the spectral signature of the received pulse of light 410-b may be determined to match the spectral signature of the emitted pulse of light 400-2 based on the beat frequencies Δf_{b}, and Δf₂ being approximately equal. Additionally, the spectral signature of the received pulse of light 410-b may be determined to not match the spectral signature of the emitted pulse of light 400-1 based on the beat frequency Δf_{b}, being different from the beat frequency Δf₁.

Determining whether the spectral signatures of two pulses of light match may include determining whether a particular threshold number or percentage of beat frequencies associated with each pulse of light are approximately equal. For example, instead of requiring all the associated beat frequencies to be equal in order for two pulses of light to have matching spectral signatures, two spectral signatures may be determined to match if at least a particular percentage (e.g., 70%, 80%, or 90%) of their associated beat frequencies are approximately equal. Two pulses of light that have four out of five beat frequencies that are approximately equal (e.g., 80% of the associated beat frequencies are approximately equal) may be determined to have spectral signatures that match. As another example, a frequency-detection circuit 600 may include five frequency-measurement channels that measure the amplitudes of five different frequency components of a voltage signal. For two pulses of light, if the amplitudes of at least four of the five frequencies are approximately equal, then the two pulses of light may be determined to have spectral signatures that match. Alternatively, if less than or equal to three of the five frequencies are approximately equal, then the two pulses of light may be determined to have spectral signatures that do not match.

Determining whether the spectral signatures of two pulses of light match may include determining whether a measure of correlation between the two spectral signatures is greater than a particular threshold correlation value. If the measure of correlation between the spectral signatures is greater than the threshold correlation value, then a controller 150 may determine that the two spectral signatures match. For example, a controller 150 may compare the frequency spectrum of a voltage signal 360 associated with a received pulse of light 410 to the frequency spectrum of a voltage signal associated with an emitted pulse of light 400. The comparison of the frequency spectra may include determining a measure of correlation between the frequency spectrum associated with the received pulse of light and the frequency spectrum associated with the emitted pulse of light. A measure of correlation may be determined by calculating a convolution or cross-correlation between the two frequency spectra, and if the measure of correlation exceeds the threshold correlation value, then the spectral signatures of the received and emitted pulses of light may be determined to match. The threshold value for determining that two spectral signatures match may be any suitable value, such as for example, 1.0 (indicating a 100% correlation between the two spectral signatures), 0.9 (indicating a 90% correlation), or 0.8 (indicating an 80% correlation). In FIG. 24, the correlation between frequency spectra associated with the received pulse of light 410-a and the emitted pulse of light 400-1 may be determined to be 90%, and the correlation between frequency spectra associated with the received pulse of light 410-a and the emitted pulse of light 400-2 may be 30%. If the threshold correlation value is 80%, then the spectral signatures of the received pulse of light 410-a and the emitted pulse of light 400-1 may be determined to match, which indicates that the received pulse of light includes scattered light from the emitted pulse of light. Additionally, the spectral signatures of the received pulse of light 410-a and the emitted pulse of light 400-2 may be determined not to match.

A measure of correlation between the spectral signatures of two pulses of light may be determined based on the zero crossings of derivative signals 632 associated with each of the pulses of light. For example, a receiver 140 may include a derivative circuit 630 that produces a derivative signal 632 and a zero-crossing circuit 640 that determines the zero-crossing times of the derivative signal. A controller 150 may compare the zero crossings associated with a received pulse of light 410 to the zero crossings associated with an emitted pulse of light 400 to determine an amount of correlation between the two sets of zero-crossing data. A measure of correlation may be determined by calculating a convolution or cross-correlation between the two sets of zero-crossing data, and if the measure of correlation exceeds a threshold correlation value, then the spectral signatures of the received and emitted pulses of light may be determined to match. In FIG. 24, the correlation between the zero crossings associated with the received pulse of light 410-b and the emitted pulse of light 400-1 may be determined to be 45%, and the correlation between the zero crossings associated with the received pulse of light 410-b and the emitted pulse of light 400-2 may be 95%. If the threshold correlation value is 90%, then the spectral signatures of the received pulse of light 410-b and the emitted pulse of light 400-2 may be determined to match. Additionally, the spectral signatures of the received pulse of light 410-b and the emitted pulse of light 400-1 may be determined not to match.

Comparing two sets of zero crossings may include a direct comparison of time values. For example the time intervals t₂-t₁, t₃-t₁, t₄-t₁, etc. in FIG. 23 associated with the received pulse of light 410 in FIG. 22 may be compared with corresponding time intervals for an emitted pulse of light 400. Alternatively, comparing two sets of zero crossings may include comparing ratios of time intervals, which may allow for scaling, distortion, or stretching of one set of zero crossings with respect to another (e.g., due to a Doppler shift). For example, the scaled time-interval values (t₃-t₁)/(t₂-t₁), (t₄-t₁)/(t₂-t₁), (t₅-t₁)/(t₂-t₁), etc. associated with the received pulse of light 410 in FIG. 22 may be compared with corresponding scaled time-interval values of an emitted pulse of light 400.

A measure of correlation between the spectral signatures of two pulses of light may be determined based on output signals 145 associated with each of the pulses of light. For example, a pulse-detection circuit 365 may include multiple comparators and TDCs (e.g., as illustrated in FIG. 18) or may include an ADC 368 (e.g., as illustrated in FIG. 21), and the output signal 145 produced by the pulse-detection circuit 365 may include a digital representation of a voltage signal 360 corresponding to a pulse of light. As an example, the output signal 145 may include a series of digital values that represents the temporal behavior or shape of the voltage signal 360. A controller 150 may compare the output signal associated with a received pulse of light 410 to the output signal associated with an emitted pulse of light 400 to determine an amount of correlation between the two pulses of light. For example, a measure of correlation may be determined by calculating a convolution or cross-correlation between the two output signals 145. If the measure of correlation exceeds a threshold correlation value, then the spectral signatures of the received and emitted pulses of light may be determined to match.

Determining which of two or more emitted pulses of light 400 a received pulse of light 410 is associated with may include determining a measure of correlation between the received pulse of light and each of the emitted pulses of light. For example, a frequency-detection circuit 600 may determine the spectral signatures of the P most recently emitted pulses of light 400 (where P is an integer greater than or equal to 2), and a controller 150 may store the P spectral signatures. The parameter P may have a value of 2, 3, 4, 5, 10, 20, 50, 100, or any other suitable value less than or equal to approximately 100, and each of the P most recently emitted pulses of light may have a different spectral signature. The spectral signature of a received pulse of light 410 may be compared with the each of the stored spectral signatures of the P emitted pulses of light 400 to determine P measures of correlation between the received pulse of light and each of the emitted pulses of light. The measures of correlation may be determined based on frequency spectra, zero crossings, or output signals 145 associated with the pulses of light. A controller may determine that the spectral signature of the received pulse of light 410 matches the spectral signature of a particular emitted pulse of light, based on the particular emitted pulse of light having the highest measure of correlation with the received pulse of light (which indicates that the received pulse of light is associated with the particular emitted pulse of light). The measure of correlation between the spectral signatures of the received pulse of light and the particular emitted pulse of light may be greater than each of the (P−1) measures of correlation between the spectral signatures of the received pulse of light and the other (P−1) emitted pulses of light.

If none of the P measures of correlation exceeds a minimum threshold value (e.g., a minimum threshold value of 70% correlation), then the controller may determine that the spectral signature of the received pulse of light 410 does not match any of the P different spectral signatures of the most recently emitted pulses of light. For example, the received pulse of light 410 may be an interfering optical signal that is not associated with any of the P most recently emitted pulses of light. The received pulse of light may originate from a light source external to the lidar system (e.g., the pulse of light may originate from another lidar system), and the received pulse of light may be determined to be an invalid or interfering optical signal. If a received pulse of light is determined to be an interfering optical signal, the interfering optical signal may be discarded or ignored since it is not associated with any of the emitted pulses of light 400. A lidar system 100 may refrain from determining a time-of-arrival or determining a distance to a target 130 until a received pulse of light 410 is determined to be valid. For example, a receiver 140 or controller 150 may first verify that a received pulse of light 410 is valid (e.g., based on a measure of correlation) before determining a time-of-arrival for the received pulse of light or determining a distance to a target 130 associated with the received pulse of light. If a received pulse of light 410 is determined to be an interfering optical signal, the receiver 140 may not perform further analysis to determine the time-of-arrival or to determine a distance to a target.

In FIG. 24, the parameter P may be 2, and the emitted pulses 400-1 and 400-2 may represent the two most recently emitted pulses of light. A measure of correlation between the spectral signatures of the received pulse of light 410-a and the emitted pulse of light 400-1 may be determined to be higher than a measure of correlation between the spectral signatures of the received pulse of light 410-a and the emitted pulse of light 400-2. The higher correlation with the emitted pulse of light 400-1 may indicate that the spectral signatures of the received pulse of light 410-a and the emitted pulse of light 400-1 match. This indicates that the received pulse of light 410-a is associated with the emitted pulse of light 400-1 (e.g., the received pulse of light 410-a includes light from the emitted pulse of light 400-1 that was scattered from the target 130). Additionally, a relatively low measure of correlation between the spectral signatures of the received pulse of light 410-b and the emitted pulse of light 400-1 may indicate that the spectral signatures of the received pulse of light 410-b and the emitted pulse of light 400-1 do not match. A measure of correlation between the spectral signatures of the received pulse of light 410-b and the emitted pulse of light 400-1 may be determined to be lower than a measure of correlation between the spectral signatures of the received pulse of light 410-b and the emitted pulse of light 400-2. The higher correlation with the emitted pulse of light 400-2 may indicate that the spectral signatures of the received pulse of light 410-b and the emitted pulse of light 400-2 match.

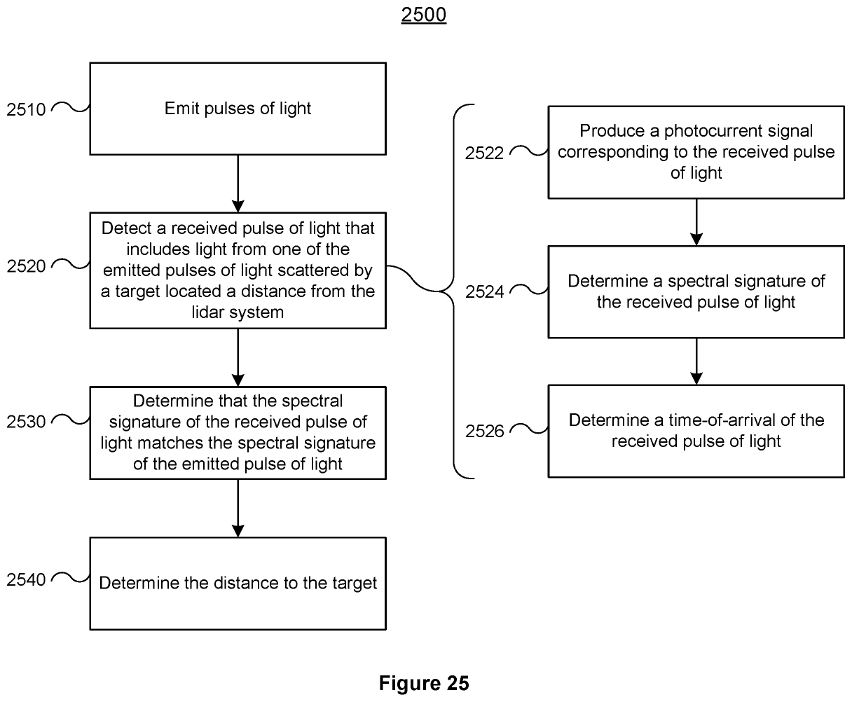

FIG. 25 illustrates an example method 2500 for determining the distance from a lidar system 100 to a target 130. The method 2500 may begin at step 2510 where a light source 110 of a lidar system 100 emits pulses of light 400. Each emitted pulse of light may include a spectral signature of multiple different spectral signatures. At step 2520, a receiver 140 of the lidar system 100 may detect a received pulse of light 410. The received pulse of light 410 may include light from one of the emitted pulses of light 400 scattered by a target 130 located a distance D from the lidar system 100, and the emitted pulse of light 400 may include one of the spectral signatures of the multiple different spectral signatures. Step 2520 of detecting the received pulse of light 410 may include step 2522, step 2524, and step 2526. At step 2522, a detector 340 may produce a photocurrent signal corresponding to the received pulse of light 410. At step 2524, a frequency-detection circuit 600 may determine the spectral signature of the received pulse of light 410. At step 2526, a pulse-detection circuit 365 may determine a time-of-arrival of the received pulse of light 410. At step 2530, a processor or controller 150 of the lidar system 100 may determine that the spectral signature of the received pulse of light 410 matches the spectral signature of the emitted pulse of light 400. The spectral signatures of the two pulses of light matching may indicate that the received pulse of light 410 is associated with the emitted pulse of light 400 (e.g., the received pulse of light includes light from the emitted pulse of light that was scattered from the target). At step 2540, the processor or controller 150 may determine the distance from the lidar system 100 to the target 130 based on the time-of-arrival of the received pulse of light 410, at which point the method 2500 may end. For example, the distance D to the target 130 may be determined from the expression D=c·ΔT/2, where Δτ is the round-trip time of flight for a portion of an emitted pulse of light 400 to travel to the target 130 and back to the lidar system 100. The round-trip time of flight may be determined from the expression ΔT=T₂−T₁, where T₂ is the time-of-arrival of the received pulse of light 410, and T₁ is a time at which the corresponding pulse of light 400 was emitted.

FIG. 26 illustrates an example computer system 2600. One or more computer systems 2600 may perform one or more steps of one or more methods described or illustrated herein. One or more computer systems 2600 may provide functionality described or illustrated herein. Software running on one or more computer systems 2600 may perform one or more steps of one or more methods described or illustrated herein or may provide functionality described or illustrated herein. A computer system may be referred to as a processor, a controller, a computing device, a computing system, a computer, a general-purpose computer, or a data-processing apparatus. For example, controller 150 in FIG. 1 or as described herein may be referred to or may include a computer system. Herein, reference to a computer system may encompass one or more computer systems, where appropriate.

Computer system 2600 may take any suitable physical form. As an example, computer system 2600 may be an embedded computer system, a system-on-chip (SOC), an application-specific integrated circuit (ASIC), a field-programmable gate array (FPGA), a single-board computer system (SBC), a desktop computer system, a laptop or notebook computer system, a mainframe, a mesh of computer systems, a server, a tablet computer system, or any suitable combination of two or more of these. As another example, all or part of computer system 2600 may be combined with, coupled to, or integrated into a variety of devices, including, but not limited to, a camera, camcorder, personal digital assistant (PDA), mobile telephone, smartphone, electronic reading device (e.g., an e-reader), game console, smart watch, clock, calculator, television monitor, flat-panel display, computer monitor, vehicle display (e.g., odometer display or dashboard display), vehicle navigation system, lidar system, ADAS, autonomous vehicle, autonomous-vehicle driving system, cockpit control, camera view display (e.g., display of a rear-view camera in a vehicle), eyewear, or head-mounted display. Where appropriate, computer system 2600 may include one or more computer systems 2600; be unitary or distributed; span multiple locations; span multiple machines; span multiple data centers; or reside in a cloud, which may include one or more cloud components in one or more networks. Where appropriate, one or more computer systems 2600 may perform without substantial spatial or temporal limitation one or more steps of one or more methods described or illustrated herein. As an example, one or more computer systems 2600 may perform in real time or in batch mode one or more steps of one or more methods described or illustrated herein. One or more computer systems 2600 may perform at different times or at different locations one or more steps of one or more methods described or illustrated herein, where appropriate.

As illustrated in the example of FIG. 26, computer system 2600 may include a processor 2610, memory 2620, storage 2630, an input/output (I/O) interface 2640, a communication interface 2650, or a bus 2660. Computer system 2600 may include any suitable number of any suitable components in any suitable arrangement.

Processor 2610 may include hardware for executing instructions, such as those making up a computer program. As an example, to execute instructions, processor 2610 may retrieve (or fetch) the instructions from an internal register, an internal cache, memory 2620, or storage 2630; decode and execute them; and then write one or more results to an internal register, an internal cache, memory 2620, or storage 2630. A processor 2610 may include one or more internal caches for data, instructions, or addresses. Processor 2610 may include any suitable number of any suitable internal caches, where appropriate. As an example, processor 2610 may include one or more instruction caches, one or more data caches, or one or more translation lookaside buffers (TLBs). Instructions in the instruction caches may be copies of instructions in memory 2620 or storage 2630, and the instruction caches may speed up retrieval of those instructions by processor 2610. Data in the data caches may be copies of data in memory 2620 or storage 2630 for instructions executing at processor 2610 to operate on; the results of previous instructions executed at processor 2610 for access by subsequent instructions executing at processor 2610 or for writing to memory 2620 or storage 2630; or other suitable data. The data caches may speed up read or write operations by processor 2610. The TLBs may speed up virtual-address translation for processor 2610. Processor 2610 may include one or more internal registers for data, instructions, or addresses. Processor 2610 may include any suitable number of any suitable internal registers, where appropriate. Where appropriate, processor 2610 may include one or more arithmetic logic units (ALUs); may be a multi-core processor; or may include one or more processors 2610.

Memory 2620 may include main memory for storing instructions for processor 2610 to execute or data for processor 2610 to operate on. As an example, computer system 2600 may load instructions from storage 2630 or another source (such as, for example, another computer system 2600) to memory 2620. Processor 2610 may then load the instructions from memory 2620 to an internal register or internal cache. To execute the instructions, processor 2610 may retrieve the instructions from the internal register or internal cache and decode them. During or after execution of the instructions, processor 2610 may write one or more results (which may be intermediate or final results) to the internal register or internal cache. Processor 2610 may then write one or more of those results to memory 2620. One or more memory buses (which may each include an address bus and a data bus) may couple processor 2610 to memory 2620. Bus 2660 may include one or more memory buses. One or more memory management units (MMUs) may reside between processor 2610 and memory 2620 and facilitate accesses to memory 2620 requested by processor 2610. Memory 2620 may include random access memory (RAM). This RAM may be volatile memory, where appropriate. Where appropriate, this RAM may be dynamic RAM (DRAM) or static RAM (SRAM). Memory 2620 may include one or more memories 2620, where appropriate.

Storage 2630 may include mass storage for data or instructions. As an example, storage 2630 may include a hard disk drive (HDD), a floppy disk drive, flash memory, an optical disc, a magneto-optical disc, magnetic tape, or a Universal Serial Bus (USB) drive or a combination of two or more of these. Storage 2630 may include removable or non-removable (or fixed) media, where appropriate. Storage 2630 may be internal or external to computer system 2600, where appropriate. Storage 2630 may be non-volatile, solid-state memory. Storage 2630 may include read-only memory (ROM). Where appropriate, this ROM may be mask ROM (MROM), programmable ROM (PROM), erasable PROM (EPROM), electrically erasable PROM (EEPROM), flash memory, or a combination of two or more of these. Storage 2630 may include one or more storage control units facilitating communication between processor 2610 and storage 2630, where appropriate. Where appropriate, storage 2630 may include one or more storages 2630.

I/O interface 2640 may include hardware, software, or both, providing one or more interfaces for communication between computer system 2600 and one or more I/O devices. Computer system 2600 may include one or more of these I/O devices, where appropriate. One or more of these I/O devices may enable communication between a person and computer system 2600. As an example, an I/O device may include a keyboard, keypad, microphone, monitor, mouse, printer, scanner, speaker, camera, stylus, tablet, touch screen, trackball, another suitable I/O device, or any suitable combination of two or more of these. An I/O device may include one or more sensors. Where appropriate, I/O interface 2640 may include one or more device or software drivers enabling processor 2610 to drive one or more of these I/O devices. I/O interface 2640 may include one or more I/O interfaces 2640, where appropriate.

Communication interface 2650 may include hardware, software, or both providing one or more interfaces for communication (such as, for example, packet-based communication) between computer system 2600 and one or more other computer systems 2600 or one or more networks. As an example, communication interface 2650 may include a network interface controller (NIC) or network adapter for communicating with an Ethernet or other wire-based network or a wireless NIC (WNIC); a wireless adapter for communicating with a wireless network, such as a WI-FI network; or an optical transmitter (e.g., a laser or a light-emitting diode) or an optical receiver (e.g., a photodetector) for communicating using fiber-optic communication or free-space optical communication. Computer system 2600 may communicate with an ad hoc network, a personal area network (PAN), an in-vehicle network (IVN), a local area network (LAN), a wide area network (WAN), a metropolitan area network (MAN), or one or more portions of the Internet or a combination of two or more of these. One or more portions of one or more of these networks may be wired or wireless. As an example, computer system 2600 may communicate with a wireless PAN (WPAN) (such as, for example, a BLUETOOTH WPAN), a WI-FI network, a Worldwide Interoperability for Microwave Access (WiMAX) network, a cellular telephone network (such as, for example, a Global System for Mobile Communications (GSM) network), or other suitable wireless network or a combination of two or more of these. As another example, computer system 2600 may communicate using fiber-optic communication based on 100 Gigabit Ethernet (100 GbE), 10 Gigabit Ethernet (10 GbE), or Synchronous Optical Networking (SONET). Computer system 2600 may include any suitable communication interface 2650 for any of these networks, where appropriate. Communication interface 2650 may include one or more communication interfaces 2650, where appropriate.

Bus 2660 may include hardware, software, or both coupling components of computer system 2600 to each other. As an example, bus 2660 may include an Accelerated Graphics Port (AGP) or other graphics bus, a controller area network (CAN) bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these. Bus 2660 may include one or more buses 2660, where appropriate.

Various modules, circuits, systems, methods, or algorithm steps described in connection with the implementations disclosed herein may be implemented as electronic hardware, computer software, or any suitable combination of hardware and software. Computer software (which may be referred to as software, computer-executable code, computer code, a computer program, computer instructions, or instructions) may be used to perform various functions described or illustrated herein, and computer software may be configured to be executed by or to control the operation of computer system 2600. As an example, computer software may include instructions configured to be executed by processor 2610. Owing to the interchangeability of hardware and software, the various illustrative logical blocks, modules, circuits, or algorithm steps have been described generally in terms of functionality. Whether such functionality is implemented in hardware, software, or a combination of hardware and software may depend upon the particular application or design constraints imposed on the overall system.

A computing device may be used to implement various modules, circuits, systems, methods, or algorithm steps disclosed herein. As an example, all or part of a module, circuit, system, method, or algorithm disclosed herein may be implemented or performed by a general-purpose single- or multi-chip processor, a digital signal processor (DSP), an ASIC, a FPGA, any other suitable programmable-logic device, discrete gate or transistor logic, discrete hardware components, or any suitable combination thereof. A general-purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

One or more implementations of the subject matter described herein may be implemented as one or more computer programs (e.g., one or more modules of computer-program instructions encoded or stored on a computer-readable non-transitory storage medium). As an example, the steps of a method or algorithm disclosed herein may be implemented in a processor-executable software module which may reside on a computer-readable non-transitory storage medium. A computer-readable non-transitory storage medium may include any suitable storage medium that may be used to store or transfer computer software and that may be accessed by a computer system. Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs (e.g., compact discs (CDs), CD-ROM, digital versatile discs (DVDs), Blu-ray discs, or laser discs), optical disc drives (ODDs), magneto-optical discs, magneto-optical drives, floppy diskettes, floppy disk drives (FDDs), magnetic tapes, flash memories, solid-state drives (SSDs), RAM, RAM-drives, ROM, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layout of the devices illustrated.

One or more of the figures described herein may include example data that is prophetic. For example, the example graphs illustrated in FIGS. 11-21, 23, and 24 may include or may be referred to as prophetic examples.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, ±3%, ±4%, ±5%, ±10%, ±12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 10⁴ s, 10³ s, 10² s, 10 s, 1 s, 100 ms, 10 ms, 1 ms, 100 μs, 10 μs, or 1 μs. The term “substantially constant” may be applied to any suitable value, such as for example, an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

What is claimed is:

1. A lidar system comprising:
a light source configured to emit pulses of light, wherein each emitted pulse of light comprises a spectral signature of a plurality of different spectral signatures;
a receiver configured to detect a received pulse of light, the received pulse of light comprising light from one of the emitted pulses of light scattered by a target located a distance from the lidar system, the emitted pulse of light comprising one of the spectral signatures, wherein the receiver comprises:
a detector configured to produce a photocurrent signal corresponding to the received pulse of light;
a frequency-detection circuit configured to determine, based on the photocurrent signal, a spectral signature of the received pulse of light; and
a pulse-detection circuit configured to determine, based on the photocurrent signal,
a time-of-arrival of the received pulse of light; and
a processor configured to determine:
that the spectral signature of the received pulse of light matches the spectral signature of the emitted pulse of light; and
the distance to the target based on the time-of-arrival of the received pulse of light.

2. The lidar system of claim 1, wherein each spectral signature comprises two or more optical-frequency components, wherein the photocurrent signal produced by the detector in response to the received pulse of light comprises one or more beat signals, each beat signal comprising a beat frequency corresponding to a frequency difference between two optical-frequency components of the spectral signature of the received pulse of light.

3. The lidar system of claim 2, wherein determining the spectral signature of the received pulse of light comprises determining one or more respective beat frequencies of the one or more beat signals.

4. The lidar system of claim 2, wherein determining that the spectral signature of the received pulse of light matches the spectral signature of the emitted pulse of light comprises determining that one or more beat frequencies associated with the received pulse of light are approximately equal to one or more beat frequencies associated with the emitted pulse of light.

5. The lidar system of claim 2, wherein:
the spectral signature of the emitted pulse of light comprises a first optical-frequency component having a first frequency f₁ and a second optical-frequency component having a second frequency f₂, wherein f₂ is greater than f₁;
the first optical-frequency component is represented by E₁(t)·cos[2πf₁t+ϕ₁], wherein E₁(t) represents an amplitude of an electric field of the first optical-frequency component, and ϕ₁ represents a phase of the first optical-frequency component;
the second optical-frequency component is represented by E₂(t)·cos[2πf₂t+ϕ₂], wherein E₂(t) represents an amplitude of an electric field of the second optical-frequency component, and ϕ₂ represents a phase of the second optical-frequency component; and
the photocurrent signal produced by the detector in response to the received pulse of light comprises a beat signal having a beat frequency of (f₂−f₁).

6. The lidar system of claim 2, wherein two of the optical-frequency components are coherently mixed at the detector to produce one of the beat signals.

7. The lidar system of claim 2, wherein the beat frequency of each beat signal is between 100 MHz and 40 GHz.

8. The lidar system of claim 1, wherein the frequency-detection circuit is further configured to (i) receive a voltage signal that corresponds to the photocurrent signal and (ii) produce, based on the received voltage signal, an output signal that corresponds to the photocurrent signal, wherein the spectral signature of the received pulse of light is determined based on the output signal.

9. The lidar system of claim 8, wherein the receiver further comprises an electronic amplifier configured to receive the photocurrent signal from the detector and amplify the photocurrent signal to produce the voltage signal that corresponds to the photocurrent signal.

10. The lidar system of claim 8, wherein the frequency-detection circuit comprises an analog-to-digital converter (ADC) configured to (i) receive the voltage signal that corresponds to the photocurrent signal and (ii) produce, based on the received voltage signal, the output signal that corresponds to the photocurrent signal.

11. The lidar system of claim 8, wherein the frequency-detection circuit comprises a plurality of comparators and a plurality of time-to-digital converters (TDCs), each comparator coupled to a corresponding TDC, wherein:
each comparator is configured to (i) receive the voltage signal that corresponds to the photocurrent signal and (ii) provide an electrical-edge signal to the corresponding TDC when the voltage signal rises above or falls below a particular threshold voltage; and
the corresponding TDC is configured to produce a time value corresponding to a time when the electrical-edge signal was received, wherein the output signal that corresponds to the photocurrent signal comprises time values produced by one or more of the TDCs.

12. The lidar system of claim 8, wherein the frequency-detection circuit comprises one or more electronic band-pass filters and one or more amplitude detectors, each band-pass filter coupled to a corresponding amplitude detector, wherein:
each band-pass filter has a particular pass-band with a particular center frequency and is configured to (i) receive the voltage signal that corresponds to the photocurrent signal and (ii) produce a filtered signal, the filtered signal corresponding to a portion of the voltage signal within the particular pass-band of the band-pass filter; and
the corresponding amplitude detector is configured to produce an amplitude signal that corresponds to an amplitude of the filtered signal, wherein the output signal that corresponds to the photocurrent signal comprises one or more amplitude signals from one or more of the amplitude detectors.

13. The lidar system of claim 12, wherein the amplitude signal produced by the corresponding amplitude detector comprises a first value if the amplitude of the filtered signal is greater than or equal to a particular threshold value and a second value if the amplitude of the filtered signal is less than the particular threshold value.

14. The lidar system of claim 8, wherein the frequency-detection circuit comprises:
a derivative circuit configured to (i) receive the voltage signal that corresponds to the photocurrent signal and (ii) produce, based on the received voltage signal, a derivative signal that corresponds to a derivative of the photocurrent signal; and
a zero-crossing circuit configured to determine a plurality of zero crossings of the derivative signal, each zero crossing corresponding to a time associated with a local maximum or minimum of the photocurrent signal, wherein the output signal that corresponds to the photocurrent signal comprises the zero crossings.

15. The lidar system of claim 1, wherein determining the spectral signature of the received pulse of light comprises determining a frequency spectrum of the photocurrent signal.

16. The lidar system of claim 15, wherein determining that the spectral signature of the received pulse of light matches the spectral signature of the emitted pulse of light comprises comparing the frequency spectrum of the photocurrent signal of the received pulse of light to a frequency spectrum of a photocurrent signal associated with the emitted pulse of light.

17. The lidar system of claim 15, wherein:
the frequency-detection circuit is further configured to produce an output signal that corresponds to the photocurrent signal; and
the frequency-detection circuit is configured to determine the frequency spectrum of the photocurrent signal based on the output signal.

18. The lidar system of claim 1, wherein determining that the spectral signature of the received pulse of light matches the spectral signature of the emitted pulse of light comprises determining that a measure of correlation between the spectral signature of the received pulse of light and the spectral signature of the emitted pulse of light is greater than a particular threshold correlation value.

19. The lidar system of claim 1, wherein:
the emitted pulse of light is one of P most recently emitted pulses of light, wherein P is an integer greater than or equal to 2;
the frequency-detection circuit is further configured to determine a spectral signature of each of the P emitted pulses of light, the determined spectral signatures comprising the spectral signature of the emitted pulse of light and spectral signatures of the other (P−1) emitted pulses of light; and
determining that the spectral signature of the received pulse of light matches the spectral signature of the emitted pulse of light comprises determining that a measure of correlation between the spectral signature of the received pulse of light and the spectral signature of the emitted pulse of light is greater than each of (P−1) measures of correlation between the spectral signature of the received pulse of light and the spectral signatures of the other (P−1) emitted pulses of light.

20. The lidar system of claim 1, wherein:
the received pulse of light is a first received pulse of light;
the spectral signature of the received pulse of light is a first spectral signature;
the receiver is further configured to detect a second received pulse of light;
the frequency-detection circuit is further configured to determine a second spectral signature of the second received pulse of light, wherein the second spectral signature is different from the first spectral signature; and
the processor is further configured to determine that the second spectral signature does not match the spectral signature of the emitted pulse of light.

21. The lidar system of claim 1, wherein the light source is further configured to emit test pulses of light, wherein each test pulse of light is associated with one of the emitted pulses of light.

22. The lidar system of claim 21, wherein the frequency-detection circuit is further configured to determine a spectral signature of each of the emitted pulses of light based on a spectral signature of an associated test pulse of light.

23. The lidar system of claim 22, wherein:
the processor is further configured to store the spectral signatures of P most recently emitted pulses of light, wherein P is an integer greater than or equal to 2, and the P most recently emitted pulses of light include the emitted pulse of light; and
determining that the spectral signature of the received pulse of light matches the spectral signature of the emitted pulse of light comprises comparing the spectral signature of the received pulse of light to the spectral signature of each of the P most recently emitted pulses of light.

24. The lidar system of claim 21, wherein the processor is configured to determine that the spectral signature of the received pulse of light matches the spectral signature of the emitted pulse of light based on the spectral signature of the received pulse of light matching a spectral signature of a test pulse of light associated with the emitted pulse of light.

25. The lidar system of claim 21, wherein:
the lidar system further comprises an optical splitter configured to split off a portion of each emitted pulse of light to produce a test pulse of light;
the receiver is further configured to detect the test pulse of light; and
the frequency-detection circuit is further configured to determine a spectral signature of the test pulse of light.

26. The lidar system of claim 1, wherein the light source is configured to impart to each emitted pulse of light one of the spectral signatures.

27. The lidar system of claim 26, wherein the light source is configured to impart spectral signatures to the emitted pulses of light so that the spectral signatures change in a random manner.

28. The lidar system of claim 1, wherein the light source comprises:
a seed laser diode configured to produce seed light; and
a semiconductor optical amplifier (SOA) configured to amplify temporal portions of the seed light to produce the emitted pulses of light, wherein each amplified temporal portion of the seed light corresponds to an emitted pulse of light.

29. The light source of claim 28, wherein the SOA comprises a tapered optical waveguide extending from an input end of the SOA to an output end of the SOA, wherein a width of the tapered optical waveguide increases from the input end to the output end.

30. The lidar system of claim 28, wherein the light source further comprises an electronic driver configured to:
supply a substantially constant electrical current to the seed laser diode so that the seed light comprises light having a substantially constant optical power; and
supply pulses of electrical current to the SOA, wherein each pulse of current causes the SOA to amplify one of the temporal portions of the seed light to produce one of the emitted pulses of light,
wherein the spectral signature of each emitted pulse of light depends at least in part on one or more of: an amplitude of the substantially constant electrical current, an amplitude of the pulse of current, a duration of the pulse of current, a rise-time of the pulse of current, a fall-time of the pulse of current, and a shape of the pulse of current.

31. The lidar system of claim 28, wherein the light source further comprises an electronic driver configured to:
supply pulses of electrical current to the seed laser diode, wherein each pulse of seed current causes the seed laser diode to produce a seed pulse of light; and
supply pulses of electrical current to the SOA, wherein each pulse of SOA current causes the SOA to amplify one of the seed pulses of light to produce one of the emitted pulses of light,
wherein the spectral signature of each emitted pulse of light depends at least in part on one or more of: an amplitude of the pulse of seed current, a duration of the pulse of seed current, a rise-time of the pulse of seed current, a fall-time of the pulse of seed current, a shape of the pulse of seed current, an amplitude of the pulse of SOA current, a duration of the pulse of SOA current, a rise-time of the pulse of SOA current, a fall-time of the pulse of SOA current, a shape of the pulse of SOA current, and a temporal offset between the pulse of seed current and the pulse of SOA current.

32. The lidar system of claim 1, wherein the light source comprises:
a seed laser diode configured to produce seed light;
a semiconductor optical amplifier (SOA) configured to amplify temporal portions of the seed light to produce initial pulses of light; and
a fiber-optical amplifier configured to further amplify the initial pulses of light to produce the emitted pulses of light, wherein each amplified temporal portion of the seed light corresponds to one of the emitted pulses of light.

33. The lidar system of claim 1, wherein the light source comprises:
a passive optical waveguide comprising an optical filter;
a semiconductor optical amplifier (SOA), wherein the passive optical waveguide and the SOA are optically coupled to one another; and
an electronic driver configured to supply pulses of electrical current to the SOA, wherein each pulse of current causes the SOA to produce one of the emitted pulses of light.

34. The lidar system of claim 1, wherein the detector is one of a plurality of detectors, each detector configured to produce a respective photocurrent signal corresponding to the received pulse of light.

35. The lidar system of claim 1, wherein the receiver further comprises:
an electronic amplifier configured to receive the photocurrent signal from the detector and amplify the photocurrent signal to produce a voltage signal that corresponds to the photocurrent signal, wherein:
the frequency-detection circuit determines the spectral signature of the received pulse of light from the voltage signal; and
the pulse-detection circuit determines the time-of-arrival of the received pulse of light from the voltage signal.

36. The lidar system of claim 1, wherein the pulse-detection circuit comprises a plurality of comparators and a plurality of time-to-digital converters (TDCs), wherein each comparator is coupled to a TDC, wherein:
each comparator is configured to receive a voltage signal that corresponds to the photocurrent signal and provide an electrical-edge signal to a corresponding TDC when the voltage signal rises above or falls below a particular threshold voltage; and
the corresponding TDC is configured to produce a time value corresponding to a time when the electrical-edge signal was received, wherein the time-of-arrival of the received pulse of light is determined based at least in part on one or more time values produced by one or more of the TDCs.

37. A method comprising:
emitting, by a light source of a lidar system, pulses of light, wherein each emitted pulse of light comprises a spectral signature of a plurality of different spectral signatures;
detecting, by a receiver of the lidar system, a received pulse of light, the received pulse of light comprising light from one of the emitted pulses of light scattered by a target located a distance from the lidar system, the emitted pulse of light comprising one of the spectral signatures, wherein detecting the received pulse of light comprises:
producing a photocurrent signal corresponding to the received pulse of light;
determining, based on the photocurrent signal, a spectral signature of the received pulse of light; and
determining, based on the photocurrent signal, a time-of-arrival of the received pulse of light;
determining, by a processor of the lidar system, that the spectral signature of the received pulse of light matches the spectral signature of the emitted pulse of light; and
determining, by the processor, the distance to the target based on the time-of-arrival of the received pulse of light.
